(19) United States
(12) Patent Application Publication
(10) Pub. No.: US 2022/0132896 A1
(43) Pub. Date: May 5, 2022

(54) Low Density Amorphous Sugar

(71) Applicant: NUTRITION SCIENCE DESIGN PTE. LTD, Singapore (SG)

(72) Inventors: David KANNAR, Singapore (SG); Meng Wai WOO, Clayton (AU); Yongmei SUN, Clayton (US)

(73) Assignee: NUTRITION SCIENCE DESIGN PTE. LTD, Singapore (SG)

(21) Appl. No.: 17/436,861

(22) PCT Filed: Mar. 6, 2020
(86) PCT No.: PCT/SG2020/050114

§ 371 Date: Sep. 7, 2021

(30) Foreign Application Priority Data
Mar. 8, 2019 (SG) 10201902102Q

(51) Int. Cl. A23L 27/30; A23L 33/125; A23L 2/60; C13B 50/00

(52) U.S. Cl. CPC A23L 27/33; C13B 50/00; A23L 2/60; A23L 33/125

(57) ABSTRACT

The present invention provides a low density amorphous sugar comprising one or more sugars or alternate sweeteners and a density lowering agent. The sugar has a bulk density of less than 0.8 g/cm3 and preferably has a lower density than refined white table sugar. The invention further provides methods of making the amorphous sugar including by rapidly drying, such as spray drying and methods of food and beverage preparation using the amorphous sugar.

### FIELD OF THE INVENTION

The present invention relates to sugar compositions, sugar derived compositions, compositions comprising alternative sweeteners and processes for the preparation of said compositions. In some embodiments, the present invention relates to sugar compositions, sugar derived compositions and alternative sweetener compositions having reduced calorific content and/or lowered bulk density and processes for their preparation. The present invention further relates to foods and beverages containing and/or prepared using the sugar, sugar derived and/or alternative sweetener compositions of the invention, preferably the sugar and beverages have a reduced sugar content.

### BACKGROUND OF THE INVENTION

There is concern that refined white sugar is causal in the development of diabetes and obesity. Consequently, there is demand for alternatives to white refined sugar products, especially if the product is likely to provide health benefits or minimise the health risks, for example, by reducing the calorie consumption.

Additional strategies are needed for sugar reduction and/or calorie reduction for foods and beverages to minimise the calories traditionally present in the food or beverage. In particular, there is a need for strategies for sugar and/or calorie reduction for foods and/or beverages that are prepared industrially for commercial distribution, for example, in supermarkets.

Current sugars include refined white sugar, brown sugar and “raw sugar”. All of these are crystalline sugars. The refining process used to prepare refined white sugar removes most vitamins, minerals and phytochemical compounds from the sugar leaving a “hollow nutrient”, that is, a food without significant nutritional value beyond the energetic value of the sugar.

There is a need for alternatives to traditional sugars. These alternatives can take the form of non-traditional sugars and/or alternative sweeteners to minimise the waste of sugar production, increase the efficiency of sugar processing and/or lessen the health risks associated with the consumption of sugar. It is useful if the non-traditional sugar or alternative sweetener has reduced calories by weight or volume compared to traditional white sugar.

It is particularly useful if a non-traditional sugar or alternative sweetener is inexpensive to produce and/or suitable for industrial scale production. In addition, it is useful if the non-traditional sugar or alternative sweetener is suitable for use in commercial scale food and/or beverage production. It is useful if the non-traditional sugar or alternative sweetener avoids or ameliorates metallic aftertastes or off-favours.

Reference to any prior art in the specification is not an acknowledgment or suggestion that this prior art forms part of the common general knowledge in any jurisdiction or that this prior art could reasonably be expected to be understood, regarded as relevant, and/or combined with other pieces of prior art by a skilled person in the art.

### SUMMARY OF THE INVENTION

The present invention provides an alternative to traditional crystalline sugar. The sweeteners of the present invention are largely amorphous. This is different to traditional sugars used in food preparation, which are crystalline because they are prepared by concentrating sugar cane or beet juice, crystallising the resulting syrup to form sugar crystals and removing the uncrystallised syrup (ie molasses). Instead, the amorphous sugars/sweeteners of the invention can be prepared by rapid drying, such as spray drying, a liquid containing the sugar or other sweetener. The sweeteners of the invention comprise one or more sugar, one or more alternative sweetener or combinations thereof.

The amorphous sweeteners of the invention are lower density than traditional white sugar. This means that less sugar is needed than for a traditional sugar to achieve the same bulk. This additional bulk per weight of sugar can be used to lower the calorie content of foods. The low density or aerated sugar of the invention is of particular use in the preparation of solid food, for example, by incorporation into a solid food matrix. Examples include chocolate, cakes and baked goods. Ice-cream, dairy-based beverages, diary-based powders, yoghurt, soups, powdered soups, edible spreads, and dietary supplements such as infant formula, protein/weight loss/prebiotic shakes, protein/weight loss/prebiotic powdered shakes and protein/weight loss/prebiotic bars, are alternative examples.

The low density is achieved by combining the sweetener with a density lowering agent when the sweetener is prepared by a rapid drying technique. The density lowering agents of the invention are, therefore, edible.

In one aspect, the present invention provides a low density amorphous sweetener comprising one or more sugars or alternative sweeteners, and an edible density lowering agent.

It is preferred for the amorphous sweetener to comprise homogenous particles where each particle comprises both the density lowering agent and the one or more sugar/alternative sweetener.

The amorphous sweetener of the invention is optionally in the form of a powder comprising particles, wherein the powder particles comprise (i) one or more sugar or alternative sweetener and (ii) one or more density lowering agent.

In some embodiments, the low density sweetener is comprised of particles that are aerated. The aeration is very small air pockets or pores in the amorphous particles that cannot be felt in the mouth (eg by the tongue). This means the sugar retains a highly smooth mouth feel which is advantageous for many solid foods.

Some of the amorphous sweeteners of the invention are also sweeter than traditional white sugar, which also allows for lower quantities of sugar to be used in foods or beverages resulting in further calorie reduction. It is thought that the increase in bulk increases the proportion of the surface area available to taste while the ultimate quantity of sugar is decreased. This results in a sweeter taste but lower calories.

The low density and/or aerated nature of the amorphous sweetener of the invention also dissolves quickly resulting in a faster onset of sweetness taste than occurs with crystalline sucrose sugar.

The smaller amorphous particles of the sweeteners of the invention also blend easily into other food products such as melted chocolate or baked goods mixes (eg cake mix) which is likely to result in lower mixing times and speeds, and therefore, lower time and energy costs. This will be particularly useful in an industrial setting.

In preferred embodiments, the low density amorphous sweetener comprises aerated particles. Preferably, the sugar or alternate sugar and the density lowering agent are in the same particles and the particles are low density. Optionally, the sugar particles are between 1 and 100 μm in diameter (eg a D90 of 100 μm or less). Optionally, the sugar particles have a D50 of 100 μm or less. Optionally, the D50 of particles is 80-160 μm or 80-140 μm or about 120 microns. Optionally, the D90 is 130-230 μm. In some embodiments, where a small particle size is desired, the sugar particles have a D90 of less than 60 microns. For some applications, such as for use in chocolate manufacture, a powder with a D90 of less than 30 microns is preferred (such as a D90 of 10 to <30 microns or 20 to <30 microns). For other applications, such as for use in baking, a powder with a D90 of greater than 30 microns is preferred (such as a D90 of >30 to <60 microns or a D90 of >30 to <100 microns).

Optionally, the D10 is 2 to 15 microns. Optionally, the D50 is 8 to 40 microns. Alternatively, the D50 is 50 to 150 microns or 50 to 100 microns. Optionally, the D90 is 20 to 100 microns.

Optionally the particle size span is between 0.031 and 5.50. Preferably, the particle size span is between 0.05 and 5.50, between 0.10 and 5.50, between 0.20 and 5.50, between 0.50 and 5.50, between 1.00 and 5.50, between 1.50 and 5.50, between 2.00 and 5.50, between 2.50 and 5.50, between 3.00 and 5.50, between 3.50 and 5.50, between 4.00 and 5.50, or between 4.50 and 5.50. Preferably, the particle size span is between 0.05 and 5.00, between 0.10 and 4.50, between 0.20 and 4.00, between 0.50 and 3.50, between 1.00 and 3.00, between 1.50 and 2.50, or between 2.00 and 2.50. Preferably, the particle size span is between 0.05 and 3.00, between 0.10 and 2.50, between 0.20 and 2.00, between 0.50 and 1.50, or between 1.00 and 1.50. Optionally the particle size span is less than 5.24. Preferably, the particle size span is less than 0.10, less than 0.20, less than 0.50, less than 1.00, less than 1.50, less than 2.00, less than 2.50, less than 3.00, less than 3.50, less than 4.00, less than 4.50, less than 5.00.

In some embodiments, the sugar has up to 5% non-aerated particles, up to 10% non-aerated particles or up to 20% non-aerated particles.

A sweetener with a higher proportion of aerated particles or lower density may be prepared by sieving to remove the smaller non-aerated particles and retain the aerated particles. Using this method an aerated amorphous sweetener with greater than 95% aerated particles, 99% aerated particles or about 100% aerated particles may be prepared. Particle separation may also be achieved using cyclones and classifiers capable of splitting particles based on size and weight.

In some embodiments, the amorphous sweetener of the invention has non-agglomerated particles. In some embodiments, the aerated sweetener of the invention is openly aerated (in the sense that a reasonable proportion of the particles (eg at least 20, 40, 60, or 80%) have an opened external surface rather than air pockets within a fully enclosed particle). In other embodiments, the sweetener is comprised of aerated particles that are enclosed by a skin (in the sense that a reasonable proportion of the particles (eg at least 20, 40, 60, or 80%) are enclosed). Optionally, about 100% are enclosed.

In some embodiments, the aerated sugar of the invention is both non-agglomerated and aerated.

The amorphous sweetener is optionally a homogenous mixture of ingredients. Where larger density lowering agents are used, the amorphous sweetener is optionally density lowering agent at its core with the density lowering agent coated by the sucrose and/or other smaller components of the amorphous sweetener.

The amorphous sweetener is comprised of particles. The particles are generally between 1 and 100 μm in diameter. The particles are optionally between 5 and 80 μm, 5 and 60 μm and 5 and 40 μm. A blend of smaller and larger particles is common, for example, a blend of particles less than 10 μm in diameter with particles of over 10 μm but less than 50 μm in diameter. It is also common for the aerated sugar of the invention (see below) to include some non-aerated particles immediately following its preparation.

While it is possible to coat the amorphous sweetener particles, the particles are usually not coated.

Optionally, the amorphous sweetener particles further comprise a gum, for example Guar gum. Cellulose gum, Gum premix and xanthan gum are also suitable. The addition of a gum has been found to be useful in particular where the density lowering agent is a starch or fibre.

### Bulk Density

The bulk density of the amorphous sweeteners of the invention is optionally about 0.25 to 0.7 g/cm³, about 0.3 to 0.7 g/cm³, 0.4 to 0.6 g/cm³ or 0.45 to 0.55 g/cm³. The density is reduced 10 to 70%, 20 to 60% or 30 to 60% compared to traditional crystalline white sugar (sucrose).

Alternatively, the bulk density of the amorphous sweetener is less than 0.8 g/cm³, less than 0.6 g/cm³, less than 0.5 g/cm³. Bulk density can be measured as tapped or free poured bulk density. Above are free poured or loose bulk density measures. Preferably, the free poured bulk density of the amorphous sweetener is 0.4 to 0.8 g/cm³ and/or the tapped bulk density of the amorphous sweetener is 0.2 to 0.7 g/cm³. Preferably, the free poured bulk density of the amorphous sweetener is 0.5 to 0.7 g/cm³ and/or the tapped bulk density of the amorphous sweetener is 0.3 to 0.6 g/cm³.

Particle density is optionally measured by the AccuPyc II 1330 Series Pycnometers. Particle density of crystalline sugar is 1.58 μm. Particle density may optionally be about 0.3 to 1.3 μm or 0.3 to 1.0 μm.

### Polyphenols

In all embodiments of the invention, the sweetener optionally further comprises at least about 20 mg catechin equivalent (CE) polyphenols/100 g carbohydrate. Optionally, the sweetener comprises greater than 50 mg catechin equivalent (CE) polyphenols/100 g carbohydrate. Optionally, the sweetener comprises 60 or more mg catechin equivalent (CE) polyphenols/100 g carbohydrate. Optionally, the sweetener comprises less than 1 g or less than 200 mg or less than 100 mg catechin equivalent (CE) polyphenols/100 g carbohydrate.

There are multiple options for the measurement of polyphenol content. One option is to measure milligrams catechin equivalents (CE) per amount of carbohydrate. An alternative is to measure gallic acid equivalents (GAE) per amount of carbohydrate. Amounts in mg CE/100 g can be converted to mg GAE/100 g by multiplying by 0.81 ie 60 mg CE/100 g is 49 mg GAE/100 g.

### Sweetener Options

Optionally, the one or more sugars is selected from the group consisting of glucose, fructose, galactose, ribose, xylose, lactose, maltose, rice syrup, coconut sugar, monk fruit, agave, stevia, fermented stevia, maple syrup and combinations thereof. Alternatively, the one or more sugars is selected from the group consisting of glucose, galactose, ribose, xylose, lactose, maltose, rice syrup, coconut sugar, monk fruit, agave, stevia, fermented stevia, maple syrup and combinations thereof. Alternatively, the sugar is glucose and/or fructose.

The amorphous sweeteners of all aspects of the invention are optionally 40% to 95% w/w, 50% to 90% w/w or 50 to 80% w/w sweetener.

Some sweeteners are have the molecular weight, glass transition temperature increasing and low density features desirable in a density lowering agent. Those sweeteners can be used as a density lowering agent in combination with another sweetener, however, the sweetener and bulk density agent cannot be the same ingredient.

Sucrose Sugar Options

Sucrose is a low molecular weight sugar that is difficult to prepare in an amorphous form. For the low density sucrose sugars of the invention (ie where the amorphous sweetener is an amorphous sucrose sugar), the density lowering agent can also act as a drying agent that both lowers the density of the sugar and ensures a stable, dry, free flowing powder results from preparation of the sugar by rapid drying, such as spray drying.

In one embodiment, the present invention provides a low density amorphous sweetener comprising 40% to 95% w/w sucrose, 0% to 4% w/w reducing sugars, at least about 20 mg CE polyphenols/100 g carbohydrate to about 1 g polyphenols CE/100 g carbohydrate and 5% to 60% w/w low GI density lowering agent selected from a low GI carbohydrate and/or a protein.

The low GI density lowering agent is described below as is the polyphenol content.

Previous research indicates that sugar with the claimed amount of polyphenols will be low glycaemic when the quantity of higher GI sugars like glucose is low. If the density lowering agent is also low glycaemic or no glycaemic the amorphous sweetener will also be low glycaemic. The low density amorphous sweetener of the invention is optionally low glycaemic and/or low glycaemic load.

A low density amorphous sucrose sugar according to the invention can be prepared from either sugar cane or sugar beet or from refined white sugar (ie sucrose sugar sources). Beet sugar does not contain polyphenols and neither does refined white sugar contain more than trace amounts of polyphenols. When preparing a sugar of the invention with polyphenols (as opposed to the embodiments with no polyphenols), the polyphenols can be added or sourced from the cane juice or molasses. Any added polyphenols may be added to the sugar in a powdered or liquid form.

The low density amorphous sucrose sugar optionally has 40% to 95% w/w, 50% to 90% w/w or 50 to 80% w/w sucrose. Alternatively, the low density amorphous sugar is >70% to 90%, 75% to 90% or 75% to 85% sucrose. Preferred sugars of the invention are 75% to 80% w/w sucrose. Optionally, the reducing sugars are 0% to 4% w/w, 0.1% to 3.5% w/w, 0% to 3% w/w, 0% to 2.5% w/w, 0.1% to 2% w/w of the low density amorphous sucrose sugar. The low density amorphous sucrose sugar optionally has <0.3% w/w reducing sugars. This is of particular interest where the sucrose is sourced from sugar cane or sugar beet juice or molasses.

In some embodiments, the sucrose is sourced from cane juice, beet juice and/or molasses. Optionally, the sucrose is dried cane juice, dried beet juice and/or dried molasses. Alternatively, the sucrose is white refined sugar, raw sugar, brown sugar, dried cane juice, dried beet juice, dried molasses or combinations thereof. Alternatively, the sucrose is raw sugar, brown sugar, dried cane juice, dried beet juice, dried molasses or combinations thereof. In some embodiments, the sweetener in the sucrose sugars of the invention is a combination of white refined sugar and raw sugar, white refined sugar and brown sugar or raw sugar and brown sugar. Optionally, the sweetener in the sucrose sugars of the invention are 1:10 to 10:1 (preferably 1:5 to 5:1) raw or brown sucrose sugar to white sucrose sugar by weight. In these embodiments, the density lowering agent is optionally whey protein isolate, egg white protein, pea protein isolate and/or sunflower protein.

Optionally, the sucrose is sourced from cane juice, beet juice and/or molasses and the density lowering agent is a digestive resistant carbohydrate.

Optionally, the sucrose is sourced from cane juice, beet juice and/or molasses and the density lowering agent is monk fruit.

Where the sucrose is sourced from beet juice the polyphenols will need to be measured. Cane juice and molasses may include sufficient polyphenols inherently, although additional polyphenols can be added if needed.

In another embodiment, the present invention provides an amorphous sugar comprising 40% to 95% w/w sucrose, 0% to 4% w/w reducing sugars, at least about 20 mg CE polyphenols/100 g carbohydrate to about 1 g polyphenols CE/100 g carbohydrate and 5% to 60% w/w low GI density lowering agent, wherein the molecular weight of the density lowering agent is about 200 g/mol to about 70 kDa.

In another embodiment, the present invention provides an amorphous sugar comprising 40% to 95% w/w sucrose, 0% to 4% w/w reducing sugars, at least about 20 mg CE polyphenols/100 g carbohydrate to about 1 g polyphenols CE/100 g carbohydrate and 5% to 60% w/w low GI density lowering agent, wherein the molecular weight of the density lowering agent is about 200 g/mol to about 70 kDa and the density lowering agent is selected from the group consisting of digestive resistant carbohydrate or whey protein isolate or a combination thereof.

In another embodiment, the present invention provides an amorphous sweetener comprising 40% to 95% w/w sucrose, 0% to 4% w/w reducing sugars, at least about 20 mg CE polyphenols/100 g carbohydrate to about 1 g polyphenols CE/100 g carbohydrate and 5% to 60% w/w low GI density lowering agent, wherein the molecular weight of the density lowering agent is about 200 g/mol to about 70 kDa and, wherein 10 g of the amorphous sweetener of the invention has a glycaemic load of 10 or less or the amorphous sweetener has a glucose base glycaemic index of less than 55.

In all aspects of the invention comprising sucrose, unless otherwise specified the sucrose is optionally sourced from sugar cane and/or beet sugar.

The beet juice and sugar cane juice are optionally about 60 brix.

### Low Molecular Weight Sugars

In some embodiments, the low density amorphous sweetener is a low density amorphous sugar comprising (i) one or more monosaccharides selected from the group consisting of glucose, fructose, galactose, ribose and xylose, and (ii) a low GI density lowering agent. Optionally the monosaccharide is glucose and/or fructose.

As described above, the low molecular weight sugar (including monosaccharides) have traditionally been difficult to prepare in amorphous form by rapid drying, such as spray drying. The development of the low GI density lowering agent has allowed preparation of dry, flowable amorphous powders from low molecular weight sugars such as monosaccharides while retaining a low GI.

In one embodiment, the present invention provides a low density amorphous sugar comprising one or more low molecular weight sugars, at least about 20 mg CE polyphenols/100 g carbohydrate and a low GI density lowering agent.

Alternatively, the present invention provides a low density amorphous sugar comprising one or more low molecular weight sugars, at least about 20 mg CE polyphenols/100 g carbohydrate, and one or more edible, high molecular weight, low GI density lowering agents.

The low molecular weight sugar is optionally selected from the group consisting of sucrose, glucose, galactose, ribose, xylose, fructose and combinations thereof. The low molecular weight sugar in the alternate second aspects of the invention is optionally selected from the group consisting of sucrose, glucose, galactose, ribose, xylose and combinations thereof. The sugar is optionally sucrose, glucose and/or fructose. In some embodiments the low molecular weight sugar is sucrose and/or glucose.

A person skilled in the art would appreciate that inclusion of fructose could increase hygroscopicity and decrease shelf-life. Such products are best for prompt use rather than long term storage. Alternatively, their shelf life can be improved by low humidity storage among other options.

The low density amorphous sugar optionally has 40% to 95% w/w, 50% to 90% w/w or 50 to 80% w/w monosaccharide or low molecular weight sugar.

In all aspects of the invention comprising fructose, unless otherwise specified the fructose is optionally high fructose corn syrup.

### Options for the Amorphous Sugars

It is preferred for the low density amorphous sugar to comprise relatively homogenous particles where each particle comprises both the density lowering agent and the sucrose/monosaccharide/low molecular weight sugar.

The density lowering agent in amorphous sugars of the invention is preferred to also be a drying agent.

The low density amorphous sugar optionally has a maximum of 1 g CE polyphenols/100 g carbohydrate. Without being bound by theory, the drying agent is thought to increase the overall glass transition temperature of the liquid for rapid drying, allowing cane juice, molasses or a combination of the two to be dried without becoming sticky or caking. A similar effect is observed for pure sucrose (eg white refined sugar), glucose, fructose and other monosaccharides. As the drying agents traditionally used in spray drying are high GI, for example, maltodextrin, new drying agents have been utilised for this amorphous sweetener. The newer substrates aim to reduce or maintain the reduction in the glycaemic index of the amorphous sweetener and/or the glycaemic load of an amount of the amorphous sweetener. In preferred embodiments, the amorphous sweetener has a low GL and/or a low GI. Optionally, the amorphous sweetener is food grade, that is, suitable for human consumption.

One advantage of the use of an amorphous sweetener is that an amorphous sweetener will have faster dissolution than a crystalline sugar. Use of the amorphous sweetener in the preparation of industrial food products would minimise the time taken to dissolve the sugar into, for example, a beverage.

Another advantage of the amorphous sweetener is that higher amounts of polyphenols can be present than have been included in low GI crystalline sugars. In international patent application no PCT/AU2017/050782, a low GI crystalline sugar is described. The preparation of that crystalline sugar was based on the identification of a “sweet spot” in the level of sugar processing (ie the amount the massecuite is washed) where:
1. the reducing sugar content is low enough that the sugar is low hygroscopicity and the reducing sugars are not raising the GI of the sucrose; and
2. the polyphenol content remains high enough to lower the GI of the sucrose.

More specifically, the crystalline sugar included about 0 to 0.5 g/100 g reducing sugars and about 20 mg CE polyphenols/100 g carbohydrate to about 45 mg CE polyphenols/100 g carbohydrate and the sugar particles have a glucose based glycaemic index of less than 55. The amorphous sweetener of this invention can contain much higher polyphenol content without the need to add extraneous polyphenols if the sugar source is sugar cane juice or molasses rather than the crystallised sugar and massecuite that remain after molasses is removed. Use of molasses as the sugar source also increases the caramel flavour of the sugar. While sugar beet juice can be used as a sugar source, it has no inherent polyphenols so those will need to be added to prepare a sugar according to the first, first alternative and second alternative aspects of invention.

Optionally, the amorphous sweetener comprise about 20 mg CE polyphenols/100 g carbohydrate to about 1 g CE polyphenols/100 g carbohydrate, about 20 mg CE polyphenols/100 g carbohydrate to about 800 mg CE polyphenols/100 g carbohydrate, about 20 mg CE polyphenols/100 g carbohydrate to about 500 mg CE polyphenols/100 g carbohydrate, about 30 mg CE polyphenols/100 g carbohydrate to about 200 mg CE polyphenols/s100 g carbohydrate, or about 20 mg CE polyphenols/100 g carbohydrate to about 100 mg CE polyphenols/100 g carbohydrate.

Alternatively, the amorphous sweetener comprises about 50 mg CE polyphenols/100 g carbohydrate to about 100 mg CE polyphenols/100 g carbohydrate, 50 mg CE polyphenols/100 g carbohydrate to about 80 mg CE polyphenols/100 g carbohydrate, 50 mg CE polyphenols/100 g carbohydrate to about 70 mg CE polyphenols/100 g carbohydrate, 55 mg CE polyphenols/100 g carbohydrate to about 65 mg CE polyphenols/100 g carbohydrate. In some embodiments there is about 60 mg CE polyphenols/100 g carbohydrate.

Alternatively, the amorphous sweetener comprises about 55 mg CE polyphenols/100 g carbohydrate to about 100 mg CE polyphenols/100 g carbohydrate, 55 mg CE polyphenols/100 g carbohydrate to about 80 mg CE polyphenols/100 g carbohydrate or 55 mg CE polyphenols/100 g carbohydrate to about 70 mg CE polyphenols/100 g carbohydrate.

Preferably, the polyphenols are polyphenols that naturally occur in sugar cane (although they do not need to be sourced from sugar cane).

It is preferred that the polyphenols added to the sugar are polyphenols that, even if not sourced from sugar cane, are present in sugar cane. The polyphenols can be sourced from sugar cane, for example, from a sugar processing waste stream and may be in the form of a sugar cane extract.

Optionally, the amorphous sugar of the invention has good or excellent flowability. Optionally, the amorphous sugar has 0 to 0.3% w/w moisture content. Alternatively, the amorphous sweetener has 0 to 10% w/w moisture content, 0.1 to 8% w/w moisture content or 0.1 to 5% w/w moisture content. Optionally, the moisture content is 0.1 to 0.3% w/w or 0.2 to 0.25% w/w. Similar moisture content amounts are expected for non-sugar amorphous sweeteners of the invention.

Optionally, the amorphous sugar is soluble in water, preferably the solubility is equivalent to or greater than that of traditional crystalline sugar.

### Other Sweeteners

In an alternate aspect, the present invention provides a low density amorphous sweetener comprising (i) one or more sugar or alternative sweetener selected from the group consisting of lactose, maltose, trehalose, rice syrup, coconut sugar, monk fruit (dried or sourced from monk fruit juice or extract), agave, stevia, fermented stevia, maple syrup and combinations thereof, and (ii) a low GI density lowering agent. The amorphous sweetener optionally further comprises one or more monosaccharide and/or disaccharide. Having developed stable amorphous powders of sucrose, the inventors of the present invention observed the health benefits associated with their products and progressed to developing similar amorphous products of other sugars/sweeteners, including those that are capable of spray drying such as lactose and monk fruit, with the intention of providing alternative sugars and sweetening ingredients to the food industry.

In an alternate aspect, the present invention provides a low density amorphous sweetener comprising (i) one or more sugar or alternative sweetener selected from the group consisting of sucrose, lactose, maltose, trehalose, rice syrup, coconut sugar, monk fruit (dried or sourced from monk fruit juice or extract), agave, stevia, fermented stevia, maple syrup and combinations thereof, and (ii) a low GI density lowering agent, with the proviso that when the sugar is sucrose, the density lowering agent is not whey protein isolate.

In an alternate aspect, the present invention provides a low density amorphous sweetener comprising (i) sugar or alternative sweetener selected from the group consisting of lactose, maltose, trehalose, rice syrup, coconut sugar, monk fruit, agave, stevia, fermented stevia, maple syrup, optionally sucrose, and combinations thereof, and one or more edible, high molecular weight, low GI density lowering agents, with the proviso that when the sugar is sucrose, the density lowering agent is not whey protein isolate.

In an alternate aspect, the present invention provides a low density amorphous sweetener comprising (i) sugar or alternative sweetener selected from the group consisting of lactose, maltose, trehalose, rice syrup, coconut sugar, monk fruit, agave, stevia, fermented stevia, maple syrup, optionally sucrose, and combinations thereof, and one or more edible, high molecular weight, low GI density lowering agents selected from the group consisting of lactose, protein, low GI carbohydrates, insoluble fibre, soluble fibre, lipids, natural intense sweeteners and/or combinations thereof, with the proviso that when the sugar is sucrose, the density lowering agent is not whey protein isolate.

In the third and alternate third aspects of the invention, it is preferred for the amorphous sweetener to comprise relatively homogenous particles where each particle comprises both the density lowering agent and the one or more sugar/alternative sweetener.

The amorphous sweetener optionally comprises an alternative sweetener. The alternative sweetener is optionally rice syrup, maple syrup, coconut sugar and/or monk fruit.

The sugar is optionally selected from the group consisting of glucose, galactose, ribose, xylose, fructose, maltose, lactose, trehalose and combinations thereof.

The amorphous sweetener optionally further comprises at least about 20 mg CE polyphenols/100 g carbohydrate and a low GI density lowering agent. The nature and amounts of polyphenols can be as described above for the first and second aspects of the invention. However, as the skilled person would be aware, where the one or more sweetener is already low GI, the polyphenols will not be needed for their GI lowering effect.

The amorphous sweetener optionally has 40% to 95% w/w, 50% to 90% w/w or 50 to 80% w/w sugar/alternative sweetener. The amorphous sweetener optionally has 60% to 80% w/w or 70% to 80% w/w sugar/alternative sweetener. Optionally, the amorphous sweetener is 75% to 80% w/w sugar/alternative sweetener. Optionally, the amorphous sweetener is 75% w/w sugar/alternative sweetener. Optionally, the amorphous sweetener is 80% w/w sugar/alternative sweetener.

The moisture content and flowability of the powder can be as described for the amorphous sugars of the invention.

The density lowering agent is as described above and below. When the alternative sweetener is monk fruit, the density lowering agent is not also monk fruit.

### Density Lowering Agents

The edible density lowering agent is edible and low density. The edible density lowering agent can be a protein, carbohydrate, fibre (soluble or insoluble or a combination) or natural intense sweetener.

The bulk density of the density lowering agent of the invention is optionally about 0.25 to 0.7 g/cm³, about 0.3 to 0.7 g/cm³, 0.4 to 0.6 g/cm³ or 0.45 to 0.55 g/cm³. Alternatively, the bulk density of the density lowering agent is less than 0.8 g/cm³, less than 0.6 g/cm³, less than 0.5 g/cm³.

Optionally, the density lowering agent is either soluble or powdered version of silicon dioxide, cellulose gum, banana flakes, barley flour, beets, brown rice flour, brown rice protein isolate, brown whey powder, cake flour, calcium carbonate, calcium lactate, calcium silicon, caraway, carrageenan, cinnamon, cocoa beans, cocoa powder, coconut, coffee (dry ground), coffee (flaked), corn meal powder, corn starch, crisped rice, crushed malted barley, crushed soy beans, dehydrated banana flakes, dehydrated potatoes, dehydrated vegetables, dehydrated whole black beans, diacalite (diatomaceous earth), dried brewers yeast, dried calcium carbonate, dried carrots, dried celery, dried bell peppers, dried onions, dried whole whey powder, dried yeast, dry milk powder, egg protein, egg white protein, flour, ground almonds, ground cinnamon, ground corn cobb, ground potato flakes, ground silica, hazelnuts, peanuts, almonds, hemp protein, hydroxyethylcellulose, limestone (calcium carbonate), magnesium flakes, magnesium hydroxide powder, malted barley, malted milk powder, microcrystalline cellulose, milk powder, natural vanilla, parsley, peas, pea protein, potassium chloride, potassium sorbate, potato starch, potato starch flake, potato starch powder, powdered brown sugar, powdered soybean lecithin, quick oat, rice crispy treat cereal, rice short grain, rolled corn, rolled oats, sesame, silica, silicate powder, sodium caseinate, sodium silicate, soy bean mill, soya flour, sugar beet pulp, sunflower seeds, sunflower protein, vanilla, vanilla beans, vitreous fibre, wheat bran fibre, wheat germ, whey (protein) powder, white hulled sesame seeds, whole oat, yellow bread crumbs, whey protein isolate, or combinations thereof.

Optionally, the density lowering agent is either soluble or powdered version of Brown Rice Flour, Caffeinated Coffee Grounds, Cake Flour, Cheese Powder, Cheese Powder Blend, Chestnut Extract Powder, Chocolate, Chocolate Pudding Dry Mix, Chocolate Volcano Cake Base, Cinnamon, Coffee (Decaf), Corn Meal, Corn Starch, Dehydrated Potatoes, Dehydrated Soup, Dehydrated Vegetables, Dried Brewers Yeast, Dried Yeast, Dry Milk, Dry Milk Powder (Non-Fat), Flour, Flour (High Gluten), Flour (Pancake Mix), Flour Breading, Flour Mix, Food Grade Starch, Fumed Silica, Ground Almonds, Ground Cinnamon, Ground Coffee, Guar Gum, Gum Premix (Guar Gum, Locust Bean Gum, Kappa Carragenan), Ice Cream Powder (Chocolate), Malt Mix, Malted Milk Powder, Maltitol Nutriose Blend, Marshmallow Mix, Milk Powder, Milk Powder Based Feed, Milk Powder (Whole), Mixed Spices, Mustard Flour, Onion Powder, Pancake Mix, Pepperoni Spice, Potato Flour, Potato Pancake Mix, Potato Starch, Poultry Gravy, Poultry Seasoning, Powdered Candy Ingredients, Powdered Caramel Color, Powdered Dessert, Protein Drink Mix—Whey, Sweetener, Nutrients, Protein Drink Mixes (Vanilla, Chocolate), Protein Mix (French Vanilla), Salt, Salt & Milk Powder Mix, Salt & Vinager Seasoning Mix, Seaweed Powder, Silica, Silicate Powder, Sodium Benzoate, Sodium Bicarbonate, Sodium Carbonate, Sodium Caseinate, Sodium Citrate (Citric Acid), Soya Flour, Whey (Protein) Powder, Whey Feed Supplement, Whey Powder, Whey Protein or combinations thereof.

Optionally, the density lowering agent is selected from the group consisting of whey protein isolate, cake flour, cinnamon powder, cocoa powder, coconut powder, vanilla powder, pea/soy/oat/egg (including egg white)/celery/rice/sunflower protein powder, wheat germ, sugar beet pulp, bagasse or sugar cane pulp powder.

Optionally, the density lowering agent is selected from the group consisting of cake flour, cinnamon powder, cocoa powder, coconut powder, vanilla powder, pea/soy/oat/egg (including egg white)/celery/rice/sunflower protein powder, wheat germ, sugar beet pulp, bagasse or sugar cane pulp powder.

Optionally, the density lowering agent is selected from the group consisting of whey protein isolate, sunflower protein, pea protein, egg white protein or combinations thereof. Alternatively, the density lowering agent is sunflower protein, pea protein, egg white protein or combinations thereof.

Suitable proteins include whey protein isolate, preferably bovine whey protein isolate, pea protein, sunflower protein, egg white protein, hemp protein and combinations thereof.

Optionally, the density lowering agent is whey protein isolate, preferably bovine whey protein isolate, egg white protein, Faba bean protein, soy protein isolate, inulin and combinations thereof.

Preferably, the low GI density lowering agent is digestion resistant. Suitable digestion resistant density lowering agents include vitreous fibre, wheat bran fibre, wheat germ, sugar beet or sugar cane pulp, bagasse or combinations thereof. The digestive resistant density lowering agent is optionally a glucose polymer of 3 to 17 or 10 to 14 glucose units. The digestive resistant low GI density lowering agent may be a soluble or insoluble fibre or a combination thereof. One option for the digestive resistant low GI density lowering agent with insoluble fibre is bagasse.

In some embodiments, the density lowering agent is a protein and a low GI carbohydrate combination.

In some embodiments, the ratio of sugar source (ie sweetener) and density lowering agent is 99:1 to 60:40 by solid weight. In some embodiments, the ratio of sugar source and density lowering agent is 95:5 to 60:40 by solid weight or 95:5 to 70:30, preferably 90:10 to 80:20 by solid weight. In preferred embodiments, the ratio of sweetener and density lowering agent is 80:20 to 70:30 by solid weight. In alternate preferred embodiments, the ratio of sweetener and density lowering agent 80:20 to 75:25 by solid weight.

At least 5% w/w of the solids of the amorphous sweetener is preferred to be density lowering agent to achieve sufficient density lowering. The density lowering effect achieved by 5% w/w is improved at 10% and marginally improved at 30% (for whey protein isolate). Higher amounts of density lowering agent had little additional density lowering effect. A product can be prepared with more density lowering agent but at higher amounts the density lowering agent alters the taste profile of the sugar too much.

Optionally, the density lowering agent is from 1% to 60% w/w of the amorphous sweetener. Optionally, the density lowering agent is from 5% to 60% w/w, 10 to 50% w/w or 20 to 50% w/w of the amorphous sugar/sweetener. Optionally, the density lowering agent is 5% to 60%, 5 to 40%, 5 to 35%, or 10 to 40% by weight. In some embodiments the density lowering agent is 5% to less than 40% w/w of the amorphous sweetener. In some embodiments the density lowering agent is 20% to 30% by solid weight of the amorphous sweetener. Optionally, the density lowering agent is about 25% by solid weight of the amorphous sugar. Optionally, the density lowering agent is 10% to 30% or 15 to 25% by solid weight of the amorphous sweetener

A density lowering agent optionally has a molecular weight of 200 g/mol to 70 kDa, 300 g/mol to 70 kDa, 500 g/mol to 70 kDa, 800 g/mol to 70 kDa, or 1 kDa to 70 kDa. Optionally, the density lowering agent is 10 kDa to 60 kDa, 10 kDa to 50 kDa, 10 kDa to 40 kDa, or 10 kDa to 30 kDa. Where the sugar is a monosaccharide, a drying agent may be needed to ensure a non-sticky and free flowing powder product. Density lowering agents of these molecular weights are suitable drying agents.

Optionally, the density lowering agent is 200 g/mol to 1 kDa, 200 g/mol to 800 g/mol, 300 g/mol to 700 g/mol or 300 g/mol to 800 g/mol.

The skilled person would understand that higher amounts of high molecular weight drying agents with a relatively lower molecular weight will be needed to lower the glass transition temperature (Tg) of the amorphous monosaccharide sugar. The skilled person would also understand that lower amounts of high molecular weight drying agents with a relatively higher molecular weight will be needed to lower the Tg of the monosaccharide sugar.

In some embodiments, the density lowering agent is present in a non-uniform distribution throughout the particle of the sweetener of the invention. In some embodiments, the density lowering agent is present in a greater concentration on the surface region of the particle of the sweetener of the invention relative to the internal region of the particle. In some embodiments, the density lowering agent is present in a lower concentration on the surface region of the particle of the sweetener of the invention relative to the internal region of the particle. The location of the density lowering agent is thought to be affected by the molecular weight and surface activity of the density lowering agent among other factors.

### Prebiotic Sugars

In some embodiments, the density lowering agent is a low density digestive resistant carbohydrate and/or amorphous sweetener further comprises a prebiotic agent. For these embodiments, it is preferred that the prebiotic amorphous sweetener has a prebiotic effect when consumed. The prebiotic agent is optionally soluble fibre and/or insoluble fibre.

Suitable prebiotic agents include hi-maize, fructo-oligosaccharide or inulin, bagasse, xanthan gum, digestive resistant maltodextrin or its derivatives, a digestive resistant glucose polymer of 3 to 17 or 10 to 14 glucose units.

Methods for testing the prebiotic effect of the prebiotic amorphous sugar are explained in Singaporean patent application SG 10201809224Y, titled “Compositions that reduce sugar bioavailability and/or have prebiotic effect”, a copy of which is incorporated into the body of this specification by reference.

When the density lowering agent is combined with a prebiotic agent such as a digestive resistant carbohydrate, the ratio is optionally 20:1 to 5:1 w/w respectively.

### Intense Sweeteners

The natural intense sweetener density lowering agents are intensely sweetening plant extracts or juices. These can be either liquid or dried. Suitable extracts and juices in liquid and dried forms are commercially available for stevia, monk fruit and blackberry leaf. In view of the monk fruit products prepared by the inventors, stevia and blackberry leaf versions of the sugars/sweeteners of the invention are expected to be successful.

Optionally, the density lowering agent is monk fruit.

In some embodiments, the density lowering agent is one or more natural intense sweeteners selected from the group consisting of stevia, monk fruit, blackberry leaf and their extracts, with the proviso that when the low GI density lowering agent is monk fruit or a monk fruit extract, the sugar/sweetener is not a monk fruit alternative sweetener. In addition, when the low GI density lowering agent is stevia, the sugar/sweetener is not a stevia. Optionally, when the density lowering agent is stevia the sugar is sucrose, preferably sugar cane juice.

The other features of the density lowering agent such as molecular weight, hygroscopicity and weight percentage are optionally as described above.

In one embodiment, the amorphous sweetener a natural intense sweetener density lowering agent, the sugar is sucrose and sourced from cane juice, beet juice or molasses. In embodiments, with cane juice or molasses, the sugar source masks or ameliorates the metallic taste of the high intensity sweetener to either improve the taste of the sugar and/or allow an increased amount of high intensity sweetener while retaining palatability. An increased use of high intensity sweetener will allow for a reduced use of sugar in foods and beverages prepared using this embodiment of the invention.

### Glass Transition Temperature

Optionally, the amorphous sweetener has a glass transition temperature above 60 degrees Celsius. In particular, the amorphous sugars of the invention containing sucrose optionally have a glass transition temperature above 60 degrees Celsius. Preferably, the amorphous sugars of the invention containing at least 40% by weight (optionally 40-90%, 40-80% or 50-80% by weight) sucrose have a glass transition temperature above 60 degrees Celsius due to the glass transition temperature increasing effect of the density lowering agent. Optionally, the glass transition temperature of these amorphous sweeteners is 65-120° C., 70-120° C., 80-120° C., 90-120° C., 65-110° C., 70-110° C., 80-110° C., 90-110° C., 65-100° C., 70-100° C., 80-100° C., 90-100° C., 70-90° C. or 80-90° C.

### Stability

The low density amorphous sweeteners of the invention are stable for 12 months, 1 year, or 2 years. In particular, low density amorphous sugars of the invention (including sucrose sugars) are stable for 12 months, 1 year, or 2 years. Preferably, these amorphous sweeteners are stable when stored in sealed low-density plastic (eg polyethylene) at ambient conditions (room temperature and 50-60% relative humidity). Optionally, stable sugars retain their low density and/or aerated structure and/or remain free-flowing powders (ie have good or excellent powder flowability) upon storage. Preferably, these sweeteners/sugars include a low density agent selected from whey protein isolate.

Optionally, the amorphous sugars of the invention do not cake. Embodiments including sugar cane juice tend not to cake. Optionally, an anticaking agent is included. Suitable anticaking agents include magnesium stearate, calcium silicate and/or tricalcium phosphate. This can assist in particular with embodiments comprising refined white, raw or brown sugar.

Without being bound by theory, the density lowering agent is thought to stabilise the amorphous sweetener and protect ingredients such as sucrose from crystallisation.

### Exclusions

Optionally, the amorphous sweeteners of the invention do not include rennet casein or rennet casein alkai salt.

In some embodiments, the amorphous sweetener of the invention does not comprise white refined sucrose. In some embodiments, the amorphous sweetener of the invention does not comprise whole milk powder or whey protein isolate.

### Other Features

Optionally, the amorphous sweeteners of all aspects of the invention have low hygroscopicity eg 0 to 0.2% at 50% relative humidity.

Optionally, anti-caking agents are added including but not limited to starch, calcium phosphate and/or magnesium stearate.

Optionally, the reducing sugars are 0% to 4% w/w, 0.1% to 3.5% w/w, 0% to 3% w/w, 0% to 2.5% w/w, 0.1% to 2% w/w of the amorphous sweetener.

Optionally, the amorphous sweeteners of all aspects of the invention have a water activity (a_{w}) of less than 0.6, less than 0.4 or about 0.3.

### Low GI/GL

In some embodiments, the amorphous sweetener is low glycaemic or very low glycaemic.

Optionally, 10 g of the amorphous sweetener of the invention has a glycaemic load (GL) of 10 or less, or 8 or less, or 5 or less. Calculation of glycaemic load of an amount of a food is explained in the detailed description below.

Optionally, the amorphous sweetener of the invention has a glucose based GI of 54 or less or 50 or less. Optionally, the amorphous sweetener has a glucose based GI of 54 or less and 10 g of the amorphous sweetener has a glucose based GL of 10 or less.

Optionally, the amorphous sweetener further comprises a flow agent and/or desiccant. A flow agent and/or desiccant is of particular assistance where the reducing sugars are above 2% w/w or above 3% w/w of the amorphous sweetener.

### Stability

The amorphous sweetener of the invention optionally remains a free flowing powder following 6, 12, 18 or 24 months storage in ambient conditions.

### Taste

In embodiments where the sugar is sucrose and it is sourced from cane juice, beet juice and/or molasses, the amorphous sweetener of the invention has a desirable sensory profile, in particular, a taste that is sweeter than refined white sugar and/or a stronger caramel flavour than refined white sugar. Without being bound by theory, this is thought to occur either because the cane juice, beet juice and molasses sourced sugars are sweeter than essentially pure sugar and/or because the amorphous nature of the sugar allows for rapid tasting of the sugar compounds present in the amorphous sweetener and/or because the aerated size of the sugar positions the sugar for increased contact with taste buds resulting in a stronger recognition of the sweetness.

Where the amorphous sweetener of the invention includes whey protein isolate, the sugar optionally has a milkier taste than that for refined white sugar.

Where the amorphous sugar comprises sugar cane juice, the amorphous sugar optionally masks or ameliorates the metallic aftertaste associated with the consumption of high intensity sweeteners such as stevia, monk fruit and/or blackberry leaf (preferably stevia).

### Preferred Embodiments

Optionally, the amorphous sweetener of the invention comprises particles comprising 70-80% sugar and/or alternative sweetener and 20-30% density lowering agent. Optionally, the amorphous sweetener of the invention comprises particles consisting of 70-80% sugar and/or alternative sweetener and 20-30% density lowering agent. Each particle includes both density lowering agent and sugar/alternative sweetener.

In some embodiments, the invention provides a low density amorphous sugar comprising particles comprising one or more sugars and one or more edible density lowering agent, wherein the one or more sugars are selected from the group consisting of white refined sugar, raw sugar, brown sugar, dried cane juice, dried beet juice, dried molasses and combinations thereof; wherein the density lowering agent is selected from the group consisting of whey protein isolate, egg white protein, inulin, soy protein isolate, faba protein isolate and combinations thereof. Optionally, the one or more sugars are 70-80% of the amorphous sugar and/or the one or more density lowering agents are 20-30% of the amorphous sugar by weight. Alternatively, the one or more sugars are about 75% of the amorphous sugar and/or the one or more density lowering agents are about 25% of the amorphous sugar by weight. Optionally, the glass transition temperature of these amorphous sugar is 65-120° C. or 80-120° C. Optionally, the particles of the amorphous sugar retain their low density and/or aerated structure and/or have good or excellent powder flowability, preferably these features are retained after storage in a sealed low-density plastic at ambient conditions. Optionally, the reducing sugars are 0.1% to 3.5% w/w of the amorphous sweetener. Optionally, the sugar comprises 0 to 0.3% w/w moisture. Optionally, the sugar has a taste that is sweeter than refined white sugar and/or a stronger caramel flavour than refined white sugar.

In some embodiments, the invention provides a low density amorphous sweetener comprising particles comprising (i) one or more sugars or alternate sweeteners and (ii) one or more edible density lowering agent, wherein the one or more density lowering agent is whey protein isolate and coco powder. Optionally, the whey protein isolate and coco powder are present in a 1:2 to 2:1 ratio by weight (preferably a 1:1 ratio). Optionally the amorphous sweetener is about 70-80% sucrose and about 20-30% whey protein isolate and coco powder (for example, 70% sucrose, 15% whey protein isolate and 15% coco powder). Optionally, the glass transition temperature of these amorphous sugar is 65-120° C. or 80-120° C. Optionally, the particles of the amorphous sugar retain their low density and/or aerated structure and/or have good or excellent powder flowability, preferably these features are retained after storage in a sealed low-density plastic at ambient conditions.

In some embodiments, the invention provides a low density amorphous sugar comprising particles comprising one or more sugars and one or more edible density lowering agent, wherein the one or more sugars comprise sucrose (eg white refined sugar, raw sugar, brown sugar, dried cane juice, dried beet juice, dried molasses and combinations thereof) and the one or more density lowering agents are stevia and/or monkfruit.

In some embodiments, the invention provides a low density amorphous sugar comprising particles comprising one or more sugars and one or more edible density lowering agent, wherein the one or more sugars comprise sucrose (eg white refined sugar, raw sugar, brown sugar, dried cane juice, dried beet juice, dried molasses and combinations thereof) and the one or more density lowering agents are fibre and protein. The fibre may be soluble, insoluble or both such as xantham gum, digestive resistive maltodexrin, bagasse (eg sugar cane bagasse) or a combination thereof. Optionally, the fibre and protein are in a 1:3-1:15 ratio, eg a 1:9 ratio, by weight.

In some embodiments, the invention provides a low density amorphous sugar comprising particles comprising one or more sugars and one or more edible density lowering agent, wherein the one or more sugars comprise sucrose (eg white refined sugar, raw sugar, brown sugar, dried cane juice, dried beet juice, dried molasses and combinations thereof) and the one or more density lowering agents are (i) fibre and/or protein, (ii) and a gum. The fibre may be soluble, insoluble or both such as xantham gum, digestive resistive maltodexrin, bagasse (eg sugar cane bagasse) or a combination thereof. The protein is optionally whey protein isolate or sunflower protein. The gum is optionally guar gum. The gum and fibre/protein are optionally in a 1:20-1:5 ratio, eg a 1:10 ratio, by weight.

### Uses of the Sweeteners

The low density amorphous sweetener is intended for use as a food and/or ingredient used in the preparation of food. The sugars, alternative sweeteners and density lowering agents used are always suitable for consumption (ie edible) and/or food grade.

### Reduced Digestively Available Sugar or Calories/Increasing the Nutrition

The amorphous sweetener of the invention is suitable for use as an ingredient in other foods or as a dietary supplement. The amorphous sweetener of the invention can be used to reduce the sugar in a food system by 10% or more, 20% or more, 30% or more, or 40% or more, 55% or more or up to about 65%; relative to the use of traditional crystalline sugar in the food system (by which we mean the sugar added to the system and not the sugar inherently within the other ingredients). Optionally, the sugar in the food or beverage is reduced by 10-50% or 20-40%. That is, the added sugar is reduced by 10-50% or 20-40. The food system can be the sugar itself. This occurs because there is less free sugar in the amorphous sweetener of the invention than in refined white sugar. Also, due to the sweetness of the amorphous sweetener in embodiments of the invention where the sugar is sucrose and the sucrose is sourced from cane juice, beet juice and/or molasses, a less than a 1:1 sugar substitution may be required. See Example 12 for further detail.

The total kilojoule/calorie reduction for the amorphous sweetener of the invention is optionally 5 to 40% or 10 to 30%, when the less than 1:1 substitution potential due to the increased sweetness of the amorphous sweetener is considered. This refers to the reduction in calories from sugar in the food system.

For embodiments of the various aspects of invention where the sugar is sucrose and is sourced from cane juice, molasses and/or beet juice and there are at least 20 mg CE polyphenols/100 g carbohydrate present (for the beet juice the polyphenols will be added, preferably sourced from sugar cane), the amorphous sweetener has an improved nutritional profile compared to traditional white crystalline sugar. In these embodiments, the amorphous sweetener optionally has one or more of:
5-9%(7%) of the recommended daily amount of sodium;
20-30% (23%) of the recommended daily amount of carbohydrates;
3-10% (4%) of the recommended daily amount of fibre;
10-50% (48%) of the recommended daily amount of protein;
50-100% (90%) of the recommended daily amount of calcium;
100-180% (160%) of the recommended daily amount of iron;
30-40% (35%) of the recommended daily amount of potassium;
50-80% (70%) of the recommended daily amount of magnesium;
25-35% (35%) of the recommended daily amount of zinc;
50-65% (60%) of the recommended daily amount of copper; and/or
200-400% (350%) of the recommended daily amount of manganese.

Where the low GI density lowering agent is whey protein isolate and the sugar is optionally sourced from cane juice, the amorphous sweetener of the invention optionally has all of the above.

### Method of Preparing Amorphous Sweeteners of the Invention

In another aspect, the present invention provides a method for preparing an amorphous sweetener comprising (i) combining a liquid containing sucrose and polyphenols with at least one density lowering agent; and (ii) rapidly drying the mixture to produce the amorphous sweetener.

Alternatively, the present invention provides a method for preparing an amorphous sweetener comprising (i) combining a liquid containing one or more low molecular weight sugars and polyphenols with at least one density lowering agent; and (ii) rapidly drying the mixture to produce the amorphous sweetener.

Alternatively, the present invention provides a method for preparing an amorphous sweetener comprising (i) combining a liquid containing one or more sugars or alternative sweeteners and polyphenols with at least one density lowering agent; and (ii) rapidly drying the mixture to produce the amorphous sweetener.

What is surprising is that very mild mixing by hand is effective as it was expected that air would need to be introduced into the feedstock to achieve the aeration.

In one embodiment, a low density sugar according to the invention can also be prepared by (i) mixing a liquid containing sucrose and polyphenols with at least one density lowering agent; and (ii) rapidly drying the mixture to produce the amorphous sweetener, wherein no additional air is pumped into the feedstock prior to rapid drying.

In another embodiment, a low density amorphous sweetener according to the invention can also be prepared by (i) mixing a liquid containing sucrose and polyphenols with at least density lowering agent; and (ii) rapidly drying the mixture to produce the aerated amorphous sweetener, wherein the mixing does not create a bubbled feedstock prior to rapid drying. The inventors of the present invention have determined that bubbling the feedstock does not enhance the aeration or lower the density of at least whey protein isolate.

In an alternative embodiment, an low density amorphous sweetener according to the invention can be prepared by (i) mixing a liquid containing sucrose and polyphenols with at least one density lowering agent; and (ii) rapidly drying the mixture to produce the amorphous sweetener, wherein the mixing creates a bubbled feedstock prior to rapid drying but no additional air is pumped into the feedstock prior to rapid drying.

Optionally the rapid drying uses a spray drier. Optionally, the spray drier is a counter current spray drier. Alternatively, the spray drier is a co-current spray drier.

The liquid is optionally selected from the group consisting of cane juice, beet juice and molasses. The liquid is preferably cane juice and/or molasses. Optionally, the liquid is prepared with (or diluted/concentrated until it has) 5 to 30%, 10 to 25%, 15 to 20% or 20% w/w total solids. Alternatively, 20 to 50% or 30 to 40% w/w total solids are used.

Sugarcane juice is optionally at least 60 Brix (ie 60 g sucrose in 100 g solution). Results vary depending upon the sugarcane variety.

The liquid and density lowering agent are both optionally 0.1 micron filtered. The liquid and density lowering agent are combined. The liquid and density lowering agent has 20 mg CE polyphenols/100 g carbohydrate to 1 g CE polyphenols/100 g carbohydrate. The polyphenol content is optionally adjusted by adding additional polyphenols (or reducing polyphenols by dilution) prior to drying.

The inlet air temperature for the spray drier is optionally 140° C. to 200° C., 160° C. to 200° C., 140° C. to 180° C., 140° C. to 160° C. or 160° C. to 180° C. The inlet air temperature for the spray drier is optionally 120° C. to 200° C., 130° C. to 200° C., 130° C. to 170° C., or 130° C. to 150° C. Preferably, the inlet air temperature is about 135° C. Preferably, the inlet air temperature is about 140° C. Preferably, the inlet air temperature is about 145° C. Preferably, the inlet air temperature is about 160° C. Preferably, the inlet air temperature is about 135 to about 160° C.

The outlet air temperature for the spray drier is 70° C. to 90° C., 75° C. to 85° C. or 75° C. to 80° C.

Glucose oxidase may be added to the liquid before drying to decrease free glucose if required.

The feedstock is optionally defoamed, for example by using pressure to reduce any formed bubbles, before spray drying.

Optionally, the density lowering agent is milled to a particles size of less than 125 microns before addition to the feedstock. This is particularly useful where the density lowering agent is a fibre.

Optionally, the amorphous sweetener of the invention is prepared on an industrial scale. For example, the amorphous sweetener of the invention is optionally prepared in a spray drier capable of processing at least 200 L/hr feedstock. Optionally, the amorphous sweetener of the invention is prepared at a rate that processes at least 40 L/hr feedstock. Optionally, the amorphous sweetener of the invention is prepared at a rate that processes at least 60 L/hr feedstock.

One advantage of preparing a sugar by spray drying is that the processing is inexpensive. Other low cost drying methods may also be useful including fluidized bed drying, low temperature vacuum drying and ring drying. It is also beneficial that some of the vitamins, minerals and phytochemical compounds naturally in the sugar are retained so the sugar retains nutritional value and is not a “hollow nutrient”.

One advantage of the spray dried amorphous sweetener of the present invention (for embodiment using cane juice, beet juice or molasses as a sucrose source) is that the spray dried sugar is utilising a former sugar waste stream, molasses, to increase sugar production or utilising a less refined product cane juice to increases production and improve efficiency when compared to preparation of traditional crystalline sugars.

### Foods/Beverages

The invention also relates to foods or beverages comprising one or more amorphous sweeteners according to any aspect or embodiment of the invention. Optionally the food is a confectionary product, a dairy product, a dietary supplement or a baked good.

Suitable confectionary products include fat or oil based confectionary products in which the added sugar is replaced in whole or in part with an amorphous sweetener of the invention (preferably a sucrose containing amorphous sweetener of the invention).

In some embodiments, the invention provides a food product selected from the group consisting of chocolate, cakes and baked goods, wherein the food product comprises an amorphous sweetener of the invention. In some embodiments, the invention provides a food product selected from the group consisting of ice-cream, dairy-based beverages, dairy-based powders, yoghurt, soups, powdered soups, edible spreads, and dietary supplements such as infant formula, protein/weight loss/prebiotic shakes, protein/weight loss/prebiotic powdered shakes and protein/weight loss/prebiotic bars, wherein the food product comprises an amorphous sweetener of the invention.

Optionally, all or part of the added sugar of the food product is substituted for the amorphous sugar of the invention. Preferably, greater than about 20% of the added sugar of the food product is substituted for the amorphous sugar of the invention, more preferably greater than about 40%, more preferably greater than about 60%, more preferably greater than about 80%. Substitution is optionally calculated on a volume basis or a weight basis.

For example, the present invention provides a chocolate containing an aerated amorphous sweetener of the invention. The chocolate coats the aerated amorphous sweetener particles coated with chocolate to form particles of up to about 100 μm in diameter. A chocolate with particles of smaller size, eg less than 30 μm in diameter or less than 20 μm in diameter, may be prepared by sieving the aerated amorphous sweetener to remove larger particles. Similarly, smaller particles could be removed if desired.

In another aspect, the present invention provides a baked good containing an aerated amorphous sweetener of the invention. The baked good is optionally a biscuit, cake or muffin.

In another aspect, the present invention provides an edible spread comprising an aerated amorphous sweetener of the invention. The edible spread is optionally a jam (jelly) or a nut-based spread, such as a hazelnut-based spread, peanut butter or almond butter.

In another aspect, the present invention provides a dairy product comprising an aerated amorphous sweetener of the invention. The dairy product is optionally an ice cream, drink or yoghurt. It is preferred that the amorphous aerated sweetener of the invention used in the dairy product comprises WPI. Optionally, the amorphous aerated sweetener of the invention only partially substitutes the added sugar and the dairy product includes another sweetener, such as granulated sugar. Preferably, the dairy product is an ice cream.

In another aspect, the present invention provides a beverage containing an amorphous sweetener or alternative sweetener according to any aspects, alternate aspect or embodiment of the invention. Optionally, the alternative sweetener is monk fruit or low GI density lowering agent is an intense sweetener such as monk fruit. Preferably, the beverage is a water based beverage. Optionally, the beverage is a milk based beverage.

The beverage containing the amorphous sugar of the invention comprises 0-10% w/w protein (optionally 1-10% or 1-5% w/w), 1-10% w/w fat (optionally 2-10% or 2-6% w/w) and 0-10% w/w carbohydrate (optionally 1-10% w/w or 3-7% w/w) in water. Alternatively, the beverage containing the amorphous sugar of the invention comprises 0-10% w/w protein (optionally 1-10% or 1-5% w/w), 0-10% w/w fat (optionally 2-10% or 2-6% w/w) and 1-10% w/w carbohydrate (optionally 1-10% w/w or 3-7% w/w) in water. The beverage may further include sodium and/or calcium, for example, 0.01-0.06 or 0.04-0.05% sodium and/or 0.05-0.15 or 0.08-0.12% w/w calcium.

In yet another aspect, the present invention provides a composition comprising (i) an amorphous sweetener or amorphous alternative sweetener according to any aspects, alternate aspect or embodiment of the invention and milk powder, coffee and/or chocolate. These compositions are suitable for the preparation of beverages (ie for combining with milk or water to prepare coffee, chocolate or mocha drinks) or as an ingredient in foods, for example, baked goods. Optionally, the amorphous sweetener or alternative sweetener is a prebiotic sugar or alternative sweetener according to the invention.

In the foods, chocolate, baked goods and composition described in this section, it is preferred that the low density of the sugar is retained throughout the preparation of the food and is present in the food in its aerated form. Optionally, the aeration in the particles of the amorphous sweetener is retained throughout the preparation of the food. This allows to additional bulking of the food, which in turn can allow for a sugar reduction in the food. Without being bound by theory, this is thought to be effective because a subject consuming the food only tastes the sugar on the surface of the sugar particle. The sugar from an amorphous sweetener is tasted readily while the sugar from a crystalline sugar is tasted more slowed due to the time taken for the sugar compound to be released from the crystalline structure. The sugar in the centre of the particle is never tasted. Therefore, if part of the centre of the sugar particle is protein or fibre or air, the consumer of the particle may not register the difference but the sweetness of the sugar particle may be retained or even improved and the bulking effect of the sugar may also be retained or even improved.

In some embodiments the foods of the invention stably contain the amorphous sweetener of the invention, that is, the amorphous sweetener of the invention (i) retains its approximate density and/or particle size (eg within 10% by volume); (ii) retains its aerated structure in the food, and/or (iii) retains its amorphous nature in the food. The inventors have confirmed retention of the aerated structure using SEM in at least chocolate and icecream products.

Optionally, the amorphous sweetener of the invention is stable in a food of the invention for 3 months, 6 months, 12 months, 1 year or 2 years. Specifically, the amorphous sweetener of the invention (i) retains its approximate density and/or particle size (eg within 10% by volume); (ii) retains its aerated structure in the food, and/or (iii) retains its amorphous nature in the food for 3 months, 6 months, 12 months, 1 year or 2 years in the usual packaging and storage conditions for that food.

### Lowering the GI/GL of a Food/Beverage

In another aspect, the present invention provides a method of lowering the GR, GI and/or GL of a food or beverage comprising using a low GI and/or low GL amorphous sweetener of this invention to prepare a food/beverage. It will be apparent to the skilled person that where the amorphous sweetener of the invention contains an amount of sucrose (and other sugars) and an amount of a low GI density lowering agent, the GI of the amorphous sweetener will vary depending on the proportion of sugar to low GI density lowering agent. The GL will further vary with the amount of sugar consumed.

In another aspect, the present invention provides a method of lowering the GI of a meal, in particular a carbohydrate containing meal, comprising consuming a dietary supplement up to 30 minutes before, during or up to 30 minutes after eating the meal, wherein the supplement comprises the amorphous sweetener of the invention.

### Method of Preparing Food

In another aspect, the present invention provides a method of preparing a chocolate or baked good in which the traditional sugar in the recipe has been substituted by a sugar according to the invention, wherein (i) the non-sugar ingredients of the chocolate or baked good are combined and (ii) the amorphous sweetener is mixed with the non-sugar ingredients immediately prior to baking/setting.

Alternatively, the present invention provides a method of preparing a chocolate or baked good in which the traditional sugar in the recipe has been substituted by a sugar according to the invention, wherein (i) half of the total amorphous sweetener required is added when the traditional sugar would have been added, and (ii) the remainder of the amorphous sweetener is mixed with the other ingredients immediately prior to baking/setting.

Alternatively, the present invention provides a method of preparing a chocolate or baked good in which the part of the traditional sugar in the recipe has been substituted by an amorphous sweetener according to the invention, wherein (i) the traditional sugar is added when the traditional sugar would traditionally have been added, and (ii) the amorphous sweetener is mixed with the other ingredients immediately prior to baking/setting.

Alternatively, the present invention provides a method of preparing a chocolate comprising an amorphous sweetener of the invention, wherein the amorphous sweetener of the invention is added following conching of the chocolate. It is preferred that the amorphous aerated sweetener of the invention is not added to the aqueous phase of chocolate or a food product comprising chocolate. It is preferred that the amorphous aerated sweetener of the invention is added to the fat or oil of the chocolate or to an already formed emulsion. It is preferred that the chocolate product comprising the amorphous aerated sweetener of the invention is maintained at a temperature below the glass transition temperature of the amorphous aerated sweetener.

The chocolate or baked good optionally comprises amorphous sweetener particles of less than 30 μm or less than 20 μm in diameter.

It is preferred that the D50 of the amorphous aerated sweetener of the invention to be added to chocolate is less than about 60 μm, about 50 μm, about 40 μm, about 30 μm or about 20 μm. It is preferred that the amorphous aerated sweetener of the invention to be added to chocolate and/or milk products comprises WPI.

In another aspect, the present invention provides a method of making an icecream comprising the low density amorphous sweetener of the invention, wherein the amorphous sweetener is added to the icecream ingredients during the churning stage of icecream manufacture. Optionally, chilling is also occurring during the churning stage. Preferably the addition of the amorphous sweetener occurs when a significant proportion of the water being churned has frozen, such as, 30% or more, or 50% or more or 70% or more frozen. Adding the amorphous sweetener at this processing stage assist with the amorphous sweetener retaining its structure in the icecream.

As used herein, except where the context requires otherwise, the term “comprise” and variations of the term, such as “comprising”, “comprises” and “comprised”, are not intended to exclude further additives, components, integers or steps.

Further aspects of the present invention and further embodiments of the aspects described in the preceding paragraphs will become apparent from the following description, given by way of example and with reference to the accompanying drawings.

### BRIEF DESCRIPTION OF THE DRAWINGS

FIG. 1 is a diagram of a typical counter current spray dryer (G=gas/air, F=feed, P=powder, S=spray)

FIG. 2 depicts moisture content of 80:20 cane juice to whey protein isolate vs average drying chamber temperature for samples 2 to 4 of Table 6.

FIG. 3A is a scanning electron microscope (SEM) image of the 80:20 CJ:WPI % solids amorphous sugar, wherein the scale bar corresponds to 100 μm.

FIG. 3B is a scanning electron microscope (SEM) image of the 70:30 CJ:WPI % solids amorphous sugar, wherein the scale bar corresponds to 100 μm.

FIG. 4 graphs the results of an in vitro Glycemic Index Speed Test (GIST) on the 90:10 CJ:WPI sugar from Example 8 showing the sugar is low glycaemic.

FIG. 5A charts the results of a study on the effect of polyphenol content or polyphenol plus reducing sugar content on the GI of sucrose in the form of traditional refined white sugar. 30, 60 and 120 mg CE polyphenol/100 g carbohydrate content was tested. The GI for sucrose with 60 mg CE polyphenol/100 g carbohydrate was shown to be about 15. Adding 0.6% w/w reducing sugars (1:1 glucose to fructose) to the sucrose with 30 mg CE polyphenols/100 g carbohydrate raised the GI from 53 to 70. Adding 0.6% w/w reducing sugars (1:1 glucose to fructose) to the sucrose with 60 mg CE polyphenols/100 g carbohydrate raised the GI from 15 to 29. Adding 1.2% w/w reducing sugars (1:1 glucose to fructose) to the sucrose with 120 mg CE polyphenols/100 g carbohydrate increased the GI from 65 to 75. The presence of reducing sugar consistently increased the GI.

FIG. 5B graphs the GI of several samples from Table 10 in Example 9.

FIG. 6 depicts the sensory profile of the 90:10, 80:20 and 70:30 CJ:WPI % solids amorphous sugars from Example 8. The 90:10 and 80:20 sugars are sweeter than refined white sugar, while the 70:30 is equivalently sweet. The 90:10 and 80:20 sugars have a caramel taste. The 80:20 and 70:30 sugars have a milky taste.

FIG. 6A-E are SEM images of the aerated sugars of Example 11, wherein the scale bar in FIG. 6A corresponds to 20 μm, the scale bar in FIG. 6B corresponds to 20 μm, the scale bar in FIG. 6C corresponds to 10 μm, the scale bar in FIG. 6D corresponds to 10 μm and the scale bar in FIG. 6E corresponds to 20 μm.

FIG. 6 shows that in general, the particle size is not evenly distributed. Some particles are about 60 μm, others are less than 10 μm. A great number of porous particles were detected, especially from the chipped particle powders.

FIG. 7 shows an image of 3 g of white crystal sugar and 3 g of the aerated amorphous sugar prepared according to this Example 11. The image illustrates the difference in bulk density. The tapped bulk density of the white crystal sugar was calculated to be approximately 0.88 g/cm³. The tapped bulk density of the aerated amorphous sugar prepared according to this Example 11 was found to be approximately 0.47 g/cm³. Bulk density was calculated as described in Example 5.

FIG. 8A-D are SEM images that show the chocolate of Example 13 prepared with sugar crystals.

The sample indicates solid chocolate with tactile sugar crystals.

FIG. 8E-H are SEM images that show the chocolate of Example 13 prepared with the aerated amorphous sugar, wherein the scale bar in FIG. 8E corresponds to 10 μm, the scale bar in FIG. 8F corresponds to 10 μm, the scale bar in FIG. 8G corresponds to 10 μm and the scale bar in FIG. 8H corresponds to 10 μm.

These images show that the aerated sugar particles remain intact in the chocolate product and have not lost their aeration during food preparation. While the aeration is less evident due to a layer of fat coating the sugar, the particle remains aerated as it retains its pre-processing size and shape.

FIG. 9A-C are SEM images of product 1 from Table 13 (comprising rice syrup), wherein the scale bar in FIG. 9A corresponds to 500 μm, the scale bar in FIG. 9B corresponds to 50 μm and the scale bar in FIG. 9C corresponds to 30 μm.

FIG. 9A-C shows that in general, the particle size is reasonably evenly distributed, with most particles ranging from about 25 μm to about 50 μm in size. Porosity was observed.

FIG. 9D-E show SEM images of product 2 from Table 13 (comprising coconut sugar), wherein the scale bar in FIG. 9D corresponds to 300 μm and the scale bar in FIG. 9E corresponds to 20 μm.

FIG. 9D-E shows that in general, the particle size is reasonably evenly distributed, with most particles ranging from about 20 μm to about 55 μm in size. Porosity was observed.

FIG. 9F-G show SEM images of product 3 from Table 13 (comprising monk fruit), wherein the scale bar in FIG. 9F corresponds to 30 μm and the scale bar in FIG. 9G corresponds to 10 μm. This product was about 8 times sweeter than sucrose.

FIG. 9F-G shows that in general, the particle size is not evenly distributed. Some particles are about 100 μm, others are around 10 μm. Porosity was observed.

FIG. 9H-I show SEM images of product 4 from Table 13 (comprising maple syrup), wherein the scale bar in FIG. 9H corresponds to 300 μm and the scale bar in FIG. 9I corresponds to 20 μm.

FIG. 9H-I shows that in general, the particle size is reasonably evenly distributed, with most particles ranging from about 30 μm to about 60 μm in size. Porosity was observed.

FIG. 9J-K show SEM images of product 6 from Table 13 (comprising bagasse), wherein the scale bar in FIG. 9J corresponds to 100 μm and the scale bar in FIG. 9K corresponds to 10 μm.

FIG. 9J-K shows that in general, the particle size is reasonably evenly distributed, with most particles ranging from about 20 μm to about 30 μm in size. Porosity was observed.

FIG. 9L-M show SEM images of product 7 from Table 13 (comprising sunflower protein), wherein the scale bar in FIG. 9L corresponds to 200 μm and the scale bar in FIG. 9M corresponds to 50 μm.

FIG. 10 shows SEM images of the butter cookie prepared according to Example 15, wherein the scale bar in FIG. 10A corresponds to 10 μm and the scale bar in FIG. 10B corresponds to 10 μm.

These images show that the aerated sugar particles remain intact in the cookie product and have not lost their aeration during food preparation. While the aeration is less evident due to a layer of fat coating the sugar, the particle remains aerated as it retains its pre-processing size and shape.

FIG. 11 shows SEM images of the vanilla muffin prepared according to Example 15, wherein the scale bar in FIG. 11A corresponds to 20 μm and the scale bar in FIG. 11B corresponds to 10 μm.

These images show that the aerated sugar particles remain intact in the muffin product and have not lost their aeration during food preparation. While the aeration is less evident due to a layer of fat coating the sugar, the particle remains aerated and it retains its pre-processing size and shape.

FIGS. 12A-D show SEM images of product 7 from Table 17 (comprising pea protein isolate), wherein the scale bar in FIG. 12A corresponds to 30 μm, the scale bar in FIG. 12B corresponds to 80 μm, the scale bar in FIG. 12C corresponds to 80 μm and the scale bar in FIG. 12D corresponds to 20 μm.

Porosity was observed.

FIGS. 13A-D show SEM images of product 6 from Table 17 (comprising egg white protein), wherein the scale bar in FIG. 13A corresponds to 100 μm, the scale bar in FIG. 13B corresponds to 10 μm, the scale bar in FIG. 13C corresponds to 10 μm and the scale bar in FIG. 13D corresponds to 50 μm.

Hollow bubbles with thin skin were observed.

FIGS. 14A-G show SEM images of product 8 from Table 17 (comprising aeration prior to spray drying), wherein the scale bar in FIG. 14A corresponds to 30 μm, the scale bar in FIG. 14B corresponds to 100 μm, the scale bar in FIG. 14C corresponds to 30 μm, the scale bar in FIG. 14D corresponds to 50 μm, the scale bar in FIG. 14E corresponds to 30 μm, the scale bar in FIG. 14F corresponds to 8 μm and the scale bar in FIG. 14G corresponds to 30 μm.

Porosity was observed.

FIG. 15A shows an SEM image of a product prepared from 10% sunflower protein, 5% lecithin and 85% sugarcane juice, wherein the scale bar is 50 μm.

FIG. 15B shows an SEM image of product 7 from Table 14 (comprising 10% sunflower protein), wherein the scale bar is 50 μm.

The particles of the SEM images of FIG. 15A and FIG. 15B are both similar in size and morphology, with hollow bubbles with thin skin observed.

FIGS. 16A-D show SEM images of aerated sugar particles comprising 80% sugarcane juice, 19% digestive resistant maltodextrin and 1% fibre (phytocel-bagasse fibre and soluble fibre-xanthan gum); wherein the scale bar in FIG. 16A corresponds to 80 μm, the scale bar in FIG. 16B corresponds to 20 μm, the scale bar in FIG. 16C corresponds to 20 μm and the scale bar in FIG. 16D corresponds to 30 μm.

The presence of fibre altered the morphology of the particles, with a non-uniform surface observed.

FIGS. 17A-B show SEM images of aerated sugar particles comprising 80% sugarcane juice and 20% sunflower protein.

No significant porosity was observed in the particles.

FIGS. 18A-B show SEM images of aerated sugar particles comprising 90% sugar cane juice and 10% monk fruit juice.

Round particles with morphology consistent with hollow bubbles with a thin skin were observed. Non-uniform elongated particles with a rough surface were also observed.

FIGS. 19A-B show SEM images of aerated sugar particles comprising 80% sugar cane juice, digestive resistant maltodextrin (19%) and insoluble fibre (bagasse) (1%).

Round particles with morphology consistent with hollow bubbles with a thin skin were observed. Collapsed particles were also observed.

FIGS. 20A-B show SEM images of aerated sugar particles comprising 80% sugar cane juice, digestive resistant maltodextrin (19%) and soluble fibre (xanthan gum) (1%).

Amorphous particles were observed. String-like masses were also observed.

FIGS. 21A-B show SEM images of aerated sugar particles comprising 78% sugar cane juice.

Round particles with morphology consistent with hollow bubbles with a thin skin were observed. Collapsed particles were also observed.

FIGS. 22A-B show SEM images of aerated sugar particles comprising 80% sugarcane juice, 19% WPI and 1% prebiotic fibre (phytocel-bagasse fibre and soluble fibre-xanthan gum).

Morphology consistent with essentially smooth, hollow nodules was observed.

FIGS. 23A-B show SEM images of aerated sugar particles comprising 80% sugarcane juice, 19% digestive resistant maltodextrin and 1% fibre.

A mixture of round particles and particles of non-uniform shape were observed.

FIGS. 24A-B show SEM images of aerated sugar particles comprising 75% sugarcane juice, 19% digestive resistant maltodextrin, 5% lecithin and 1% fibre.

A mixture of round particles and surfaces with jagged edges were observed.

FIGS. 25A-F compare the sensory profile of white refined sugar with various aerated amorphous sweeteners, as follows: A) entry 4 of Table 17 (comprising 80% sugar cane juice, 20% whey protein); B) comprising 80% sugar cane juice, 20% sunflower protein; C) comprising 80% sugar cane juice, 20% monk fruit; D) comprising 90% sugar cane juice, 10% insoluble fibre (bagasse); E) comprising 90% sugar cane juice, 10% soluble fibre; and F) comprising low glycemic raw sugar (30 mg CE polyphenols/100 g).

A, C and F are sweeter than white refined sugar. E is equally sweet. A is mouth watering and has a caramel and milky taste. B has an off flavour and a caramel taste. C has aroma and is mouth watering. D has a caramel taste. E has a milky and caramel taste. F has aroma and is mouth watering. It also has a caramel taste.

FIGS. 26A-F compare the sensory profile of white refined sugar with various aerated amorphous sweeteners from Table 18; as follows: A) entry A; comprising low glycemic raw sugar (30 mg CE polyphenols/100 g); B) entry B; comprising cane juice; C) entry C; comprising cane juice with sunflower protein (20%); D) entry D; comprising cane juice with monkfruit (10%); E) entry E; comprising cane juice with digestive resistant maltodextrin (19%), insoluble fibre (bagasse) (1%); and F) entry F; comprising cane juice with digestive resistant maltodextrin (19%), soluble fibre (xanthan gum) (1%).

A, B and D are sweeter than white refined sugar. F is equally sweet. A has aroma, is mouth watering and has a caramel taste. B has aroma, is mouth watering and has a caramel and milky taste. C has an off flavour D has an aroma and is mouth watering. E has a caramel taste. F has a milky taste.

The taste profile of C suggests that this product would be more useful in foodstuffs that cover the flavour of C or in foodstuff where the amount of sugar required is reduced.

### DETAILED DESCRIPTION OF THE EMBODIMENTS

Reference will now be made in detail to certain embodiments of the invention. While the invention will be described in conjunction with the embodiments, it will be understood that the intention is not to limit the invention to those embodiments. On the contrary, the invention is intended to cover all alternatives, modifications, and equivalents, which may be included within the scope of the present invention as defined by the claims.

Further aspects of the present invention and further embodiments of the aspects described in the preceding paragraphs will become apparent from the following description, given by way of example.

All of the patents and publications referred to herein are incorporated by reference in their entirety.

For purposes of interpreting this specification, terms used in the singular will also include the plural and vice versa.

One skilled in the art will recognize many methods and materials similar or equivalent to those described herein, which could be used in the practice of the present invention. The present invention is in no way limited to the methods and materials described.

The inventors of the present invention have developed a low density amorphous sweetener comprising a sweetener and a density lowering agent. The sugar has fewer calories per volume of sweetener than traditional table sugar and will be of assistance when seeking to lower the total calories in a food.

Low GI versions of the sweetener can also be prepared to reduce the GR, GI and/or GL of foods.

A prebiotic version of the sugar has also been developed. As many popular foods, particularly foods with high sugar content, have a less than ideal impact on to the gastro-intestinal microbiome, the preparation of prebiotic sugars is a highly significant advance. The prebiotic sugars of the invention provide sugar substitutes that avoid one of the less desirable aspects of sugar and introduce a desirable prebiotic effect into sugars that will increase the health benefits of foods comprising the prebiotic sugars.

The term “aerated” refers to including air. In particular, in the context of this invention an aerated particle is one that includes air pockets or air bubbles ie is porous in nature.

The term “amorphous” refers to a solid that is largely amorphous, that is, largely without crystalline structure. For example, the solid could be 80% or more amorphous, 90% or more amorphous, 95% or more amorphous or about 100% amorphous.

The term “bagasse” refers to sugar fibre either from sugar cane or sugar beet. It is the fibrous pulp left over after sugar juice is extracted. Bagasse products are commercially available, for example, Phytocel is a sugar cane bagasse product sold by KFSU.

The term “drying agent” refers to an agent that is suitable for rapid drying with sucrose to achieve a dry powder as opposed to the sticky powder achieved is sucrose is dried alone.

The term “high molecular weight drying agent” refers to a drying agent with a molecular weight above that of sucrose, for example, about the molecular weight of lactose or higher.

The term “density lowering agent” refers to an edible product with lower bulk density than bulk white sugar. Preferably, the density is less than 0.7 g/m³. Preferably, the product is soluble or in powder form.

The term “low glycaemic” refers to a food with a glucose based GI of 55 or less.

The term “very low glycaemic” refers to a food with a glucose-based GI of less than half the upper limit of low GI (ie the GI is in the bottom half of the low GI range).

The term “sugar” refers to a solid that contains one or more low molecular weight sugars (monosaccharides) such as glucose or disaccharides such as sucrose etc. In the context of the invention, the sugars referred to are edible sugars used in the production of food. The amorphous sugars of the invention could be spray dried cane juice or molasses but could also be spray dried fruit juice.

The term “reducing sugar” refers to any sugar that is capable of acting as a reducing agent. Generally, reducing sugars have a free aldehyde or free ketone group. Glucose, galactose, fructose, lactose and maltose are reducing sugars. Sucrose and is not a reducing sugar.

The term “phytochemical” refers generally to biologically active compounds that occur naturally in plants.

The term “polyphenol” refers to chemical compounds that have more than one phenol group. There are many naturally occurring polyphenols and many are phytochemicals. Flavonoids are a class of polyphenols. Polyphenols including flavonoids naturally occur in sugar cane. In the context of the present invention the polyphenols that naturally occur in sugar cane are most relevant. Polyphenols in food are micronutrients that are of interest because of the role they are currently thought to have in prevention of degenerative diseases such as cancer, cardiovascular disease or diabetes.

The term “refined white sugar” refers to fully processed food grade white sugar that is essentially sucrose with minimal reducing sugar content and minimal phytochemicals such as polyphenols or flavonoids.

The term “massecuite” refers to a dense suspension of sugar crystals in the mother liquor of sugar syrup. This is the suspension that remains after concentration of the sugar juice into a syrup by evaporation, crystallisation of the sugar and removal of molasses. The massecuite is the product that is washed in a centrifuge to prepare bulk sugar crystals.

The term “sugar juice” refers to the syrup or liquid extracted from sugar-rich plant feedstocks, such as the juice extracted following crushing/pressing sugar cane or the liquid exiting a diffuser during the processing of sugar beets.

The term “cane juice” or “sugar cane juice” refers to the syrup extracted from pressed and/or crushed peeled sugar cane. Ideally sugar cane juice is at least 60 Brix.

The term “beet juice” refers to the liquid exiting a diffuser after the beet roots have been sliced into thin strips called cossetes and passed into a diffuser to extract the sugar content into a water solution.

The terms “efficacious” or “effective amount” refer to an amount that is biologically effective. In this context, one example is an effective amount of polyphenols in the sugar particles to achieve a low GI sugar, ie, a sugar that causes a low increase in blood sugar levels once consumed such that an insulin response is avoided.

The term “hi-maize” or “high amylose maize starch” refers to a resistant starch, ie a high molecular weight carbohydrate starch that resists digestion and behaves more like a fibre. Hi-maize is generally made from high amylose corn. There are 2 main structural components of starch; amylose—a linear polymer of glucose residues bound via α-D-(1,4)-glycosidic linkages and amylopectin—a highly branched molecule comprising α-D-(1,4)-linked glucopyranose units with α-D-(1,6)-glycosidic branch points. Branch points typically occur between chain lengths of 20 to 25 glucose units, and account for approximately 5% of the glycosidic linkages. Normal maize starch typically consists of approximately 25 to 30% amylose and 75 to 80% amylopectin. High amylose maize starch contains 55 to >90% amylose. The structure for amylose is (with an average degree of polymerisation of 500):

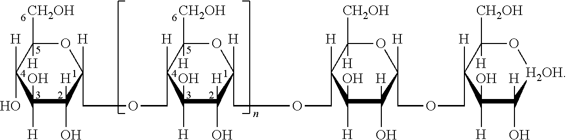

The structure for amylopectin is (with an average degree of polymerisation of 2 million):

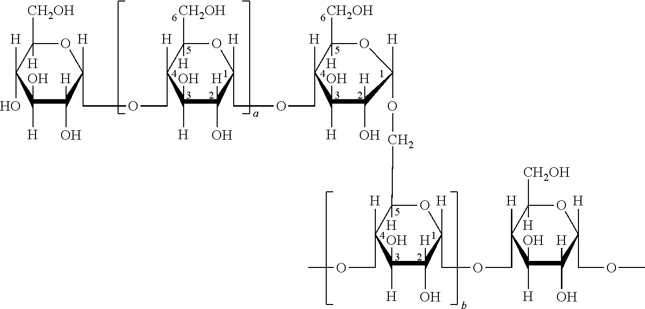

The term “inulin” refers to one or more digestive resistant high molecular weight polysaccharides having terminal glucosyl moieties and a repetitive frucosyl moiety linked by β(2,1) bonds. Generally, inulin has 2 to 60 degrees of polymerisation. The molecular weight varies but can be for example about 400 g/mol, about 522 g/mol, about 3,800 g/mol, about 4,800 g/mol or about 5,500 g/mol. Where there the degree of polymerisation is 10 or less the polysaccharide is sometimes referred to as a fructooligosaccharide. The term inulin has been used for all degrees of polymerisation in this specification. Inulin has the following structure:

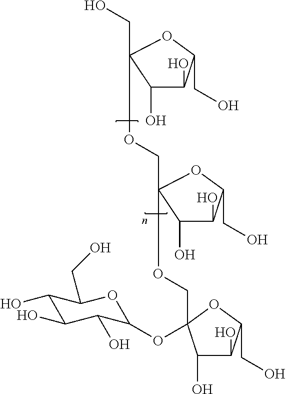

One option is to use Orafti Inulin with a molecular weight of 522.453 g/mol.

The term “dextrin” refers to a dietary fibre that is a D-glucose polymer with α-1,4 or α-1,6 glycosidic bonds. Dextrin can be cyclic ie a cyclodextrin. Examples include amylodextrin and maltodextrin. Maltodextrin is typically a mixture of chains that vary from 3 to 17 glucose units long. The molecular weight can be for example 9,000 to 155,000 g/mol.

The term “digestive resistant dextrin derivatives” refers to a dextrin modified to resist digestion. Examples include polydextrose, resistant glucan and resistant maltodextrin. Fibersol-2 is a commercial product from Archer Daniels Midland Company that is digestion resistant maltodextrin. An example structure is:

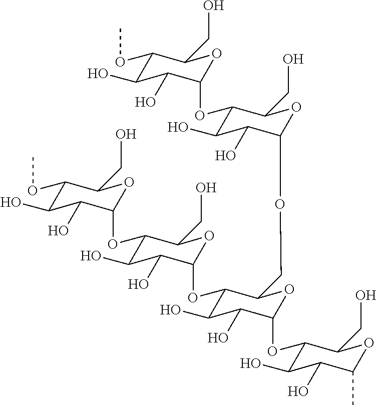

The term “whey protein isolate” refers to proteins isolated from milk, for example, whey can be produced as a by-product during the production of cheese. The whey proteins may be isolated from the whey by ion exchangers or by membrane filtration. Bovine whey protein isolate is a common form of whey protein isolate. Whey protein isolate has four major components: β-lactoglobulin, α-lactalbumin, serum albumin, and immunoglobulins. β-lactoglobulin has a molecular weight of 18.4 kDa. α-lactalbumin has a molecular weight of 14,178 kDa. Serum albumin has a molecular weight of 65 kDa. The immunoglobulin (Ig) in placental mammals are IgA, IgD, IgE, IgG and IgM. A typical immunoglobulin has a molecular weight of 150 kDa.

The term “high intensity sweetener” refers to either a natural or an artificial sweetener that has a higher sweetness than sucrose by weight ie less of the high intensity sweetener than the amount of sucrose is needed to achieve a similar sweetness level. Sucrose has a sweetness of 1 on the sucrose relative sweetness scale. For example, monk fruit extract has a sweetness value of about 150 to 300 times sweeter than sucrose, blackberry leaf extract is about 300 times sweeter than sucrose and stevia is about 200-300 times sweeter than sucrose. Monk fruit extract, blackberry leaf extract and stevia are examples of natural high intensity sweeteners because they are sourced from plant by extraction and/or purification.

The term “stevia” refers to a sweetener prepared from the stevia plant including steviol glycosides such as Steviol, Steviolbioside, Stevioside, Rebaudioside A (RA), Rebaudioside B (RB), Rebaudioside C(RC), Rebaudioside D (RD), Rebaudioside E (RE), Rebaudioside F (RF), Rubusoside and Dulcoside A (DA) or a sweetener comprising the highly purified rebaudioside A extract approved by the FDA and commonly marketed as “stevia”.

The term “prebiotic” refers to a food ingredient that stimulates the growth and/or activity of one or more beneficial gastrointestinal bacteria. Prebiotics may be non-digestible foods or of low digestibility. A prebiotic can be a fibre but not all fibres are prebiotic. Oligosaccharides with a low degree of polymerisation ie are thought to better stimulate bacteria concentration than oligosaccharides with higher degree of polymerisation.

The term “water activity” (a_{w}) is a measure of the partial vapor pressure of water in a substance divided by the standard state partial vapour pressure of water. Water migrates from areas of high a_{w} to areas of low a_{w}. Water activity is measured to determine shelf-stable foods. A water activity of 0.6 or less is preferred for foods and food ingredients of this type to inhibit mould and bacterial growth.

Particle size distribution can be defined using D values. A D90 value describes the diameter where ninety percent of the particle distribution has a smaller particle size and ten percent has a larger particle size. The particle size can be determined either by mass or by volume. Volume based measurement is preferred.

The D50, the volume basis median, is defined as the diameter where half of the population lies below this value. The D50 is described as the X50 when following certain ISO guidelines.

Optionally, the particle size of the sugar particles is measured dry or wet. A preferred instrument for measuring particle size dry is a Malvern Scirocco. Preferably, the instrument for measuring particle size dry is operated at reduced pressure, more preferably, at 0.5 bar. A preferred instrument for measuring particle size wet is a Malvern Mastersizer S. Preferably, the wet measurements are performed upon a suspension in isopropanol, more preferably, at a concentration of 0.5 g substrate to 50 mL of isopropanol. Both the Malvern Scirocco and Malvern Mastersizer S instruments express particle size distribution on a volume basis. For instance, the D50 provided by these instruments is the volume basis median.

Alternatively, particle size distribution can be expressed in other terms, for instance, in terms of the relative amount by mass, of particles according to size. The mass-median diameter provides the log-normal distribution mass median diameter and is considered to be the average particle diameter by mass.

Particle size distribution can also be described by particle size span. Particle size span=(D90−D10)/D50. It gives an indication of how far the 10 percent and 90 percent points are apart, normalised by the midpoint.

### Glycaemic Response (GR)

GR refers to the changes in blood glucose after consuming a carbohydrate-containing food. Both the GI of a food and the GL of an amount of a food are indicative of the glycaemic response expected when food is consumed.

### GI

The glycaemic index is a system for classifying carbohydrate-containing foods according to the relative change in blood glucose level in a person over two hours after consuming that a food with a certain amount of available carbohydrate (usually 50 g). The two hour blood glucose response curve (AUC) is divided by the AUC of a glucose standard, where both the standard and the test food must contain an equal amount of available carbohydrate. An average GI is usually calculated from data collected from 10 subjects. Prior to a test the person would typically have undergone a twelve hour fast. The glycaemic index provides a measure of how fast a food raises blood-glucose levels inside the body. Each carbohydrate containing food has a GI. The amount of food consumed is not relevant to the GI. A higher GI generally means a food increases blood-glucose levels faster. The GI scale is from 1 to 100. The most commonly used version of the scale is based on glucose. 100 on the glucose GI scale is the increase in blood-glucose levels caused by consuming 50 grams of glucose. High GI products have a GI of 70 or more. Medium GI products have a GI of 55 to 69. Low GI products have a GI of 54 or less. These are foods that cause slow rises in blood-sugar.

Those skilled in the art understand how to conduct GI testing, for example, using internationally recognised GI methodology (see the Joint FAO/WHO Report), which has been validated by results obtained from small experimental studies and large multi-centre research trials (see Wolever et al 2003).

In vitro GI testing is now also available, see Example 4.

### GL

Glycaemic load is an estimate of how much an amount of a food will raise a person's blood glucose level after consumption. Whereas glycaemic index is defined for each type of food, glycaemic load is calculated for an amount of a food. Glycaemic load estimates the impact of carbohydrate consumption by accounting for the glycaemic index (estimate of speed of effect on blood glucose) and the amount of carbohydrate that is consumed. High GI foods can be low GL. For instance, watermelon has a high GI, but a typical serving of watermelon does not contain much carbohydrate, so the glycaemic load of eating it is low.

One unit of glycaemic load approximates the effect of consuming one gram of glucose. The GL is calculated by multiplying the grams of available carbohydrate in the food by the food's GI and then dividing by 100. For one serving of a food, a GL greater than 20 is high, a GL of 11-19 is medium, and a GL of 10 or less is low.

### Cane Juice

Cane juice contains all the naturally occurring macronutrients, micronutrients and phytochemicals present in the syrup extracted from pressed and/or crushed peeled sugar cane that are normally removed in white refined sugar, which is 99.9% sucrose.

Molasses

Is a viscous by-product of sugar preparation, which is separated from the crystallised sugar. The molasses may be separated from the sugar at several stages of sugar processing. Molasses contains the same compounds as cane juice but is a more highly concentrated source of phytochemicals.

### Spray Drying and Other Drying Methods

Spray drying operates on the principle of convection to remove the moisture from the liquid feed, by intimately contacting the product to be dried with a stream of hot air. The spray drying process can be broken down into three key stages: atomisation of feedstock, mixing of spray and air (including evaporation process) and the separation of dried product from the air. Other appropriate drying methods include fluidized bed drying, ring drying, freeze drying and low temperature vacuum dehydration.

### Feedstock

The spray drying feed is liquid or suspension (preferably the sweetener and density lowering agent are dissolved). Combining the ingredients can result in bubbles. There is defoaming machinery available for use with spray driers if needed to reduce the foam generated before spray drying the feedstock. These often rely on pressure to collapse the bubbles.

It is also known in the art to add carbon dioxide (or other) gas to the feed stock (potentially under pressure) to increase the aeration of the feedstock before spray drying. With certain ingredients this approach can decrease the density of the particles produced.

### Atomisation

In order to ensure that the particles to be dried have the maximum surface area available to contact the hot air stream, the liquid feed is often atomised, producing very fine droplets ultimately leading to more effective drying. There are several atomiser configurations that exist, the most common being the wheel-type, pneumatic and nozzle atomisers.

A pneumatic high pressure nozzle atomiser was used for the experiments described below.

### Evaporation and Separation

The second stage of the spray drying process involves the evaporation of moisture by using hot gases which flow around the surface of the particles/droplets to be dried.

There are notably three different types of air-droplet contacting configurations that exist: co-current, counter-current and mixed flow, all of which have differing applications depending on the product to be dried.

Both co-current and counter-current drying chambers are able to be used for heat sensitive materials, however the use of mixed-flow drying chambers is restricted to drying materials that are not susceptible to quality degradation due to high temperatures.

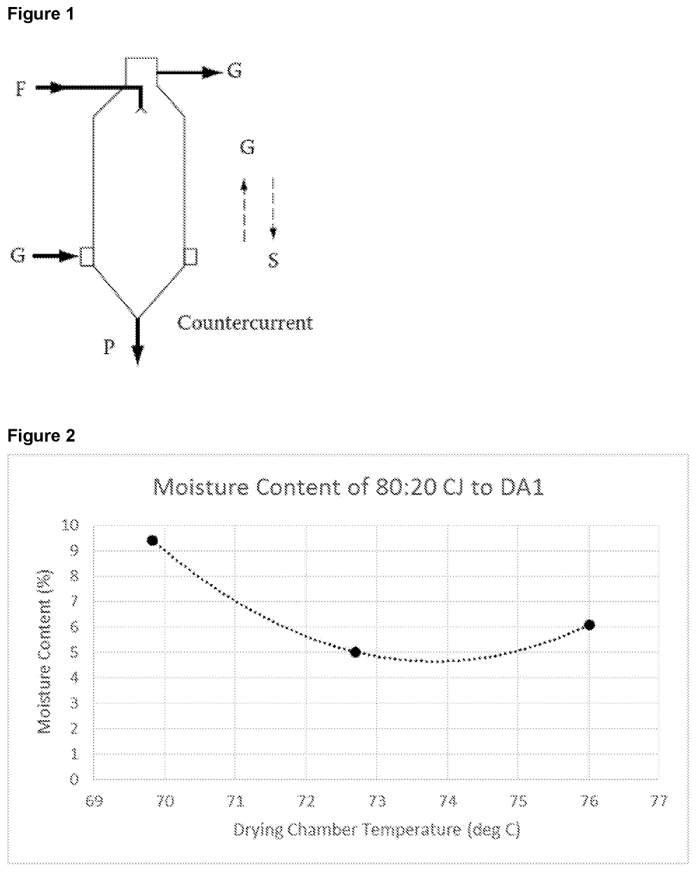

Representations of typical counter-current and co-current dryer setup is shown below in FIG. 1.

The final stage of the spray drying process is the separation of the powder from the air stream. The dry powder collects at the base of the drying chamber before it is discharged or manually collected.

### Glass Transition Temperature

The glass transition temperature (Tg) is the substance-specific temperature range at which a reversible change occurs in amorphous materials from the solid, glassy state to the supercooled liquid state or the reverse. The glass transition temperature becomes very important for the production of dried products, particularly in relation to the processing and storage stages of manufacture. The glass transition temperature of the powders can be determined via differential scanning calorimetry (DSC).

### ICUMSA

ICUMSA is a sugar colour grading system. Lower ICUMSA values represent less colour. ICUMSA is measured at 420 nm by a spectrophotometric instrument such as a Metrohm NIRS XDS spectrometer with a ProFoss analysis system. Currently, sugars considered suitable for human consumption, including refined granulated sugar, crystal sugar, and consumable raw sugar (ie brown sugar), have ICUMSA scores of 45-5,000.

### Prebiotic Testing

The prebiotic effect of the sugars and alternate sweeteners of the invention can be tested using the Triskelion TNO Intestinal Model 2. This in an in vitro model of the gastrointestinal tract including a model colon with a variety of bacterial species presence such that an increase in probiotic following consumption of the prebiotic can be measured.

### High Intensity Sweeteners

A natural low calorie sweetener, stevia, has also been developed and approved for use in many countries. Stevia is a high intensity sweetener meaning that one gram is much sweeter than one gram of sugar. Stevia has been used, in combination with sucrose, in several commercial products. However, consumers consider stevia to have an undesirable metallic aftertaste.

Monk fruit extract and blackberry leaf extract are alternative natural high intensity sweeteners.

### Monk Fruit Extract and Blackberry Leaf Extract

Monk fruit extract is of interest because it has zero glycaemic index, contains no calories and is a natural product. The sweetness is from the mogrosides which make up about 1% of monk fruit. Monk fruit extract is being cultivated in New Zealand by BioVittoria. Monk fruit extract is also heat stable and has a long shelf life making it suitable for cooking and storage.

Monk fruit extract is prepared by crushing monk fruit and extracting the juice in water. The extract is filtered and the triterpene glycosides called mogrosides collected. It is sold in both liquid and powdered form. The extract is often combined with a bulking agent in powdered form.

Monk fruit extract costs more than stevia but has a less intense metallic after taste than stevia.

The sweetness index for monk fruit extract is up to 300 ie it is up to 300 times sweeter than sucrose depending on the specific extract used.

Blackberry leaf extract is similarly prepared by extracting blackberry leaves.

Stevia can be prepared by extracting stevia leaves but it is often further purified to improve the proportion of Rebaudioside A to other components with less beneficial flavour profiles.

Both monk fruit extract and blackberry extract are available from Hunan NutraMax Inc, F25, Jiahege Building, 217 Wanjiali Road, Changsha, China 410016, http://www.nutra-max.com/

### Food Grade

Food grade foods are those safe for human consumption. For example the metals present in traditional sugar are removed (for example using magnets) so that traditional sugar is food grade. Food grade edible products have acceptable levels of organic waste like bird droppings (achieved, for example, either by ensuring no access to birds following crushing of the cane/beet and/or by washing or other waste removal processes), and/or acceptable levels of pesticides, herbicides, heavy metal and/or other toxins. Food grade edible products meet the regulatory/quality control requirements for human food.

### Bulk Density of Common Materials

Bulk density may be measured as described in Example 5. The table below provides the bulk density of some common materials that are suitable density lowering agents of the invention.

| | | Bulk Density |
|---|---|---|
| Bulk Material | lb/ft³ | g/cm³ |
| Brown Rice Flour | 20.5 | 0.33 |
| Caffeinated Coffee Grounds | 33 | 0.53 |
| Cake Flour | 33 | 0.53 |
| Cheese Powder | 40 | 0.64 |
| Cheese Powder Blend | 28 | 0.45 |
| Chestnut Extract Powder | 26 | 0.42 |
| Chocolate | 40 | 0.64 |
| Chocolate Pudding Dry Mix | 30 | 0.48 |
| Chocolate Volcano Cake Base | 30 | 0.48 |
| Cinnamon | 40 | 0.64 |
| Coffee (Decaf) | 34 | 0.54463 |
| Corn Meal | 40 | 0.64 |
| Corn Starch | 36 | 0.58 |
| Dehydrated Potatoes | 24 | 0.38 |
| Dehydrated Soup | 21 | 0.34 |
| Dehydrated Vegetables | 42 | 0.67 |
| Dried Brewers Yeast | 35 | 0.560646 |
| Dried Yeast | 31 | 0.5 |
| Dry Milk | 37 | 0.59 |
| Dry Milk Powder (Non-Fat) | 35 | 0.560646 |
| Flour | 39 | 0.62 |
| Flour (High Gluten) | 42 | 0.67 |
| Flour (Pancake Mix) | 37.5 | 0.6 |
| Flour Breading | 39 | 0.62 |
| Flour Mix | 31 | 0.5 |
| Food Grade Starch | 38 | 0.61 |
| Fumed Silica | 25 | 0.4 |
| Ground Almonds | 22 | 0.35 |
| Ground Cinnamon | 35.7 | 0.57 |
| Ground Coffee | 41 | 0.66 |
| Guar Gum | 23.5 | 0.38 |
| Gum Premix (Guar Gum, Locust Bean Gum, | 28 | 0.45 |
| Kappa Carragenan) | | |
| Ice Cream Powder (Chocolate) | 27 | 0.43 |
| Malt Mix | 31.5 | 0.5 |
| Malted Milk Powder | 36 | 0.58 |
| Maltitol Nutriose Blend | 30 | 0.48 |
| Marshmallow Mix | 43 | 0.688794 |
| Milk Powder | 35 | 0.560646 |
| Milk Powder Based Feed | 35 | 0.560646 |
| Milk Powder, Whole | 31 | 0.5 |
| Mixed Spices | 31 | 0.5 |
| Mustard Flour | 27 | 0.43 |
| Onion Powder | 39 | 0.62 |
| Pancake Mix | 33 | 0.53 |
| Pepperoni Spice | 19 | 0.3 |
| Potato Flour | 34 | 0.54463 |
| Potato Pancake Mix | 31 | 0.5 |
| Potato Starch | 16 | 0.26 |
| Poultry Gravy | 33.6 | 0.54 |
| Poultry Seasoning | 32 | 0.51 |
| Powdered Candy ingredients | 40 | 0.64 |
| Powdered Caramel Color | 30 | 0.48 |
| Powdered Dessert | 40 | 0.64 |
| Protein Drink Mix - Whey, Sweetener, | 24 | 0.38 |
| Nutrients | | |
| Protein Drink Mixes (Vanilla, Chocolate) | 27 | 0.43 |
| Protein Mix (French Vanilla) | 27 | 0.43 |
| Salt | 36 | 0.58 |
| Salt & Milk Powder Mix | 42 | 0.67 |
| Salt & Vinager Seasoning Mix | 41 | 0.66 |
| Seaweed Powder | 40 | 0.64 |
| Silica | 15 | 0.24 |
| Silicate Powder | 31.5 | 0.5 |
| Sodium Benzoate | 23 | 0.37 |
| Sodium Bicarbonate | 31.5 | 0.5 |
| Sodium Carbonate | 27 | 0.43 |
| Sodium Caseinate | 11 | 0.18 |
| Sodium Citrate (Citric Acid) | 40 | 0.64 |
| Soya Flour | 31 | 0.5 |
| Whey (Protein) Powder | 42.8 | 0.68 |
| Whey Feed Supplement | 32.8 | 0.53 |
| Whey Powder | 28.5 | 0.46 |
| Whey Protein | 26 | 0.42 |

### REFERENCES

International patent application no PCT/AU2017/050782.
Jaffé, W. R., (2012) Sugar Tech, 14:87-94.
Joint FAO/WHO Report. Carbohydrates in Human Nutrition. FAO Food and Nutrition. Paper 66. Rome: FAO, 1998.
Kim, Dae-Ok, et al (2003) Antioxidant capacity of phenolic phytochemicals from various cultivars of plums. Food Chemistry, 81, 321-26.
Singaporean patent application no SG 10201807121Q.
Wolever T M S et al. (2003) Determination of the glycemic index values of foods: an interlaboratory study. European Journal of Clinical Nutrition, 57:475-482.

A copy of each of these is incorporated into this specification by reference.

### EXAMPLES

### Example 1—Spray-Dried Cane Juice and Molasses with Various Low GI HMWCs

Solutions were prepared according to Table 1. Spray drying solutions were created at a ratio of 1 g of HMWC to 1 g of sucrose, in the form of either molasses or cane juice. These solutions were then made up to a concentration of 20% total solid and sprayed in 400 or 500 ml quantities.

TABLE 1
solutions for spray drying

| | | | % w/w | | |
|---|---|---|---|---|---|
| | | | Total | | |
| Number | Sample | Ratio | Solids | Viscosity | Solubility |
| 1, 2 & 3 | Inulin + Cane Juice | 1:1 | 20 | <21 Mpas | Yes* |
| 4 | Inulin + Molasses | 1:1 | 20 | <21 Mpas | Yes* |
| 5 | Hi Maize + Cane Juice | 1:1 | 20 | <21 Mpas | No |
| 6 | Hi Maize + Molasses | 1:1 | 20 | <21 Mpas | No |
| 9 | Dextrin + Cane Juice | 1:1 | 20 | <21 Mpas | Yes |
| 10 | Dextrin + Molasses | 1:1 | 20 | <21 Mpas | Yes |
| 11 | Lactose + Cane Juice | 1:1 | 20 | <21 Mpas | Yes |
| 12 | Lactose + Molasses | 1:1 | 20 | <21 Mpas | Yes |
| 13 | Cane Juice control | N/A | 20 | <21 Mpas | N/A |
| 14 | Molasses control | N/A | 20 | <21 Mpas | N/A |

*These solutions were fully dissolved but formed suspensions after overnight refrigeration.

The dextrin used was digestive resistant dextrin derivative.

TABLE 2
spray drying of solutions of Table 1
Each solution was filtered before spray drying.
The preferred method was stocking filtration.

| | Gun | Top | Bottom | Feed | |
|---|---|---|---|---|---|
| Number | Temp | Temp | Temp | pressure | Powder |
| 1 | 260 | 193 | 80 | 1.1 psi | 50% Liquid |
| 2 | 260 | 200 | 93 | 1.5 psi | 75% Liquid |
| 3 | 158 | 80 | n/a | 0.5 MPa | powder |
| 4 | 158 | 80 | 80 | 0.5 MPa | powder |
| 5 | 158 | 80 | n/a | 0.5 MPa | powder |
| 6 | 158 | 80 | n/a | 0.5 MPa | powder |
| 9 | 158 | 80 | n/a | 0.5 MPa | sticky powder |
| 10 | 158 | 80 | n/a | 0.5 MPa | sticky powder |
| 11 | 158 | 80 | n/a | 0.5 MPa | powder |
| 12 | 158 | 80 | n/a | 0.5 MPa | Powder |
| 13 | 158 | 80 | n/a | 0.5 MPa | Very sticky powder |
| 14 | 158 | 80 | n/a | 0.5 MPa | Very sticky powder |

Control solutions 13 and 14 did not include a HMWC and show that a suitable powder cannot be prepared without a HMWC additive.

Solutions 1 and 2 were spray dried using a co-current spray drier and produced liquid products. Later experiments with a co-current drier were successful but lower temperatures were used.

Solutions 3 to 14 were dried using a counter current spray drier. The drier was a pilot scale unit at Monash University. Similar results are expected if commercially available models are used. Viable powders were formed using the HMWCs inulin, hi-maize (corn starch) and lactose. The dextrin powders were too sticky for commercial use. However, it is expected that dextrin will be a suitable density lowering agent, if desiccant is added.

After a 4 week period of storage at room temperature and humidity, the inulin and hi-maize containing powders remained flowable powders. The lactose powders caked, likely due to the hygroscopicity of the lactose, but addition of a desiccant is likely to improve the shelf life of the powder.

Interestingly, there was no significant difference between the results achieved from the cane juice and molasses solutions. Two minor differences were that Hi-Maize with molasses formed a stickier (but still acceptable) powder than Hi-Maize with cane sugar and inulin with molasses resulted in a greater yield of non-sticky powder than inulin with cane sugar.

### Example 2—Analysis of Polyphenol Content in Amorphous Sugar, Cane Juice or Molasses

40 g of sample was accurately weighed into a 100 ml volumetric flask. Approximately 40 ml of distilled water was added and the flask agitated until the sample was fully dissolved after which the solution was made up to final volume with distilled water. The polyphenol analysis was based on the Folin-Ciocalteu method. In brief, a 50 μL aliquot of appropriately diluted raw sugar solution was added to a test tube followed by 650 μL of distilled water. A 50 μL aliquot of Folin-Ciocalteu reagent was added to the mixture and shaken. After 5 minutes, 500 μL of 7% Na₂CO₃ solution was added with mixing. The absorbance at 750 nm was recorded after 90 minutes at room temperature. A standard curve was constructed using standard solutions of catechin (0-250 mg/L). Sample results were expressed as milligrams of catechin equivalent (CE) per 100 g raw sample. The absorbance of each sample sugar was determined and the quantity of polyphenols in that sugar determined from the standard curve.

An alternative method for analysis of the polyphenol content is to measure the amount of tricin in a sample using near-infrared spectroscopy (NIR). In these circumstances, (where the polyphenols are sourced from sugar cane) the amount of tricin is proportional to the total polyphenols. Further information on this method is available in Australian Provisional Patent Application No 2016902957 filed on 27 Jul. 2016 with the title “Process for sugar production”.

Sucrose sugars with 20 to 45 mg CE polyphenols/100 g carbohydrates and 0 to 0.5 g/100 g reducing sugars are known to have low GI (see international patent application no. PCT/AU2017/050782). Sucrose sugars with 46 to 100 mg CE polyphenols/100 g carbohydrates and 0 to 1.5% w/w reducing sugars (with not more than 0.5% w/w fructose and 1% w/w glucose) are also known to be low GI (see Singaporean patent application no. SG 10201807121Q).

### Example 3—Analysis of the Reducing Sugar Content in Amorphous Sugar, Cane Juice or Molasses

There are several qualitative tests that can be used to determine reducing sugar content in a sample. Copper (II) ions in either aqueous sodium citrate or in aqueous sodium tartrate can be reacted with the sample. The reducing sugars convert the copper(II) to copper(I), which forms a copper(I) oxide precipitate that can be quantified.

An alternative is to react 3,5-dinitrosalicylic acid with the sample. The reducing sugars will react with this reagent to form 3-amino-5-nitrosalicylic acid. The quantity of 3-amino-5-nitrosalicylic acid can be measured with spectrophotometry and the results used to quantify the amount of reducing sugar present in the sample.

### Example 4—Determining the Amount of Solids Dissolved in Cane Juice or Molasses

A volume of the cane juice or molasses is filtered into a flask via a stocking. A petri dish is weighed and several drops of cane juice are placed on the petri dish and quickly re-weighed to avoid any moisture loss to the surrounding air. The petri dish is then left in an oven containing desiccant pellets at 70° C. overnight and weighed the following day. The sample is re-weighed and left in the oven until a consistent mass is observed. This mass is devoid of moisture and is the total amount of solid from the drops of cane juice. After being weighed, the mass can be calculated against the initial mass to find the mass fraction of total solids in the cane juice for further dilution.

### Example 5—Ratios of Drying Agent to Total Solids Tested

Once the total solids are tested, the drying agent (either hi-maize (HM), lecithin, whey protein isolate (WPI) or a combination thereof) is added in the specified mass ratio. The various solutions are then diluted to the final total solids percentage for the feed to be dried, and mixed thoroughly using a magnetic stirrer. The feed solution was prepared in a concentration that ensures that all solids are dissolved. The ratios and TS values of the tested samples are in Table 4.

TABLE 4
Spray dried cane juice prepared using the counter
current spray drier as used in Example 1 with varied amounts of
total solids (TS), ratios of cane juice (CJ), Whey Protein Isolate
(WPI) and Hi-Maize (HM) and inlet air temperature.

| | Total Solids | CJ : WPI : | Inlet Air |
|---|---|---|---|
| Test No. | (TS) % | HM (TS) | Temperature (° C.) |
| 1 | 10 | 70 : 30 : 0 | 160 |
| 2 | 10 | 80 : 20 : 0 | 160 |
| 3 | 10 | 90 : 10 : 0 | 160 |
| 4 | 10 | 95 : 5 : 0 | 160 |
| 5 | 10 | 98 : 2 : 0 | 160 |
| 6 | 10 | 99 : 1 : 0 | 160 |
| 7 | 10 | 99.5 : 0.5 : 0 | 160 |
| 8 | 10 | 50 : 0 : 50 | 160 |
| 9 | 10 | 60 : 0 : 40 | 160 |
| 10 | 10 | 70 : 0 : 30 | 160 |
| 11 | 10 | 80 : 0 : 20 | 160 |
| 12 | 10 | 90 : 0 : 10 | 160 |
| 13 | 10 | 60 : 30 : 10 | 160 |
| 14 | 10 | 60 : 20 : 20 | 160 |
| 15 | 10 | 60 : 30 : 10 | 160 |
| 16 | 10 | 60 : 35 : 5 | 160 |
| 17 | 10 | 60 : 38 : 2 | 160 |
| 18 | 10 | 60 : 39 : 1 | 160 |
| 19 | 10 | 60 : 39.5 : 0.5 | 160 |

### Results—Yield

### Bulk Density

Two bulk density values were determined for the powder that was produced; free poured powder bulk density, and tapped density. Density is preferably measured at room temperature and/or 50-60% relative humidity.

In order to determine the free poured density, a 20 g mass of powder was poured into a graduated measuring cylinder and the volume occupied read off the cylinder markings.

Tapped bulk density for this sample will then be determined by dropping the 20 g sample in the measuring cylinder 20 times onto a rubber mat from a height of 15 cm. Some testing methods involve tapping 100 times.

Bulk density can be expressed as: bulk density=Wₓ/V, wherein Wₓ is the weight of the powder in g and V is the apparent volume occupied by the powder in the cylinder in cm³.

### Flowability

The flowability of the powder obtained from the spray drying process, is determined using the Hausner ratio, and correlated to a flow property. These flow properties are shown in Table 5 below.

TABLE 5
Details of powder flowability vs Hausner ratio

| Powder Flow Property | Hausner Ratio |
|---|---|
| Excellent | 1.00-1.11 |
| Good | 1.12-1.18 |
| Fair | 1.19-1.25 |
| Passable | 1.26-1.34 |
| Poor | 1.35-1.45 |
| Very Poor | 1.46-1.59 |
| Very Very Poor | >1.60 |

The Hausner ratio is calculated as the ratio of tapped powder density to freely poured density. This is represented in the equation below:

HR=ρT/ρF, where ρT and ρF are the tapped and free poured densities, respectively.

### Moisture Content

Moisture content of the dried powders was determined by taking a 3-4 gram or 1-2 gram sample of powder, and placing this in an oven at 70° C. with a desiccant until the mass of powder remains constant. Moisture content is then determined as a percentage of the original mass of powder.

### Susceptibility to Caking

Powders collected from the spray drying process were stored in zip locked bags or vacuum sealed bags, and left at either ambient and refrigerated conditions. The powder was qualitatively analysed to determine how susceptible it is to caking based on the size and number of cakes present in the powder, and also the ease of breaking up the cake (ie very easy to break up into powder again, or extremely tough and difficult to granulate).

### Powder Solubility

Solubility of powder was determined by dissolving a sample of the dried product in water, and visually examining to indicate if there are any suspended solids present.

### Counter Current Spray Drying

500 g of solution was spray dried in each experimental run. The feed solution was prepared in a concentration that ensured that all solids were dissolved. The feed pressure was 500 kPa. The feed flows through a nozzle type atomiser at a rate of 15 ml/min. Results are shown in Table 6 below.

TABLE 6
Spray dried CJ:WPI

| | | Inlet | Inlet Air | Atomisation | Chamber | | Moisture | |
|---|---|---|---|---|---|---|---|---|
| Run | | Air | Pressure | Pressure | Temperature | Powder | Content | Tg |
| Number | CJ:WPI | Temp (° C.) | (kPa) | (kPa) | (° C.) | produced | (%) | (° C.) |
| 1 | 70:30 | 180 | 350 | 400 | 68.0 | Yes | 8.02 | N/A |
| 2 | 80:20 | 190 | 350 | 500 | 69.8 | Yes | 9.42 | 22.81 |
| 3 | 80:20 | 200 | 350 | 500 | 72.7 | Yes | 5.03 | 26.19 |
| 4 | 80:20 | 210 | 350 | 500 | 76.0 | Yes | 6.09 | 33.49 |
| 5 | 90:10 | 200 | 400 | 500 | 72.7 | Yes | 8.82 | — |
| 6 | 90:10 | 220 | 350 | 500 | 79.5 | Yes | 6.27 | — |

Whey protein isolate was found to be a very effective additive in the spray drying of cane juice. The inlet air temperature was increased in 10° C. increments twice, whilst retaining the same feed solution conditions and it was found that the driest powder that displayed high flowability and minimal caking following storage was produced at an inlet air temperature of 200° C., with a moisture content of 5.03%.

It was initially thought that powder produced utilising higher temperatures would be drier than those produced at lower temperatures, however it was found that there existed an optimum temperature that would yield powders with minimal water remaining, and operating at temperatures higher or lower than this point would increase the residual moisture. FIG. 2 depicts moisture content versus temperature of the drying chamber.

Without being bound by theory, it is thought that the increase in air temperature increases the rate of evaporation from the droplet to the air resulting in lower moisture content until the evaporation occurs too rapidly and a crust is formed on the surface of the particle, which slows further evaporation from the particle, resulting in an increase. Using a similar inlet air temperature but only 10% drying agent increased the water content. When the inlet air temperature was increased to 220° C., the moisture content of the powder lowered back to 6.27%. The best sample with 20% WPI remained completely free flowing with no caking upon storage (row 3, Table 6) and is therefore the best of the sugars prepared.

The optimum ratio of cane juice to WPI was found to be 80:20 CJ:WPI at a total solids concentration of 20% w/w. Drying chamber temperature was found to have a significant influence on the stability of the powders formed, ultimately as a result of residual moisture content in the powder. An inlet air temperature of 200° C. corresponding to an average drying chamber temperature of 72.7° C. was found to give the lowest moisture content of the 80:20 powder at 5.03%. This yielded a free flowing, stable powder that did not exhibit caking.

Results of spray drying compositions comprising lecithin are shown in Table 7 below.

TABLE 7
Spray dried CJ:WPI:L

| | | Inlet | Inlet Air | Atomisation | Chamber | | Moisture | |
|---|---|---|---|---|---|---|---|---|
| Run | | Air | Pressure | Pressure | Temperature | Powder | Content | Tg |
| Number | CJ:WPI:L | Temp (° C.) | (kPa) | (kPa) | (° C.) | produced | (%) | (° C.) |
| 10 | 80:15:5 | 200 | 350 | 500 | 72.7 | Yes | 6.85 | — |
| 11 | 80:10:10 | 200 | 350 | 500 | 72.7 | Yes | 5.33 | 52.76 |
| 12 | 80:5:15 | 200 | 350 | 500 | 72.7 | Yes | 4.14 | 35.2 |
| 13 | 90:7.5:2.5 | 200 | 350 | 500 | 72.7 | Yes | 5.62 | — |
| 14 | 90:2.5:7.5 | 200 | 350 | 500 | 72.7 | Yes | 4.48 | — |
| 15 | 95:1.25:3.75 | 200 | 350 | 500 | 72.7 | Yes | 5.74 | — |

Items 11 and 12 were also shown to remain free flowing and not cake upon storage.

The addition of lecithin improved the moisture content when compared to the use of WPI alone. As expected, flowability and storage stability were also improved. The powders that were dried using a ratio of 3:1 lecithin to WPI in the drying agent had moisture contents as low as 4.14%.

By adding lecithin, it was possible to produce powders with as little as 95:5 (CJ:Total Drying Agent) that did not cake upon storage.

The optimum ratio of WPI:Lecithin was determined to be 1:3, and using a ratio of 80:5:15 CJ:WPI:L the moisture content of 4.14% was achieved. Furthermore the addition of Lecithin eliminated wall deposition of powder in the spray dryer.

### Example 7—Effect of Inlet Temperature and Protein Ratio

Food grade sucrose (CSR) and Whey protein (Bulk Nutrients) were used to prepare the Sucrose-protein model solutions of Table 8 below. Distilled water at room temperature was used to dissolve sucrose and whey protein in a 2 L glass beaker by a magnetic stirrer. The same spray drier was used as for Examples 1 and 5.

TABLE 8
testing refined sugar model solutions

| | | Solid in | | | | |
|---|---|---|---|---|---|---|
| | Inlet air | total | Sucrose: | | Moisture | |
| | temperature | solution | protein | Yield | content | |
| Trial | (° C.) | (wt %) | ratio | (wt %) | (%) | Stability |
| 1 | 160 | 10 | 90:10 | 4.4 | 3 | Free flowing |
| 2 | 160 | 20 | 90:10 | 11 | 9 | Free flowing |
| 3 | 160 | 40 | 90:10 | 29.2 | 14 | Sticky |
| | | | | | | and caking |
| 4 | 180 | 20 | 90:10 | 17 | 10 | Free flowing |
| 5 | 180 | 40 | 90:10 | 20.8 | 10 | Free flowing |
| 6 | 180 | 20 | 95:5 | 8.5 | 7 | Sticky,free |
| | | | | | | flowing |
| 7 | 180 | 40 | 95:5 | 9.7 | 14 | Sticky and |
| | | | | | | caking |

10% WPI of the total solids (WPI plus sucrose) was required for a non-sticky product, 5% being insufficient drying agent. Suitable powders had less than 14% moisture.

10, 20 and 40% solids in solution with a 90:10 sucrose to protein ratio resulted in free flowing powder using inlet air at 160° C. (10%) or 160° C. and 180° C. (20 and 40%).

The best yield was at 160° C. with 40% solids in solution at 90:10 sugars to WPI. However, the resulting powder was sticky possibly because the temperature was too low for the quantity of solids. The % total solids suitable varies between spray driers and the skilled person is able to optimise the % total solids. Increasing the temperature to 180° C. resolved the stickiness and retained a good yield. However, lower moisture content was considered more likely to result in a long shelf life.

Therefore, the preliminary study indicated that 160° C. to 180° C. with 90:10 sucrose:WPI were settings worth optimising for the low GI sugar of the invention.

### Example 8—Low GI Sugars Prepared with Co-Current Spray Drier

### Materials

### Sugar Cane Juice.

Non-Flavoured WPI from Bulk Nutrients

Feed solution mixture for spray drying was 40% w/w. The co-current spray dryer used had capacity to atomize high % feed solutions. A 90:10% cane juice to WPI solids solution was prepared: 1440 g sugar cane juice and 160 g WPI (20% w/w in solid base) were mixed with 2400 g Milli-Q filtered water and stirred well.

### Equipment

Spray dryer in the experiments is fabricated by KODI Machinery co. LTD. Model is LPG-5. Scanning Electron Microscope (SEM) is used to analyse the particle morphology. SEM model is PhenomXL Benchtop. The test sample is coated by Sample Coater (Quorum SC7620 Sputter coaster) prior to analysis.

### Method

The spray drier was set to inlet temperature 170° C. and outlet 62° C. and the feed stock spray dried.

### Results

A free flowing powder is produced with 1% moisture and over 70% yield. The product does not cake and has good stability.

80:20 and 70:30 CJ:WPI % solids sugars were also prepared.

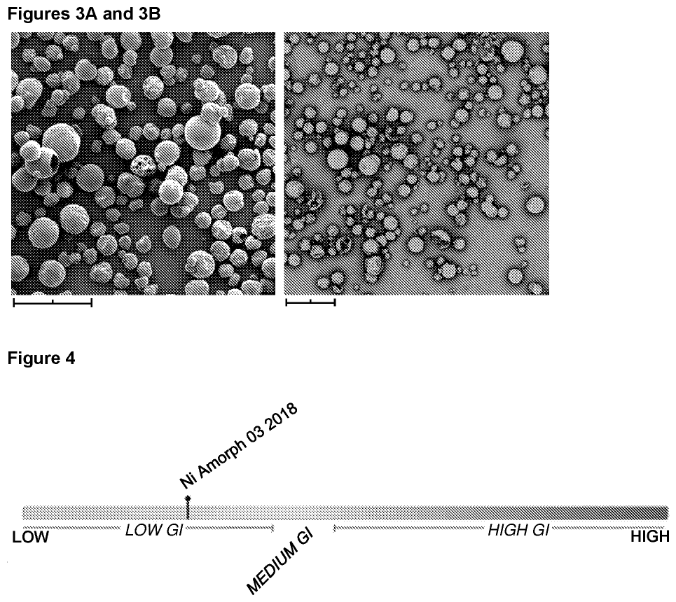

SEM images of the 80:20 and 70:30 CJ:WPI % solids sugars are in FIGS. 3 and 4 respectively. There is some porosity in the 80:20 sugar. The 70:30 sugar shows more “chipped” or “damaged” particles. The porous and chipped particle sugars remain of commercial interest.

### Example 9—GI Testing

Part A—GI Testing of 90:10 CJ:WPI Sugar from Example 8

FIG. 4 graphs the results of an in vitro Glycemic Index Speed Test (GIST) on the 90:10 CJ:WPI sugar from Example 8. The testing involved in vitro digestion of the sugar and analysis using Bruker BBFO 400 MHz NMR Spectroscopy. The testing was conducted by the Singapore Polytechnic Food Innovation & Resource Centre, who have demonstrated a strong correlation between the results of their in vitro method and traditional in vivo GI testing. The 90:10 cane juice to whey protein isolate % solids amorphous sugar is low glycaemic.

As the 90:10 sugar is low GI, the skilled person would expect the higher protein 80:20 and 70:30 sugars to also be low GI. The skilled person would also expect similar results for amorphous sugars with different drying agents, such as fibre, so long as the drying agent has no GI (like protein) or is low GI. Insoluble fibres have little effect on GI so the GI of the amorphous sugar should remain low when an insoluble fibre is the drying agent. Soluble fibres lower the glycaemic index so amorphous sugars having a soluble fibre drying agent will have even lower GI than the tested sugars with a protein drying agent. High intensity sweeteners like stevia or monk fruit sweeteners have a GI of zero. Therefore, amorphous sugars with high intensity sweeteners as a drying agent will also remain low GI.

The polyphenol content of the 90:10 CJ:WPI % solids amorphous sugar was tested for polyphenol content at the Singapore Polytechnic Food Innovation & Resource Centre using the Folin-Ciocalteu assay (UV detection at 760 nm) using an Agilent Cary 60 UV-Vis Spectrophotometer. The sugar has 446.80 mg CE polyphenols/100 g carbohydrates.

Part B—Preparation of Sugar with Very Low GI

The effect of polyphenol content on the GI of sugar was studied. Traditional white sugar ie essentially sucrose was used as a control. Sugars with varied quantities of polyphenols were prepared by adding various amounts of polyphenol content to traditional white sugar.

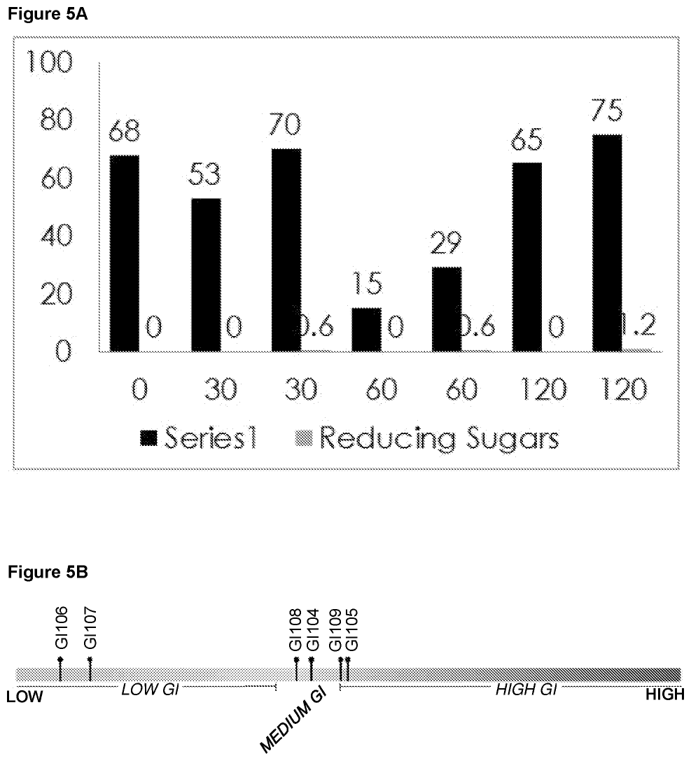

Table 9 shows the results of testing of an in vitro Glycemic Index Speed Test (GIST) on the sugars prepared. The method involved in vitro digestion and analysis using Bruker BBFO 400 MHz NMR Spectroscopy. The testing was conducted by the Singapore Polytechnic Food Innovation & Resource Centre, who have demonstrated a strong correlation between the results of their in vitro method and traditional in vivo GI testing. The results of the GIST testing is also graphed in FIG. 5A.

TABLE 9
Sugar polyphenol content v GI

| Sample | Polyphenol content | GI number | GI |
|---|---|---|---|
| 1 | 0 mg CE/100 g | About 68 | Medium |
| 2 | 30 mg CE/100 g | <55 (about 53) | Low |
| 3 | 60 mg CE/100 g | <20 (about 15) | Very Low |
| 4 | 120 mg CE/100 g | <68 (about 65) | Medium |

While the GI of fructose is 19, the GI of glucose is 100 out of 100. We therefore expect that the as glucose increases in less refined sugars the glycemic response also concurrently increases.

A second set of sugars were prepared in which reducing sugars (1:1 glucose to fructose) were added to some of the white refined sugar plus polyphenol sugars. The GI of these sugars was also tested using the GIST method and the results are in Table 10.

TABLE 10
Effect of polyphenol and reducing sugar content on GI

| Sample # | Name of Material/Sample | Sample Code | GI Banding |
|---|---|---|---|
| 1 | Sugar + 30 mg/100 g PP + <0.16% RS | GI103 | Low |
| 2 | Sugar + 30 mg/100 g PP + 0.3% RS | GI104 | Medium |
| 3 | Sugar + 30 mg/100 g PP + 0.6% RS | GI105 | Medium/High |
| | | | (about 70) |
| 4 | Sugar + 60 mg/100 g PP + 0% RS | GI106 | Very low |
| | | | (about 15) |
| 5 | Sugar + 60 mg/100 g PP + 0.6% RS | GI107 | Low (about 29) |
| 6 | Sugar + 120 mg/100 g PP + 0% RS | GI108 | Med (about 65) |
| 7 | Sugar + 120 mg/100 g PP + 1.2% RS | GI109 | High (about 75) |

*PP = polyphenols; RS = reducing sugars (1:1 glucose:fructose)

The GI of several samples from Table 10 are graphed in FIG. 5B.

While this testing used crystalline sugar, the results are expected to apply to amorphous sugars with drying agents having no GI (eg protein, insoluble fibre or a high intensity sweetener). Other drying agents (such as soluble fibre may lower the GI further but are not expected to increase the GI).

Previous low GI sugars had a glucose based glycaemic index of about 50. The ability to prepare a very low glycaemic sugar achieving a GI of about 15, which is significantly less than half of the GI of previous low glycaemic sucrose sugars, is very surprising. In addition, it is surprising that the very low glycaemic sugar is palatable.

### Example 10—Taste Profile for Sugars from Example 8

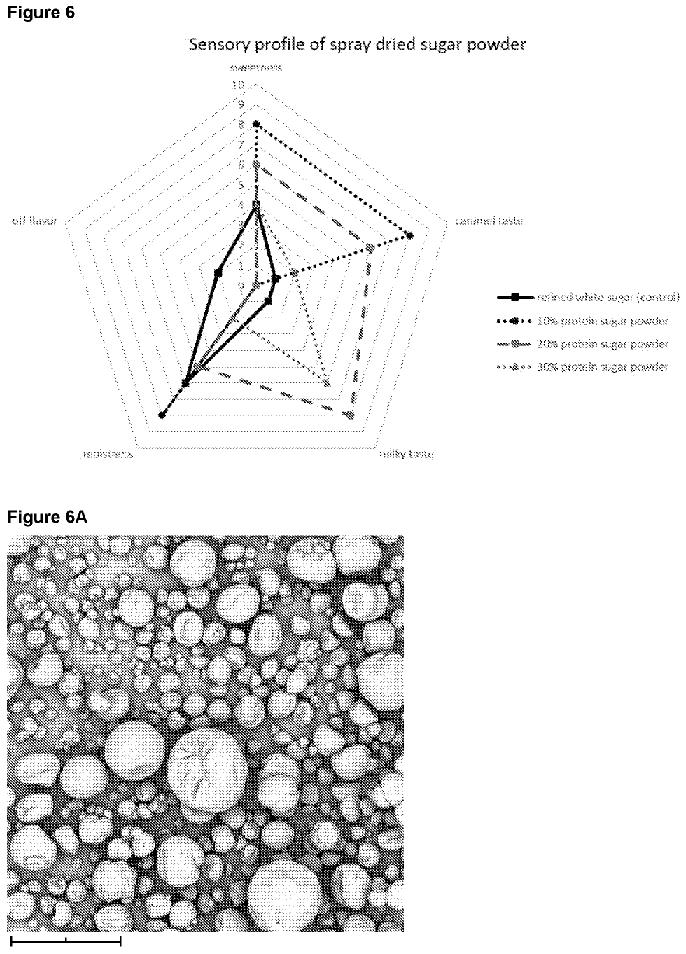

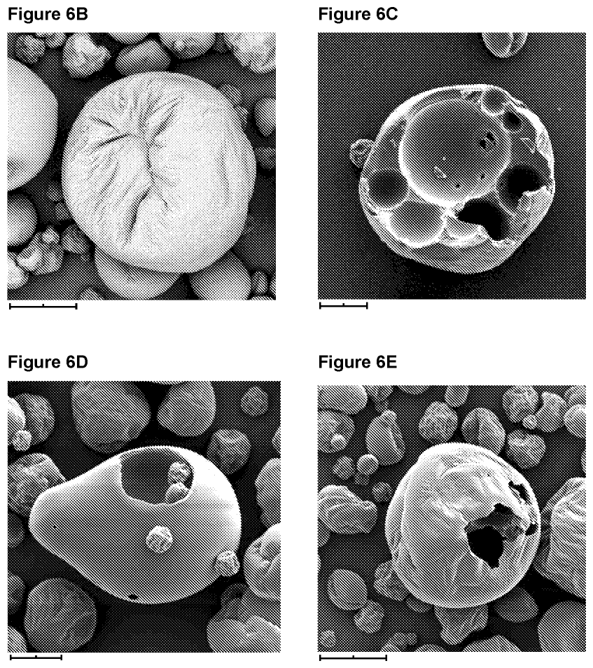

The 90:10, 80:20 and 70:30 sugars from Example 8 were taste tested by two qualified sensory analysts and two project researchers. The sensory profile is in FIG. 6.

The 90:10 and 80:20 sugars are sweeter than refined white sugar, while the 70:30 is equivalently sweet. The 90:10 and 80:20 sugars have a caramel taste. Without being bound by theory, this taste is thought to be associated with the cane juice. The 80:20 and 70:30 sugars have a milky taste. Without being bound by theory, the milky taste is thought to be associated with the WPI.

The 80:20 sugar had a good balance of sweet, milky and caramel tastes. The porosity of the particles did not cause a taste issue.

This testing demonstrates how low GI sugars can be prepared with different flavours for different applications.

### Example 11—Low Density Amorphous Sugar

### Materials:

1) sugar cane juice.
2) Whey Protein Isolate from BULK NUTRIENTS
3) feed solution mixture (50% w/w):
1600 g sugar cane juice (40% w/w of solution)
400 g WPI (20% w/w in solid base) (10% w/w of solution)
2000 g Milli-Q water (50% w/w)

### Equipment:

1) Spray dryer: KODI Machinery co. LTD, Model: LPG-5

### 2) Scanning Electron Microscope (SEM): Phenom Benchtop SEM: Phenom XL

3) Sample coater: Quorum SC7620 Sputter coater.

### Test Procedure:

1) Combine the feed solution ingredients.
2) Aerate the feed solution before atomization (by hand using a stirring rod) and create creamy/stable bubble. Stirring was consistent during drying.
2) Spray the solution into the dryer (Inlet 170° C.±1° C., outlet 62° C.±2° C., nozzle size 50 mm) to prepare the aerated amorphous sugar particles.
3) Collect powder from spray dryer. Coat the sample by Quorum SC7620 Sputter coater to prepare them for SEM analysis.
4) SEM analysis.

### Results and Discussions

Aerated amorphous sugar particles were successful prepared. SEM images of the sugar powder are shown in FIG. 6A-E. The particle size is variable from less than 10 μM to about 60 μM. The aeration/porous nature of the particles is visible in the images of particles that are chipped or incompletely encased.

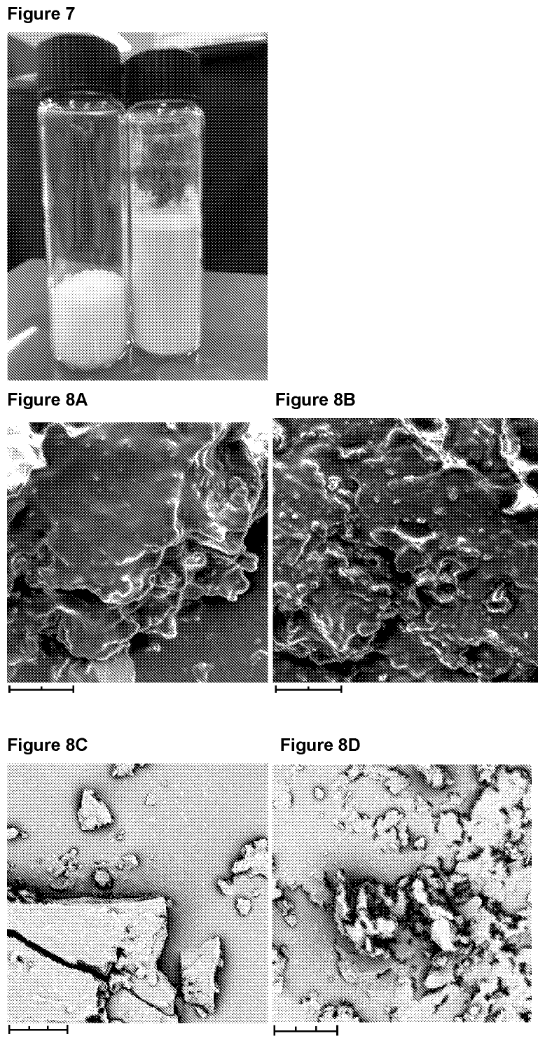

The sugar has a low bulk density. FIG. 7 shows an image of 3 g of white crystal sugar and 3 g of the low density, aerated amorphous sugar prepared according to this example. The bulk density of the white sugar is about 0.88 g/cm³. The bulk density of the aerated amorphous sugar is about 0.47 g/cm³.

### Example 12—Sugar Reduction Potential of the Amorphous Sugar

The composition of the sugar prepared in Example 8 was analysed using Near Infrared technology by FeedTest Laboratory in Australia. The results of the analysis are in Table 11 below.

TABLE 11A
composition of the 20% WPI:CJ amorphous sugar

| TEST | Result |
|---|---|
| Crude Protein (TP/026) | |
| Protein (N × 6.25) (% of dry matter) | 23.5 |
| Fat by Acid Hydrolysis (TP/050) | |
| Fat (dmb) (% of dry matter) | <1 |
| Saturated Fat (g/100 g) | <0.1 |
| Monounsaturated Fat (g/100 g) | <0.1 |
| Polyunsaturated Fat (g/100 g) | <0.1 |
| Trans Fat (g/100 g) | <0.1 |
| Ash (TP/024) | |
| Ash (dmb) (% of dry matter) | 7.6 |
| Crude Fibre (TP/098) | |
| Crude Fibre (dmb) (% of dry matter) | 1.1 |
| NFE (TP/FT/008) | |
| NFE (%) | 62.5 |
| Metabolisable Energy (Atwater) (TP/FT/008) ^{∧} | |
| ATWATER_ENERGY (kcal/100 g dry matter) | 321 |
| Dry Matter (FT/002) ^{∧} | |
| Dry Matter (%) | 98.3 |
| Moisture (%) | 1.7 |
| Starch (TP/037) ^{∧} | |
| Total Starch (% of dry matter) | 0.9 |
| Sugar Profile (TP/036) | |
| Total Free Sugars (%) | 63 |

TABLE 11B
composition of the 20% Sunflower Protein:CJ amorphous sugar

| TEST | Result |
|---|---|
| Crude Protein (TP/026) | |
| Protein (N × 6.25) (% of dry matter) | 19.0 |
| Fat by Acid Hydrolysis (TP/050) | |
| Fat (dmb) (% of dry matter) | <0.2 |
| Ash (TP/024) | |
| Ash (dmb) (% of dry matter) | 2.34 |
| Total Dietary Fibre (TP/025) | |
| Total Dietary Fibre (%) | 3.2 |
| Carbohydrates (Difference) (TP/110) | |
| Carbohydrates (%) | 75.1 |
| Carbohydrates (no TDF) (%) | 78.3 |
| Energy (Human Nutrition) (TP/110) ^{∧} | |
| Energy (calories/100 g dry matter) | 389 |
| Energy kJ/100 g) | 1630 |
| Oven Moisture (TP/022) ^{∧} | |
| Moisture (%) | <1.0 |
| Sugar Profile (TP/036) | |
| Total Free Sugars (%) | 67 |
| Minerals (ICP) | |
| Calcium (mg/kg dry matter) | 1,600 |
| Potassium (mg/kg dry matter) | 5,600 |
| Magnesium (mg/kg dry matter) | 1,000 |
| Phosphorus (mg/kg dry matter) | 990 |
| Sodium (mg/kg dry matter) | 2,700 |
| Sulphur (mg/kg dry matter) | 2,500 |

Crude fibre is the insoluble carbohydrate and NFE (Nitrogen free extract) is the soluble carbohydrate.

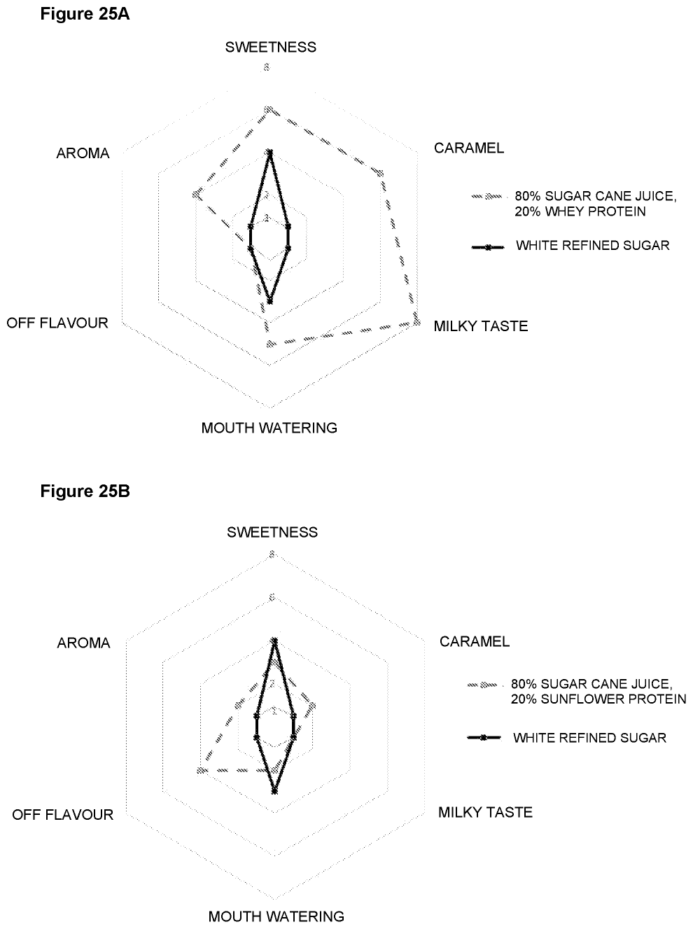

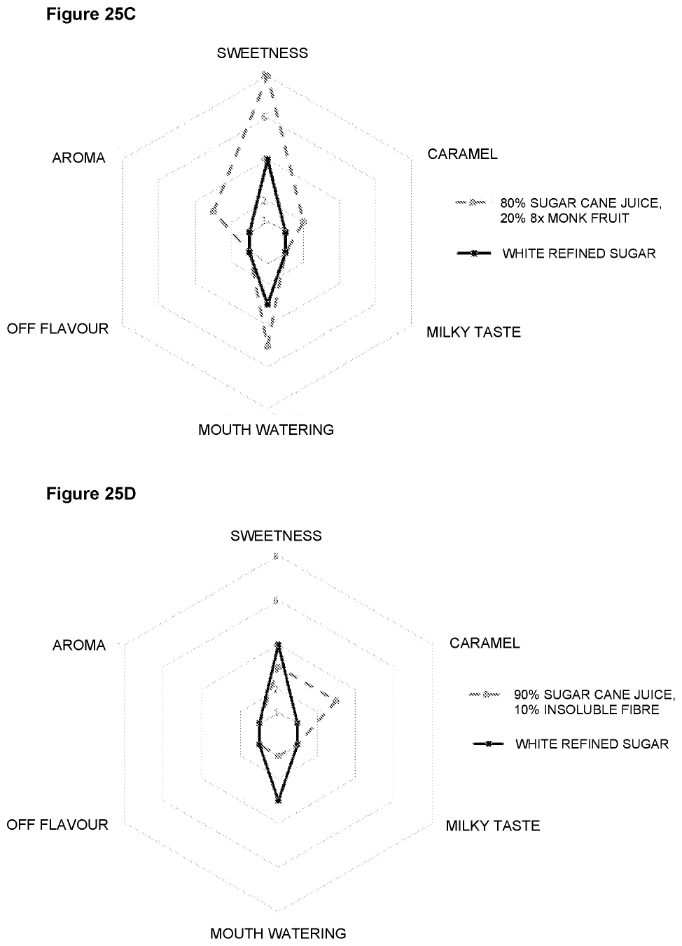

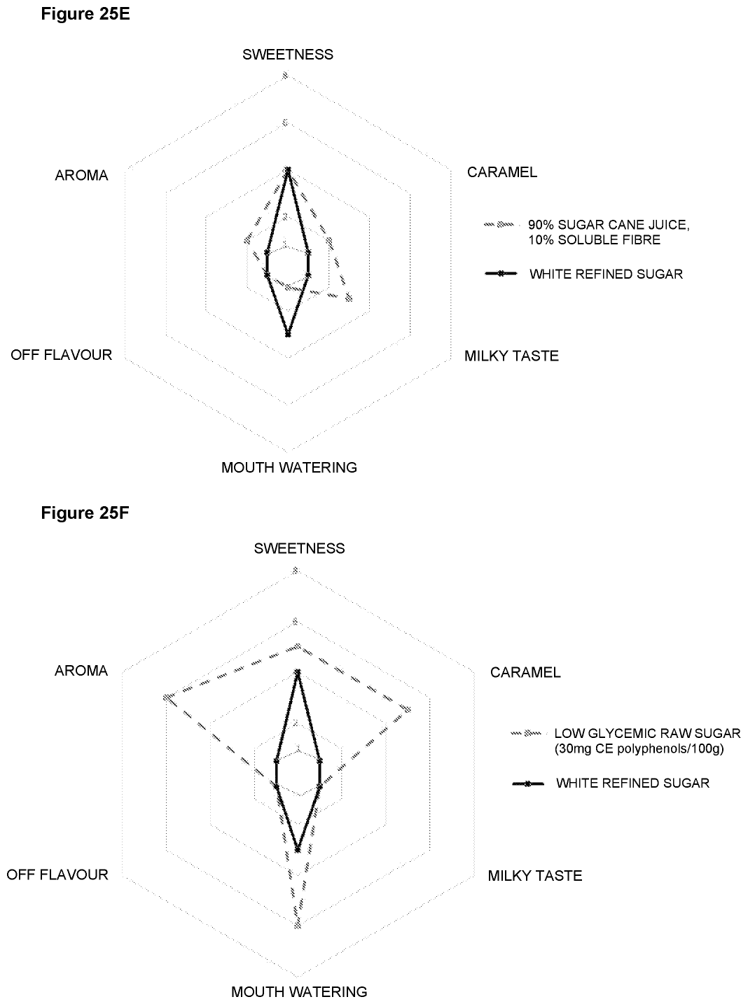

The amorphous sugar of Table 11A has 63% free sugars compared to 100% free sugars for refined white sugar, yet the sweetness of the sugar is comparable (see Example 11 and FIG. 6). This is a 37% reduction in sugar if the amorphous sugar is substituted for white refined sugar in a 1:1 ratio (by weight). However, based on the increased sweetness a substitution of 0.85:1 could be achieved. This would result in a 43% reduction in free sugar. The results for a non-aerated version of the sugar are expected to be identical as this comparison is based on weight not density/volume. The amorphous sugar of Table 11B has 75% free sugars compared to 100% free sugars for refined sugar, yet the sweetness of the sugar is comparable (see Example 18 and FIG. 25B). This is a 25% reduction in sugar if the amorphous sugar is substituted for white refined sugar in a 1:1 ratio (by weight).

Where the sugar source for the amorphous sugar of the invention is sugar cane juice (or something with equivalent composition), the reduction in free sugar is expected to be equivalent independent of the drying agent used (so long as the drying agent does not include free sugar).

White refined sugar is 1,700 kJ/100 g. The amorphous sugar of Table 11A is about 321 cal/100 g, which is about 1343 kJ/100 g. The amorphous sugar of Table 11B is about 389 cal/100 g which is about 1630 kJ/100 g. Therefore, the amorphous sugars of Table 11A and Table 11B contain about 79% and about 96%, respectively, of the total energy/total calories of white refined sugar. In other words, the total energy/total calories by weight of the amorphous sugar is reduced by about 20% and 5%, respectively, when compared to an equivalent weight of white refined sugar. These calculations are based on an aerated sugar and protein blend. The protein included has calories. Non-digestible/digestive resistant foods will have lower to no calories. A sugar with a non-digestible/digestive resistant ingredient instead of a protein will have increased calorie reduction.

Again, the results for a non-aerated version of the sugar are expected to be identical as this comparison is based on weight not density/volume.

The skilled person will understand that the reduction in total energy will vary depending on the nature and amount of the drying agent used. For example, if the drying agent is a fibre, a larger reduction in total energy is expected than where the drying agent is protein. A larger reduction in total energy is expected where a greater amount of drying agent is used, for example, 30% by solid weight.

The nutritional information for the composition of the sugar prepared in Example 8 is in Table 12 below. The % Daily Value (DV) in the table tells you how much a nutrient in a serving of food contributes to a daily diet. 2,000 calories a day is used for general nutrition advice.

TABLE 12
nutritional details of a serving size

| Serving size | 100 g |
|---|---|
| Calories | 350 |
| Content in % Daily Value | |
| Total fat 1 g | 1% |
| Saturated fat 0 g | 0% |
| Trans fat 0 g | 0% |
| Cholesterol 0 mg | 0% |
| Sodium 170 mg | 7% |
| Total Carbohydrate 63 g | 23% |
| Dietary Fiber 1 g | 4% |
| Total sugars 63 g | |
| Includes 0 g added sugars | 0% |
| Protein 24 g | 48% |
| Vitamin D 0 mcg | 0% |
| Calcium 1200 mg | 90% |
| Iron 29 mg | 160% |
| Potassium 170 mg | 35% |
| Magnesium | 70% |
| Zinc | 30% |
| Copper | 60% |
| Manganese | 350% |

This sugar has significantly more mineral content than traditional white crystal sugar.

Traditional white crystalline sugar is about 400 calories per 100 g serve. This 20% solids w/w whey protein isolate and 80% w/w solids sugar cane juice amorphous sugar has 87.5% of the calorie content of an equivalent mass of traditional crystalline white sugar. This is a reduction in calories of 12.5%. The protein in this sugar has calories, if a non-digestible carbohydrate drying agent was used, the calories present would be reduced and the calorie reduction larger. The results will be the same whether or not the sugar is aerated as density is not relevant to this measure.

As mentioned previously, as this amorphous sugar is sweeter than traditional sugar, it is thought that a substitution of 0.85:1 could be achieved. This would result in an about 25.6% reduction in calories by weight.

### Example 13—Preparation of Chocolate Using Aerated Amorphous Sugar

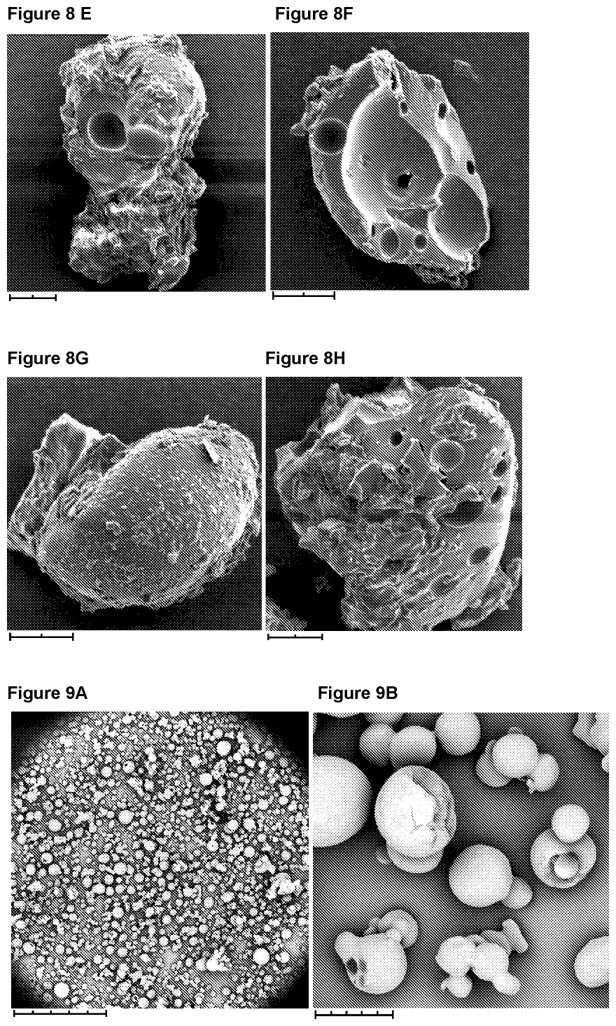

30 g of Lindt 70% dark chocolate was melted and combined with 30 g white crystalline sugar as a control. 30 g of Lindt 70% dark chocolate was melted on a water bath, mixed with 15 g aerated amorphous sugar prepared according to Example 8 and allowed to set. SEM images were taken using the SEM process described in Example 8 and are depicted in FIG. 8—A to D showing the chocolate with sugar crystals; and E to H showing the chocolate with the aerated amorphous sugar. As described in Example 22, the amorphous sugar particles are stable in the chocolate after manufacture.

FIGS. 8 A-D indicate solid chocolate with tactile sugar crystals. FIGS. 8 E-H indicate the chocolate is coated onto the aerated amorphous sugar particles. The chocolate coated amorphous particles are less than 25 μm and no bigger particles were detected.

Both Samples were Taste Tested

Solid chocolate with tactile sugar crystals: The first taste is bitter from cocoa. The sweetness comes quite late in aftertaste. Overall taste is less sweet than the chocolate coated aerated amorphous sugar particles despite the high sugar content.

Chocolate coated aerated amorphous sugar particles: First taste is sweet. The texture is creamy and full of aroma. The aftertaste is still sweet. The overall taste is almost double the sweetness of the white sugar chocolate blend but has only 50% w/w added sugar content.

### Example 14—Amorphous Sugars Prepared with Varied Sugar Sources

In this example, the technology developed to prepare amorphous sugars was applied to prepare amorphous alternative sweeteners with soluble fibre, insoluble fibre or protein including vegan protein.

### Materials

### Recipe 1

### 1) Sweeteners

rice syrup—Pure Harvest: Organic Rice malt syrup
coconut sugar—CSR: unrefined coconut sugar
monk fruit—Morlife: Nature's Sweetener Monk Fruit
maple syrup—Woolworths: 100% pure Canadian Maple syrup
   2) Whey Protein Isolate from BULK NUTRIENTS 100% WPI.

### Feed Solution Mixture

360 g Sweeteners (a. Rice syrup, b. Coconut sugar, c. Monk fruit (300 grams, find the feed solution in the table below) or d. Maple syrup)
40 g WPI
600 g Milli-Q water

### Recipe 2

### 1) Sweetener: Sugar Cane Syrup

### 2) Whey Protein Isolate

3) Soluble fibres (Lotus: Xanthan Gum) or insoluble fibres (KFSU: Phytocel—100% natural sugarcane flour)

### Feed Solution Mixtures

3.1) Insoluble fibres
360 g Sugar Cane Syrup
36 g WPI
4 g Insoluble fibres
600 g Milli-Q water
   3.2) Soluble fibres
500 g Sugar Cane Syrup
36 g WPI
4 g Insoluble fibres
400 g Milli-Q water

### Recipe 3

### 1) Sweetener: Sugar Cane Syrup

2) Vegan Protein (Bio Technologies LLC, Sunprotein: Sunflower protein powder).

### Feed Solution Mixture

500 g Sugar Cane Syrup
40 g Vegan Protein
300 g Milli-Q water

### Equipment

1) Spray dryer: LPGS, KODI Machinery co. LTD.

### 2) Scanning Electron Microscope (SEM): Phenom Benchtop SEM: Phenom XL

3) Sample coater: Quorum SC7620 Sputter coater.

### 4) Vacuum Packaging Machine

### Test Procedure

1) Combine and mix the feed solution ingredients to create a stable solution (as opposed to a solution with a stable bubble) before atomization.
2) Spray the solution into the dryer (Inlet 170° C.±1° C., outlet 70° C.±2° C., nozzle size 50 mm).
3) Collect powder from spray dryer. Coat the sample by Quorum SC7620 Sputter coater to prepare them for SEM analysis.
4) SEM analysis.

TABLE 13
Ingredients in the amorphous sugars of Example 14

| | | | | | | | | Water |
|---|---|---|---|---|---|---|---|---|
| | Recipe | Sweetener | g | Protein | g | Fibre | g | (g) |
| 1 | 1 | Rice syrup | 360 | WPI | 40 | — | — | 600 |
| 2 | 1 | Coconut | 360 | WPI | 40 | — | — | 600 |
| | | sugar | | | | | | |
| 3 | 1 | Monk fruit | 360 | WPI | 40 | — | — | 600 |
| 4 | 1 | Maple syrup | 360 | WPI | 40 | — | — | 600 |
| 5 | 2 | Sugar Cane | 360 | WPI | 36 | Soluble | 4 | 400 |
| | | Syrup | | | | Xanthan Gum | | |
| 6 | 2 | Sugar Cane | 360 | WPI | 36 | Insoluble | 4 | 600 |
| | | Syrup | | | | Fibre | | |
| | | | | | | Bagasse | | |
| | | | | | | (Phytocel) | | |
| 7 | 3 | Sugar Cane | 360 | Sunflower | 40 | — | — | 300 |
| | | Syrup | | protein | | | | |

### Results

In each case, a free-flowing powder was formed (prior to sputter coating) and aerated amorphous sugar particles were successfully prepared. The powders were aerated but less aerated than the powders prepared in Example 11, where the solution was actively aerated before spray drying using a hand stirring rod. These powders were only mixed ordinarily to achieve a homogeneous solution to spray dry rather than more vigorously mixed to achieve a stable bubble.

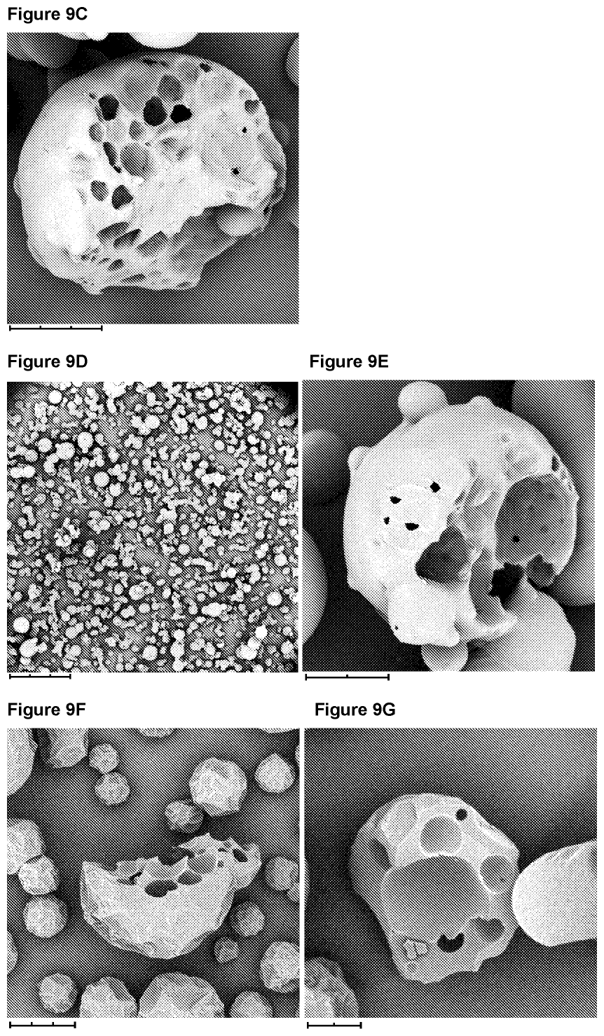

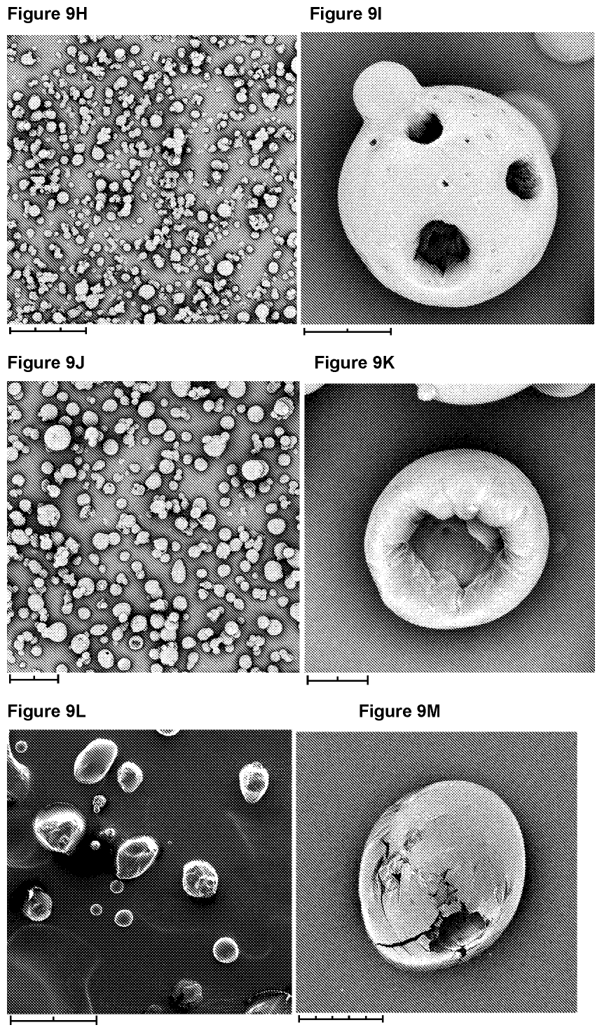

SEM images of products 1 to 4 and 6 to 7 from Table 12 are in FIG. 9 A-C (rice syrup), D-E (coconut sugar), F-G (monk fruit), H-I (maple syrup), J-K (bagasse), L-M (sunflower protein). There are no images for product 5 (xanthan gum).

The particle size is variable from less than 10 μm to about 60 μm. The aeration/porous nature of the particles is visible in the images of particles that are chipped or incompletely encased.

The bulk density of the powders was determined as for the products in FIG. 7. The results are in Table 14 below.

TABLE 14
Bulk density results

| | Recipe | Sweetener | Protein | Fibre | Density g/cm3 |
|---|---|---|---|---|---|
| 1 | 1 | Rice syrup | WPI (10%) | — | 0.36 |
| 2 | 1 | Coconut sugar | WPI (10%) | — | 0.41 |
| 3 | 1 | Monk fruit | WPI (10%) | — | 0.37 |
| 4 | 1 | Maple syrup | WPI | — | 0.41 |
| 5 | 2 | Sugar Cane Syrup | WPI (9%) | Soluble | 0.52 |
| | | | | Xanthan | |
| | | | | Gum (1%) | |
| 6 | 2 | Sugar Cane Syrup | WPI(9%) | Insoluble | 0.38 |
| | | | | Fibre | |
| | | | | Bagasse | |
| | | | | (Phytocel) | |
| | | | | (1%) | |
| 7 | 3 | Sugar Cane Syrup | Sunflower | — | 0.55 |
| | | | protein (10%) | | |

The bulk density of the aerated amorphous sugar is about 0.47 g/cm³. These results are similar despite the minimal mixing before spray drying (ie the feed stock was not stirred into a creamy bubble before spray drying). The sunflower protein resulted in aeration but was not quite as effective as the whey protein isolate at 0.55% g/cm³, a 37.5% reduction compared to traditional white sugar.

The rice syrup and monk fruit results were the least dense with a nearly 60% reduction in density. As density is likely to decrease with increasing WPI, a 70% reduction in density is plausible.

### Example 15—Baked Goods Prepared Using the Amorphous Sugar of the Invention

Both butter cookies and vanilla cupcakes were prepared using the amorphous sugar of the invention (specifically, the sugar of Example 8 prepared from 80:20% cane juice to WPI solids).

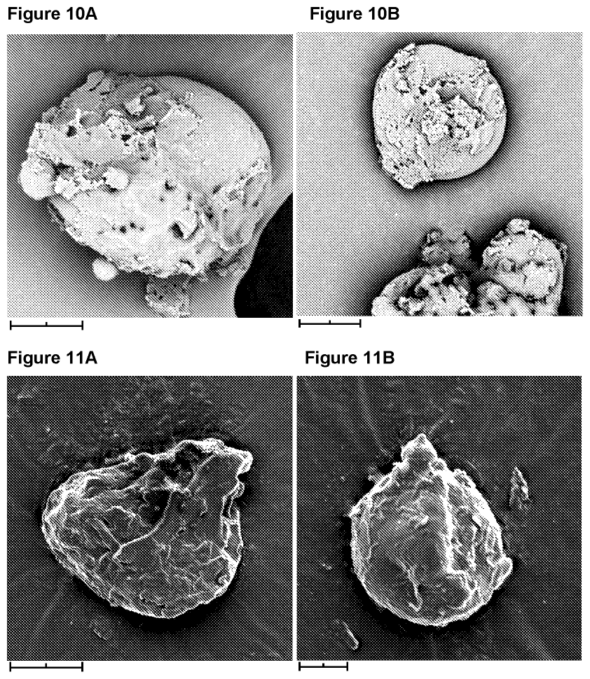

The resulting products were analysed by SEM, as shown in FIGS. 10 and 11. These images show that the aerated sugar particles remained intact in both the muffin and cookie product and had not lost their aeration during food preparation. While the aeration is less evident due to a layer of fat coating the sugar, the particle remained aerated as it retained its pre-processing size and shape.

The cookies and cupcakes were prepared as below:

TABLE 15
Ingredients in the Butter Cookies of Example 15

| Ingredient | Quantity |
|---|---|
| Plain flour | 178 g |
| Amorphous sugar of Example 8 | 72 g |
| (prepared from 80:20% | |
| cane juice to WPI solids) | |
| Butter, softened | 113 g |
| Egg | 1 |
| Vanilla extract | 2 teaspoons |
| Baking powder | ½ tablespoon |
| Baking soda | ¼ teaspoon |
| Salt | ⅛ teaspoon |

### Preparation of the Butter Cookies of Example 15

Half of the amorphous sugar of Example 8 was folded into the butter and vanilla extract. Egg was added and the mixture was mixed until combined. Sifted flour, baking powder, baking soda and salt were added and the mixture was mixed until just combined. The remaining half of the amorphous sugar of Example 8 was folded into the mixture and spoonfuls of the resulting mixture were placed on a greased baking tray and baked for 20-25 minutes at 150° C.

TABLE 16
Ingredients in the Vanilla Cupcakes of Example 15

| Ingredient | Quantity |
|---|---|
| Plain flour | 90 g |
| Amorphous sugar of Example 8 | 75 g |
| (prepared from 80:20% | |
| cane juice to WPI solids) | |
| Butter, melted | 80 g |
| Milk | 40 g |
| Egg | 1 |
| Vegetable Oil | 1 taplespoon |
| Baking powder | ¼ tablespoon |
| Vanilla extract | 1 teaspoon |

### Preparation of the Vanilla Cupcakes of Example 15

Half of the amorphous sugar of Example 8 was folded into the flour. Milk, butter, eggs and vanilla extract were added to the flour and sugar mixture and the ingredients were combined. The remaining half of the amorphous sugar of Example 8 was folded into the mixture and the resulting mixture was spooned into a greased cupcake pan and baked for 20-25 minutes at 150° C.

### Example 16—Water Activity

The water activity (or partial vapour pressure) of the sugar prepared in Example 8 (cane juice and 20% solid weight whey protein isolate) was determined to be 0.31. Water activity is measured to determine shelf-stable foods. A water activity of 0.6 or less is preferred for foods and food ingredients of this type to inhibit mould and bacterial growth.

It will be understood that the invention disclosed and defined in this specification extends to all alternative combinations of two or more of the individual features mentioned or evident from the text or drawings. All of these different combinations constitute various alternative aspects of the invention.

The bulk density of the powders was determined as for the products in FIG. 7. Products were prepared using a co-current spray drier using spraying conditions as for Example 8. The feed solution of Products 1-7 was stirred well prior to atomization as for Example 8. The feed solution of Product 8 was aerated before atomization as for Example 11. The results are in Table 17 below.

### Example 17—Amorphous Sugars Prepared with Varied Density Lowering Agents

In this example, the technology developed to prepare amorphous sugars was applied to prepare amorphous sweeteners with additional substrates or density lowering agents including vegan protein, egg white protein and baking powder.

### Materials

### Recipe 1

### 1) Sweeteners

Sugarcane juice
   2) Substrates or density lowering agents:
i. Isolated pea protein powder (Hillside Nutrition)
ii. Sorghum flour (Bob's Red Mill)
iii. Egg white (fresh) (SunnyQueen Farm)
iv. WPI (Bulk Nutrients)

### Feed Solution Mixture

For recipe 1a:
360 g Sugarcane Juice
40 g Substrate
600 g Milli-Q water
For recipe 1b:
320 g Sugarcane Juice
80 g Substrate
600 g Milli-Q water
For recipe 1c:
280 g Sugarcane Juice
120 g Substrate
600 g Milli-Q water
For recipe 1d:
365 g Sugarcane juice (moisture content 26%)˜270 g Solid Sugarcane
30 g Substrate
355 g Milli-Q water

For recipe 1 b* the feed solution was aerated before atomization to create a stable bubble (as described in Example 11). For the other recipes the other powders were only mixed ordinarily to achieve a homogeneous solution to spray dry rather than more vigorously mixed to achieve a stable bubble.

### Recipe 2

1) Sweetener: Sugar Cane juice
2) Substrates or density lowering agents:
a. Isolated Brown Rice Protein Powder (Eden Health Foods)
b. Soy Flour (Lotus)
c. Sorghum flour (Bob's Red Mill)

### Feed Solution Mixtures

325 g Sugar Cane juice (moisture content 26%)˜240 g Solid Sugarcane
60 g Substrate
365 g Milli-Q water

To avoid nozzle blockage, soy and sorghum flour solutions passed through the sieve No. 250 μm before mixing with sugarcane syrup.

### Recipe 3

### 1) Sweetener: Sugar Cane Syrup

### 2) Baking Powder (Lotus)

### Feed Solution Mixture

For recipe 3a:
325 g Sugar Cane juice (Moisture Content 26%)˜240 g (80%) Solid Sugarcane
12 g Baking Powder
350 g Milli-Q water
For recipe 3b:
325 g Sugar Cane juice (Moisture Content 26%)˜240 g (80%) Solid Sugarcane
12 g Baking Powder
48 g Flour
350 g Milli-Q water

### Equipment

1) Spray dryer: LPGS, KODI Machinery co. LTD.

### 2) Vacuum Packaging Machine

### Test Procedure

1) Combine and mix the feed solution ingredients to create a stable solution (except for recipe 1b* where a solution with a stable bubble was produced) before atomization.
2) Spray the solution into the dryer (Inlet 170° C.±1° C., outlet 70° C.±2° C., nozzle size 50 mm).
3) Collect powder from spray dryer.

### Results

In each case, a free-flowing powder was formed and aerated amorphous sugar particles were successful prepared. Apart from product 8, the powders were not aerated prior to atomization (as described in example 11). The other powders were only mixed ordinarily to achieve a homogeneous solution to spray dry rather than more vigorously mixed to achieve a stable bubble.

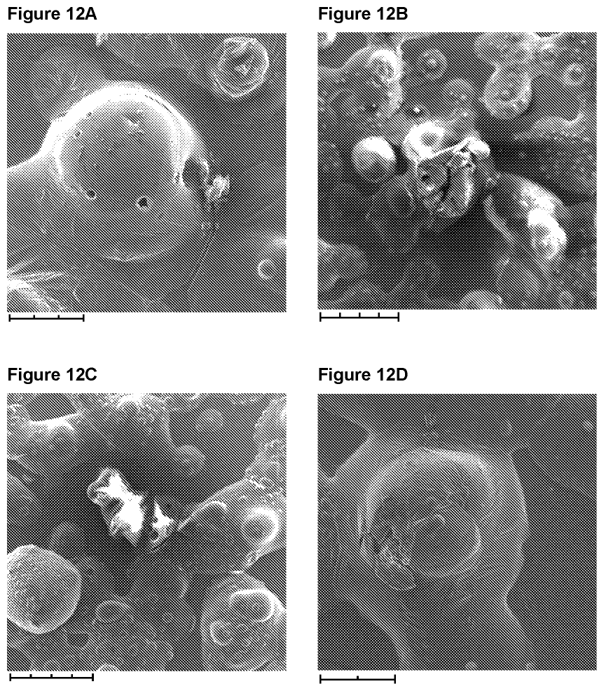

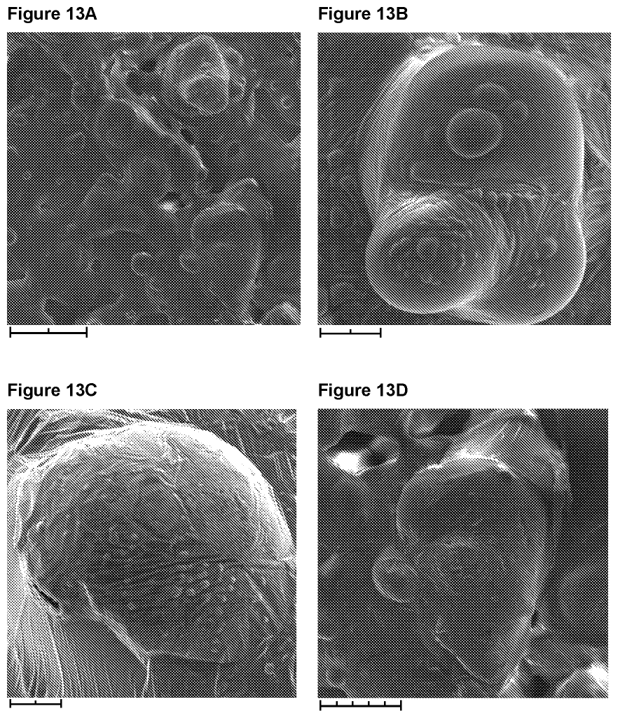

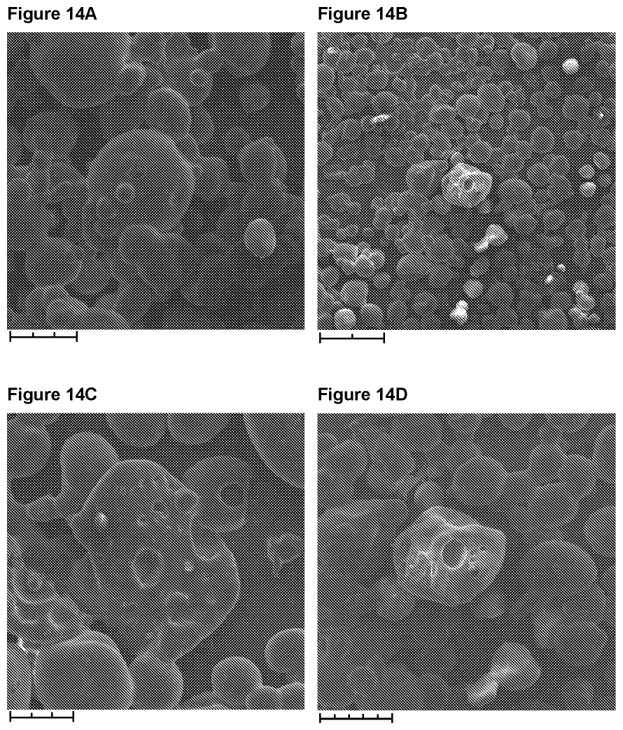

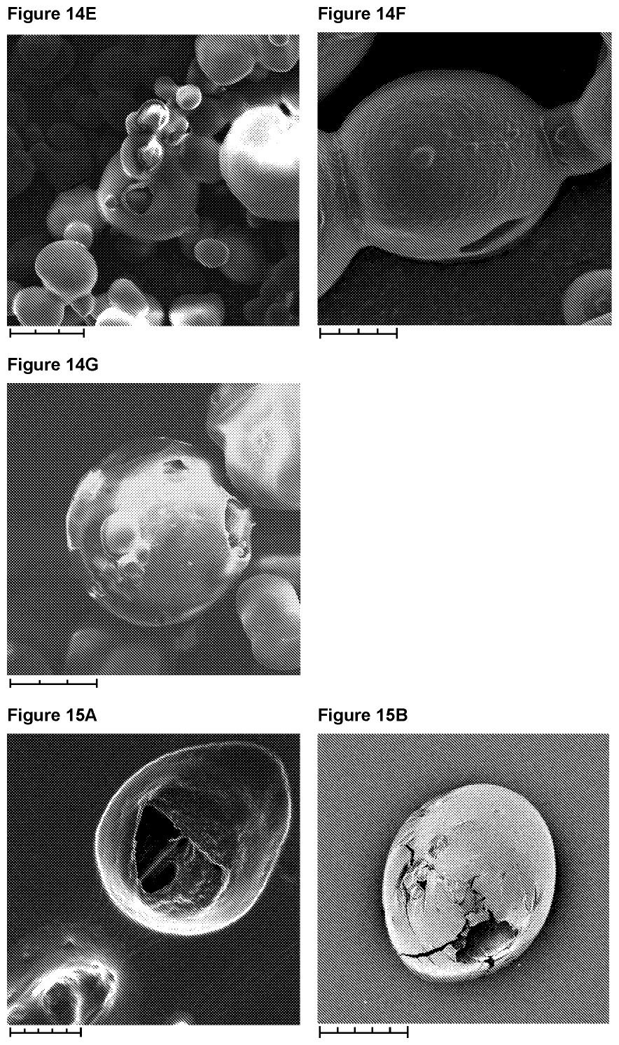

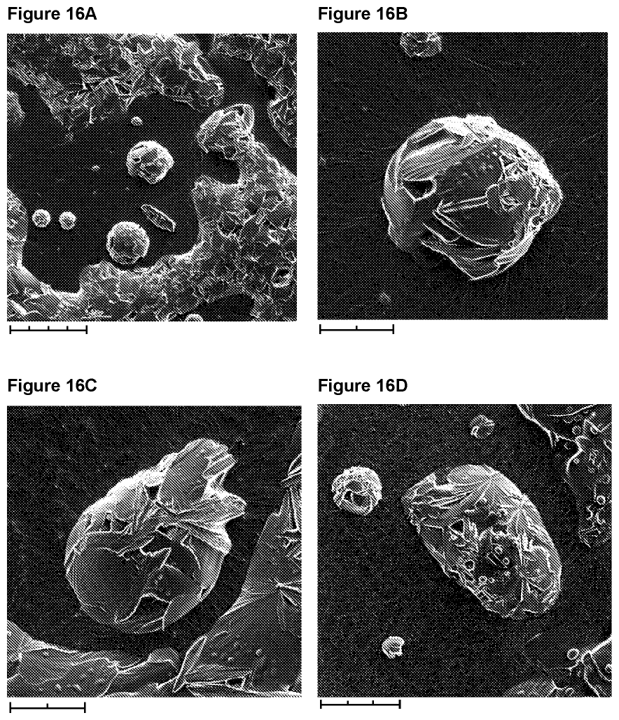

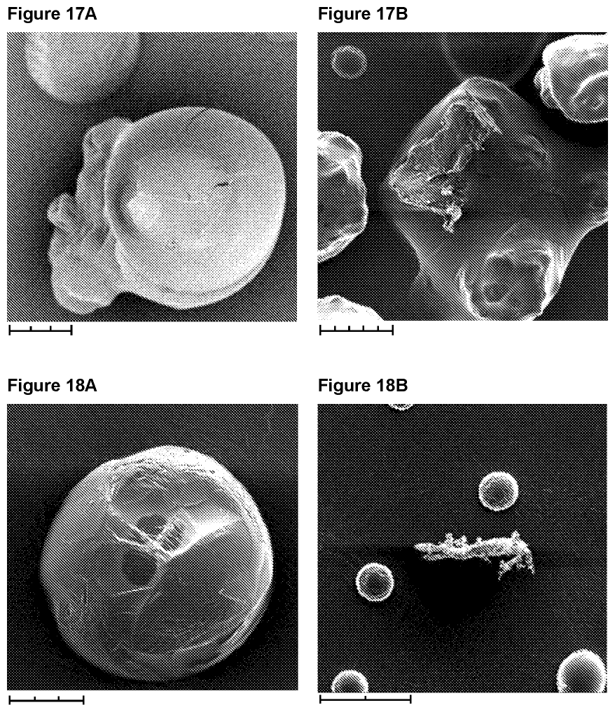

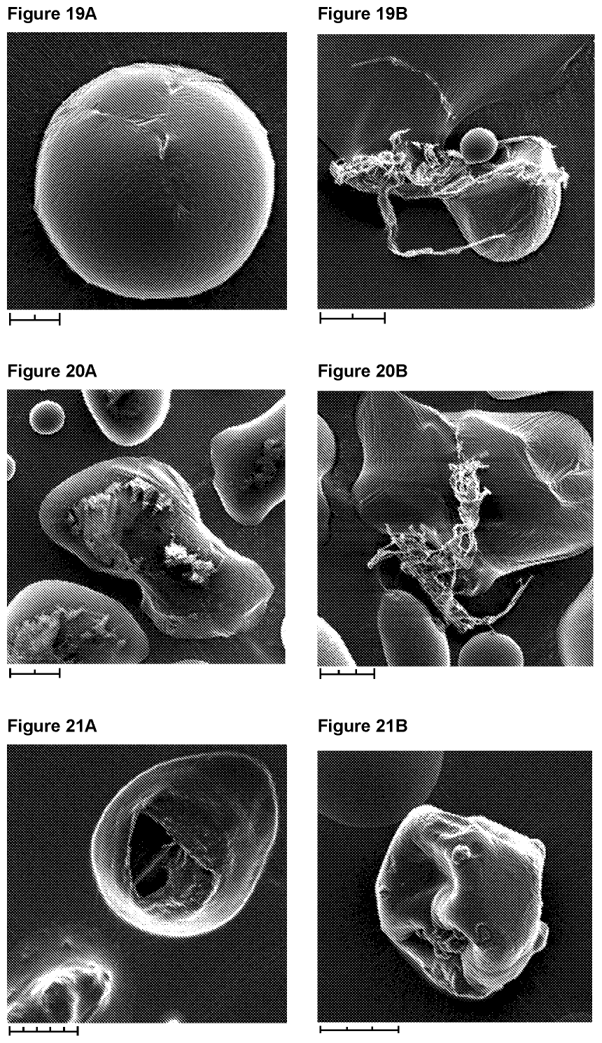

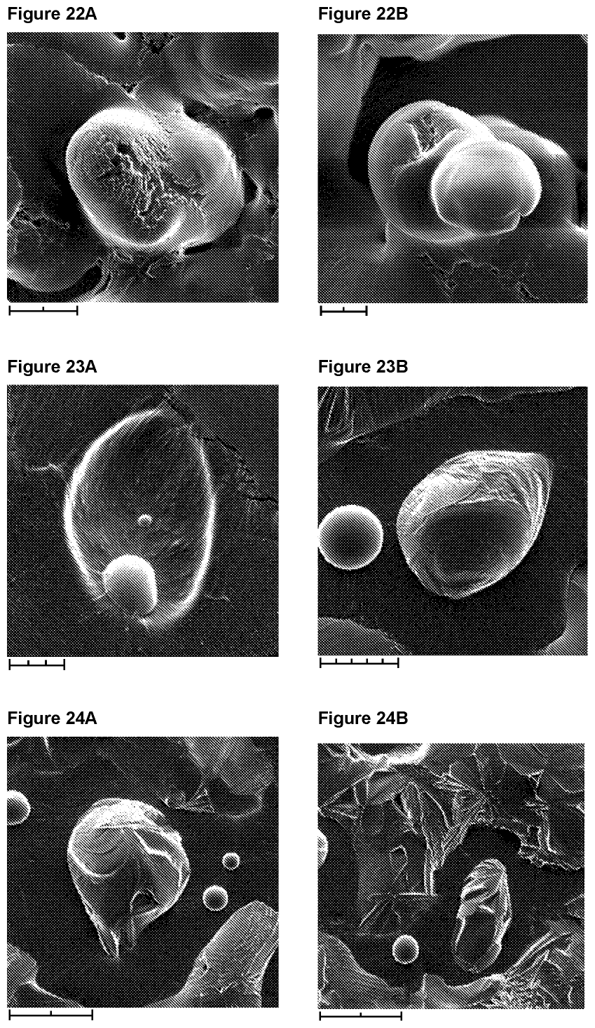

SEM images of products 6-8 from Table 17 are in FIGS. 12A-D (pea protein), FIGS. 13A-D (egg white protein) and FIGS. 14A-G (comprising aeration prior to spray drying). Porosity was observed in these samples. There are no SEM images of products 1-5 and 9-13.

The bulk density of the powders was determined as for the products in FIG. 7, as described in Example 5. The results are in Table 17 below.

TABLE 17
Bulk density results

| | | Sugar | | | Further | | |
|---|---|---|---|---|---|---|---|
| | Recipe | source | Protein | Storage | components | Feed solution preparation | Density g/cm3 |
| 1 | | — | WPI | — | — | Stirred | 0.26 |
| | | | | | | well | |
| 2 | N/A | Refined | — | — | — | N/A | 0.88 |
| | | white | | | | (crystal- | |
| | | sugar | | | | line | |
| | | | | | | material | |
| | | | | | | that | |
| | | | | | | was not | |
| | | | | | | spray | |
| | | | | | | dried) | |
| 3 | 1 a | Brown | WPI | 1 year | — | Stirred | 0.43 |
| | | sugar | (10%) | | | well | |
| 4 | 1 b | Cane | WPI | — | — | Stirred | 0.44 |
| | | juice | (20%) | | | well | |
| 5 | 1 c | Cane | WPI | — | — | Stirred | 0.37 |
| | | juice | (30%) | | | well | |
| 6 | 1 d | Cane | Egg | — | — | Stirred | 0.42 |
| | | juice | white | | | well | |
| | | | protein | | | | |
| | | | (10%) | | | | |
| 7 | 1 d | Cane | Pea | — | — | Stirred | 0.50 |
| | juice | protein | | | | well | |
| | | isolate | | | | | |
| | | (10%) | | | | | |
| 8 | 1 b* | Cane | WPI | — | — | Aerated | 0.48 |
| | | juice | (20%) | | | | |
| 9 | Cane | — | — | | Digestive | Stirred | 0.67 |
| | juice | | | | resistant | well | |
| | | | | | malto- | | |
| | | | | | dextrin | | |
| | | | | | (19%), | | |
| | | | | | lecithin | | |
| | | | | | (5%), | | |
| | | | | | fibre (1%) | | |
| 10 | 2 | Cane | — | — | Soy flour, | Stirred | 0.66 |
| | | juice | | | filtered | well | |
| | | | | | (20%) | | |
| 11 | 2 | Cane | — | — | Sorghum | Stirred | 0.76 |
| | | juice | | | flour, | well | |
| | | | | | filtered | | |
| | | | | | (20%) | | |
| 12 | 2 | Cane | Brown | — | — | Stirred | 0.63 |
| | | juice | rice | | | well | |
| | | | protein | | | | |
| | | | isolate | | | | |
| | | | (20%) | | | | |
| 13 | 3 | Cane | — | — | Baking | Stirred | 0.38 |
| | | juice | | | powder | well (4%) | |
| 14 | 3 | Cane | — | — | Soy flour, | Stirred | 0.34 |
| | juice | | | | filtered | well | |
| | | | | | (20%); | | |
| | | | | | Baking | | |
| | | | | | powder | | |
| | | | | | (4%) | | |
| 15 | 3 | Cane | — | — | Sorghum | Stirred | 0.43 |
| | | juice | | | flour, | well | |
| | | | | | filtered | | |
| | | | | | (20%); | | |
| | | | | | Baking | | |
| | | | | | powder | | |
| | | | | | (4%) | | |

The bulk density of the aerated amorphous sugar ranged from 0.34 g/cm³ to 0.76 g/cm³. These results are similar to other substrates used despite the minimal mixing before spray drying (ie the feed stock was not stirred into a creamy bubble before spray drying). The sorghum and brown rice protein resulted in aeration but was not quite as effective as the whey protein isolate at 0.44 g/cm³, but still a significant 27 to 39% reduction compared to traditional white sugar.

The formulation comprising soy flour and baking powder was the least dense (0.34 g/cm³). Apart from 30% WPI (0.37 g/cm³), the next least dense was baking powder (0.38 g/cm³) with a 63% reduction in density compared to white refined sugar. This was similar to WPI, but only used 4% substrate compared to 30% WPI or 24% for the combination of baking powder and soy flour.

20% WPI when stirred normally or whipped into a bubble before drying had the same bulk density/porosity.

Also, 20% Sunflower Protein (with and without lecithin), 19% Resistant Maltodextrin & 1% soluble/insoluble fibre (with and without lecithin) had similar bulk density, demonstrating that a surfactant does not increase bulk density.

### Example 18—Taste Profiles for Aerated Amorphous Sweeteners

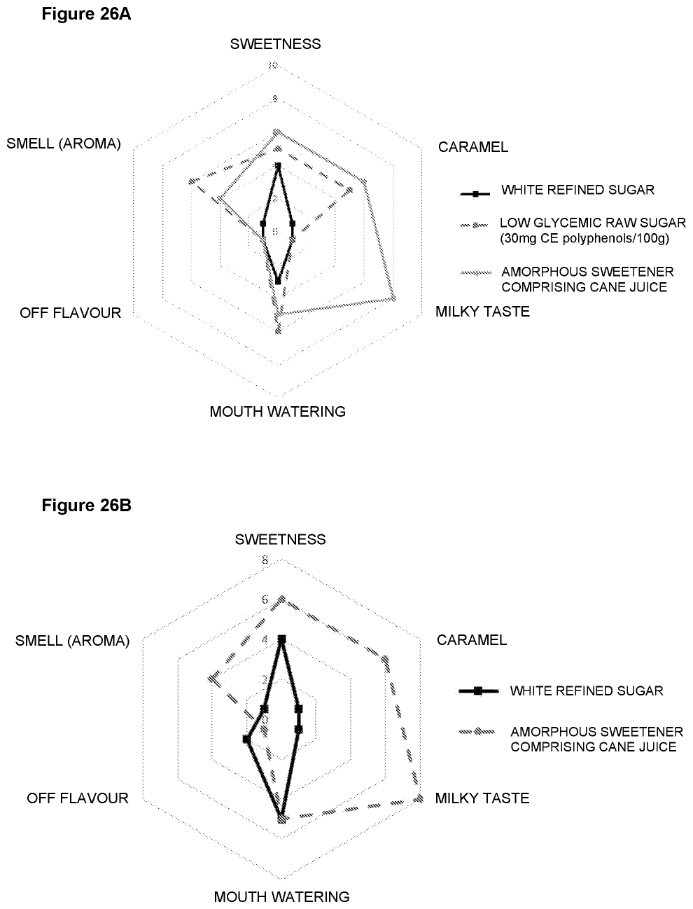

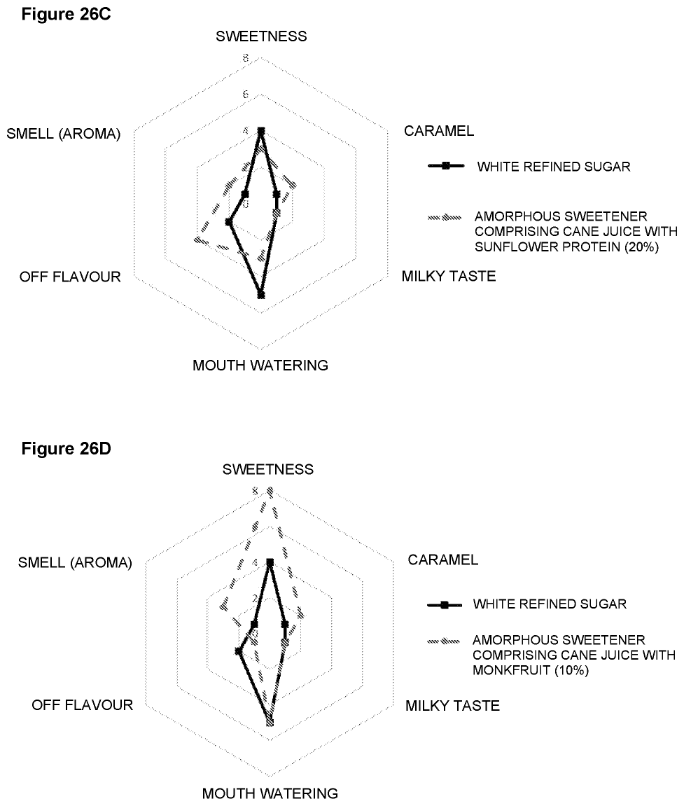

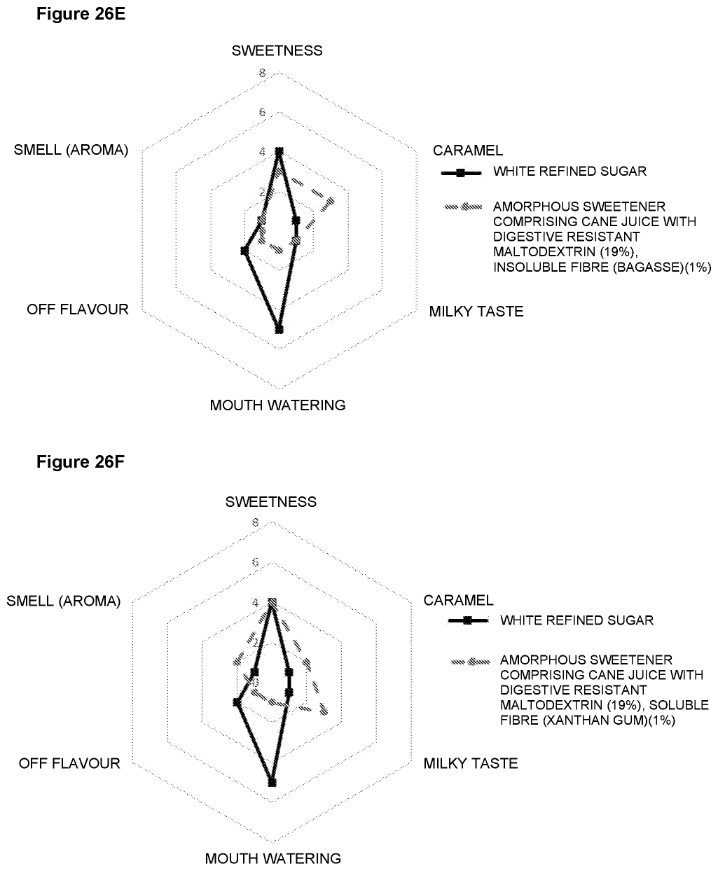

The taste profiles of various aerated amorphous sweeteners were assessed. The results are depicted in FIG. 26.

A, B and D are sweeter than white refined sugar. F is equally sweet. A has aroma, is mouth watering and has a caramel taste. B has aroma, is mouth watering and has a caramel and milky taste. C has an off flavour. D has an aroma and is mouth watering. E has a caramel taste. F has a milky taste.

The testing demonstrates how different aerated amorphous sweeteners can be prepared with different flavours for different applications. The taste profile of B suggests that this product would be more useful in foodstuffs that cover the flavour of B or in foodstuff where the amount of sugar required is reduced.

TABLE 18
Taste profiles
Product ingredients

| | | A | B | C | D | E | F |
|---|---|---|---|---|---|---|---|
| Attributes | White Sugar | Cane juice with | Cane juice with | | Cane juice | | Low |
| | | digestive resistant | digestive resistant | Cane juice | with | | glycemic raw |
| | | maltodextrin (19%), | maltodextrin (19%), | with | sunflower | | sugar (30 mg |
| | | insoluble fibre | soluble fibre | monkfruit | protein | Cane | CE polyphenols/ |
| | | (bagasse) (1%) | (xanthan gum) (1%) | (10%) | (20%) | juice | 100 g) |
| smell | 1 | 6 | 4 | 2 | 3 | 1 | 2 |
| (aroma) | | | | | | | |
| sweetness | 4 | 5 | 6 | 3 | 8 | 3 | 4 |
| caramel | 1 | 5 | 6 | 2 | 2 | 3 | 2 |
| milky taste | 1 | 1 | 8 | 1 | 1 | 1 | 3 |
| mouth | 5 | 6 | 5 | 3 | 5 | 1 | 1 |
| watering | | | | | | | |
| off flavor | 2 | 1 | 1 | 4 | 1 | 1 | 1 |

### Example 19—Preparation of Chocolate Using Aerated Amorphous Sugar

70 g of Delphi 70% dark chocolate (60% cocoa solids+10% cocoa butter) was melted and combined with 30 g white crystalline castor sugar and white sugar as control. 70 g of 70% dark chocolate was melted on a water bath, mixed with 15 g aerated amorphous sugar and tempered then molded. The aerated amorphous sugar had a D90 of less than 30 microns.

The amorphous sugar readily produced a smooth chocolate after minimal mixing by hand. After 5 minutes of mixing the chocolate mixture was smooth and creamy. The traditional sugar remained grainy in the chocolate under the same mixing conditions.

Further conching may have required to make this mixture smooth and creamy. The amorphous sugar has the advantage of easier and shorter mixing. This is likely to reduce manufacturing time and cost. As described in Example 22, the amorphous sugar particles are stable in the chocolate after manufacture.

In order to achieve these results it is useful to avoid adding the amorphous sugar to the aqueous phase of chocolate, for instance, the amorphous sugar should be added after conching. Optionally, after conching and milling. Optionally after, conching, milling and refining. To maintain the structure of the amorphous particle in the chocolate, it is recommended to maintain the temperature of the formulation comprising the amorphous sugar below the glass transition temperature of the amorphous sugar.

### Example 20—Preparation of 75% White Sugar/25% WPI and 35.7% White Sugar/35.7% Brown Cane Sugar/12.5% WPI/12.5% FOS (Fructooligosaccharide) Amorphous Sugar

The effect of the preparation method on particle size distribution, bulk density and moisture content was investigated for different formulations and preparations. The results are tabulated below in Table 19.

### Testing Conditions

Testing was performed using a GEA SD-28 spray dryer. The drying chamber has a diameter of 2.76 m, a cylindrical height of 1.95 m and a 60° cone. The drying gas, ambient air, was heated indirectly by a gas-fired (propane gas) heater and entered the drying chamber through a ceiling air disperser.

Feed was supplied by a Mono pump to a nozzle which is placed in the center of the air disperser. The atomized droplets were dried to a particular powder by means of hot air. Product was separated and collected from the cyclone and bag filter through a rotary valve.

The outlet gas from the chamber was led through a cyclone, separating the fine particles from the drying gas, a bag filter and a wet scrubber for further purification of the outlet air before exhaust into the open.

Solids content was assessed using a Mettler HR73 (T4/105° C.). The samples for powder analysis were collected at the cyclone. Particle size was assessed using a Malvern Mastersizer (dry at 0.5 bar).

Free poured bulk density was determined as for Example 5. Tapped bulk density was determined as for Example 5 except that the samples were tapped 100 times.

### Feed Preparation

### General Ingredients

Whey protein isolate (WPI) from Arla Foods, white sucrose sugar, brown sucrose cane sugar (from Fiji) and fructooligosaccharide (FOS).

### General Preparation

All feed were prepared at a concentration of 60% dry matter.

### Ingredient and Preparation for Recipes

Recipe No. 1 and 2 ingredients: 200 kg demineralized water, 225 kg white sugar, 75 kg whey protein isolate.

Recipe No. 1 and 2 preparation: Water was heated to about 70° C. and then sugar and whey protein were added. The temperature was maintained in the feed tank before spray drying.

Recipe No. 3 ingredients: 100 kg demineralized water, 112.5 kg white sugar, 37.5 kg whey protein isolate.

Recipe No. 4 ingredients: 100 kg demineralized water, 54 kg white sugar, 54 kg brown cane sugar, 4.5 kg FOS and 37.5 kg whey protein isolate.

Feed 3 and 4: Water was heated to about 70° C. and then sugar, FOS and whey protein were added. However, heating was stopped before whey protein was added. The temperature dropped to about 38-45° C. in the feed tank before spray drying.

### Observations

### Test 1

Moisture in powder was 1.24%. Bulk density (loose/tapped) was 0.58/0.66 g/ml. Average particle size (D50) 142 μm. Some deposits were present after test 1 due to the sticky powder.

### Test 2

Moisture in powder was 2.15%. Bulk density (loose/tapped) was 0.60/0.69 g/ml. Average particle size (D50) 78 μm. The nozzle pressure was higher in test 2 (142 bar) compared to test 1 (42 bar). Particles sizes decrease when nozzle pressure increases.

### Test 3

Moisture in powder was 2.24%.

### Test 4

Moisture in powder was 1.97%. Bulk density (loose/tapped) was 0.36/0.44 g/ml. Average particle size (D50) was 70 μm. The low bulk density of the powder, compared to test 1 and test 2, was probably a result of some air in the feed. The density of freshly made feed was about 0.9 g/ml due to air incorporation in the feed (the feed was milky white). After some time, the air bubbles in the feed rose to the surface and the density of the feed increased to about 1.2 g/ml, which is the correct density of the feed (without air). Then, the feed became more transparent and slight yellow in colour.

### Test 5

Moisture in powder was 2.28%. Bulk density (loose/tapped) was 0.36/0.44 g/ml. Average particle size (D50) 95 μm. The low bulk density of the powder, compared to test 1 and test 2, was probably a result of some air in the feed.

### Test 6

Moisture in the powder was 2.33%. Bulk density (loose/tapped) was 0.53/0.65 g/ml. Average particle size (D50) 55 μm.

### Test 7

Moisture in the powder was 2.45%. Bulk density (loose/tapped) was 0.47/0.57 g/ml. Average particle size (D50) 51 μm.

### Further Tests

These Tests were repeated with an inlet temperature of 140° C., resulting in stable free flowing powders and improved yields.

TABLE 19
Characteristics of prepared formulations, including particle size
distributions and bulk densities

| Parameter | Test 1 | Test 2 | Test 3 | Test 4 | Test 5 | Test 6 | Test 7 |
|---|---|---|---|---|---|---|---|
| Drying gas | | | | | | | |
| Inlet | 160 | 160 | 160 | 158 | 153 | 160 | 160 |
| temperature, ° C. | | | | | | | |
| Outlet | 86 | 88 | 92 | 98 | 94 | 80 | 80 |
| temperature, ° C. | | | | | | | |
| Feed | | | | | | | |
| Recipe No. | 1 | 2 | 3 | 3 | 3 | 4 | 4 |
| Solids content, % | 60.1 | 62.4 | 60.2 | 60.2 | 60.2 | 61.3 | 61.3 |
| Density, g/mL | 1.21 | 1.24 | 1.2 | 1.2 | 1.2 | 1.24 | 1.24 |
| Viscosity | 0.16 at | 0.097 at | — | — | — | 0.20 at | 0.20 at |
| | 25° C. | 25° C. | | | | 60° C. | 60° C. |
| Feed rate, L/h | 87 | 110 | 85 | 81 | 82 | 92 | 90 |
| Feed rate, kg/h | 105 | 136 | 102 | 97 | 98 | 114 | 112 |
| Temperature, ° C. | 74 | 68 | 38 | 38 | 38 | 42 | 45 |
| Atomization | | | | | | | |
| Specification | Pressure Nozzle | | | | | | |
| Nozzle | 42 | 142 | 141 | 140 | 135 | 185 | 180 |
| pressure, bar | | | | | | | |
| Powder analysis | | | | | | | |
| Residual | 1.24 | 2.15 | 2.24 | 1.97 | 2.28 | 2.33 | 2.45 |
| moisture % | | | | | | | |
| Particle size, | 142 | 78 | — | 70 | 95 | 55 | 51 |
| D50, μm | | | | | | | |
| Particle size, | 5.24 | 2.19 | — | 2.60 | 1.77 | 1.77 | 2.23 |
| span | | | | | | | |
| Bulk density, | 0.58 | 0.60 | 0.38 | 0.36 | 0.32 | 0.53 | 0.47 |
| free poured, g/mL | | | | | | | |
| Bulk density, | 0.66 | 0.69 | 0.56 | 0.62 | 0.55 | 0.65 | 0.57 |
| tapped 100×, g/mL | | | | | | | |

### Example 21—Effect of Feedstock and Preparation Recipe

The effect of the preparation method on particle size distribution, bulk density, yield and moisture content was investigated for different formulations and preparations.

Spray drying was conducted using the GEA Mobile Minor Spray drier. Wet particle sizing was performed using a Malvern Mastersizer S. Isopropyl alcohol was employed to stop the particles sticking together. Dry particle sizing was performed using a Malvern Scirocco at 0.5 bar pressure.

The results are tabulated in Table 20 below.

It was found that increasing the atomizing air pressure or reducing the percentage of feed solids reduced the D90 particle size (compare Trials 1, 2 and 3; as well as Trials 8, 9 and 10). In formulations comprising WPI (see Trials 1-3), it was found that increasing the atomizing air pressure to 2 bar (Trial 2) had a greater effect on the D90 particle size than reducing the percentage of feed solids to 50% (Trial 1). In contrast, in formulations comprising egg white protein and inulin (see Trials β-10), it was found that reducing the percentage of feed solids to 50% (Trial 10) had a greater effect on D90 particle size than increasing the air pressure to 1.5 bar (Trial 9). The skilled person will be able to use both techniques to achieve suitable particle size for a variety of density lowering agents.

Running Trials 12 and 13 with a solids content of 40% in the feed at a feed rate of 18 g/min did not affect D10, D50, D90 or bulk density values.

It was observed that the propensity of the feed to form bubbles upon mixing with water varied according to the type of protein present. Different formulations of the same total solids content comprising 80% white sucrose and 20% protein were mixed with water under the same conditions and left overnight. The volume of bubbles versus the volume of bulk liquid mixture present the next day was measured. The volume percentage of bubbles was found to be about 20% for the faba bean formulation, about 4% for the WPI formulation and negligible for the soy protein isolate formulation

TABLE 20
Characteristics of prepared formulations, including particle
distributions and bulk densities

| Bulk density, | | Not recorded | Not recorded | Not recorded | 0.48 |
|---|---|---|---|---|---|
| g/cm³ | | | | | |
| Moisture | | Not recorded | Not recorded | Not recorded | 1.75 ± |
| content % | | | | | 0.15 |
| Particle | D90 | 42.66 | 22.12 | 60.77 ± 12.11 | 60.77 ± |
| size | | | | | 12.11 |
| distribution, | D50 | 15.58 | 8.05 | 19.21 ± 2.63 | 19.21 ± |
| μm | | | | | 2.63 |
| | D10 | 3.95 | 2.82 | 4.77 ± 0.35 | 4.77 ± |
| | | | | | 0.35 |

| | | | | |
|---|---|---|---|---|
| yield, % | Not recorded | Not recorded | Not recorded | 91.3 |
| Average feed | Not recorded | Not recorded | Not recorded | 30.7 |
| rate, g/min | | | | |
| Atomizing air | 1 | 2 | 1 | 1 |
| pressure,bar | | | | |
| Outlet | 85 | 85 | 85 | 85 |
| temperature, | | | | |
| ° C. | | | | |
| Inlet | 160 | 160 | 160 | 160 |
| temperature, | | | | |
| ° C. | | | | |
| Water, kg | 0.83 | 0.83 | 0.55 | 5.5 |
| Dry mass of | 0.83 | 0.83 | 0.83 | 8.3 |
| feedstock,kg | | | | |
| Feedstock | 70% | 70% | 70% | 70% |
| | sugar A, | Sugar A, | Sugar A, | Sugar A, |
| | 5% Sugar B, | Sugar B, | Sugar B, | Sugar B, |
| | 25% WPI | 25% WPI | 25% WPI | 25% |
| | | | | WPI |
| Trial | 1 | 2 | 3 | 4 |

### Example 22—Stability of Amorphous Sugar Particles

The stability of the amorphous aerated sugar particles was assessed. The aerated amorphous sugar particles in the formulation were prepared from 75% sucrose and 25% WPI, in conditions analogous to those described in Example 21.

The chocolate formulation was stored for 12 months in a sealed low density polyethylene bag under ambient conditions of 25° C. and 50-60 RH. After this time, the particles remained free flowing. The morphology of the sugar particles after 12 months storage in sealed low density plastic and ambient conditions was assessed using SEM spectroscopy. A Magellan 400 FEGSEM instrument was employed. This is an extreme high resolution (XHR) instrument equipped with a monochromator allowing improved resolution at low accelerating voltages and elemental analysis. Prior to analysis the particle samples were mounted on stainless steel discs before being coated with iridium for analysis.

It was found and confirmed by SEM that the aerated sugar particles had retained their amorphous and porous morphology after 12 months storage in a sealed low density plastic bag in ambient conditions.

### Example 23—Preparation of Ice Cream Using Aerated Amorphous Sugar

Ice cream was prepared using amorphous sugar prepared from 70% white refined sugar, 5% raw sugar and 25% WPI (by solid weight) (ie dissolved and spray dried to make amorphous sugar particles).

### Preparation

Milk and cream were added to a saucepan and heated to about 30° C. Skim milk powder was stirred in and after the milk powder had dissolved, any granulated crystalline sugar/glucose syrup was added. The mixture was heated to 72° C. and held at this temperature for 20 seconds. The mixture was stirred during heating to prevent scorching. The pasteurized ice cream mixture was transferred into a plastic pouch and sealed. The plastic pouch was placed in an ice bath to allow the ice cream mixture to cool down before storage in the fridge overnight. The ice cream mixture was poured into a prepared ice cream machine and churned for 45-50 minutes. For recipes where amorphous sugar made from 70% white refined sugar, 5% raw sugar and 25% WPI was added, this component was added after churning for 30 minutes. For these recipes, the mixture was churned for another 20 minutes following addition of the amorphous sugar made from 70% white refined sugar, 5% raw sugar and 25% WPI was added. The ice cream was then transferred to a container and blast freezed at −18° C. before storage in a freezer.

The recipes for the different ice-cream formulations are tabulated below.

TABLE 21
Formulations of ice cream comprising granulated sugar as the primary
sweetening agent

| Formula No. | N1.0 (Control) | | N1.1 | | N1.2 | |
|---|---|---|---|---|---|---|
| | Weight | | Weight | | Weight | |
| Ingredients | percent | | percent | | percent | |
| | (wt %) | Weight (g) | (wt %) | Weight (g) | (wt %) | Weight (g) |
| Granulated sugar | 13.0 | 91.0 | 7.8 | 54.6 | 3.1 | 21.7 |
| (Redman brand) | | | | | | |
| Amorphous sugar made | — | — | — | — | 6.3 | 44.1 |
| from 70% white refined | | | | | | |
| sugar, 5% raw sugar | | | | | | |
| and 25% WPI | | | | | | |
| Whipping cream | 26.0 | 182.0 | 27.5 | 192.5 | 27.1 | 189.7 |
| (President brand) | | | | | | |
| Full cream milk | 51.0 | 357.0 | 54.3 | 380.1 | 53.1 | 371.7 |
| (Farmhouse brand) | | | | | | |
| Skim milk powder | 10.0 | 70.0 | 10.4 | 72.8 | 10.4 | 72.8 |
| (Fonterra) | | | | | | |
| Total | 100.0 | 700.0 | 100.0 | 700.0 | 100.0 | 700.0 |

TABLE 22
Formulations of ice cream comprising glucose syrup as the primary
sweetening agent

| Formula No. | N2.0 (Control) | | N2.1 | | N2.2 | |
|---|---|---|---|---|---|---|
| | Weight | | Weight | | Weight | |
| Ingredients | percent | | percent | | percent | |
| | (wt %) | Weight (g) | (wt %) | Weight (g) | (wt %) | Weight (g) |
| Granulated sugar | — | — | 4.9 | 34.3 | — | — |
| (Redman brand) | | | | | | |
| Amorphous sugar | — | — | — | — | 6.6 | 46.2 |
| made from 70% white | | | | | | |
| refined sugar, 5% raw | | | | | | |
| sugar and 25% WPI | | | | | | |
| Whipping cream | 22.0 | 154.0 | 24.4 | 170.8 | 24.0 | 168 |
| (President brand) | | | | | | |
| Full cream milk | 48.0 | 336.0 | 53.7 | 375.9 | 52.5 | 367.5 |
| Skim milk powder | 10.0 | 70.0 | 10.9 | 76.3 | 10.9 | 76.3 |
| (Fonterra) | | | | | | |
| Glucose syrup | 20.0 | 140.0 | 6.0 | 42.0 | 6.0 | 42.0 |
| (Redman brand) | | | | | | |
| Total | 100.0 | 700.0 | 100.0 | 700.0 | 100.0 | 700.0 |

### Results and Discussion

The control formulae (N1.0 and N2.0) were formulated based on typical composition found in ice cream.

The amorphous sugar of the invention was added approximately 30 minutes into the churning stage when most of the water in the ice cream mixture had frozen. This was because the amorphous sugars of the invention are known to hold bulk density in a fat matrix and dissolve completely in an aqueous liquid matrix.

In the reduced sugar formulations, the amount of sugar, calculated as total solid content, was reduced by 40% (Tables 21 and 22). The total amount of sugar in the ice cream is best represented as total solids from sweetening agents, as glucose syrup exists as a liquid with a solid content of 81%.

Theoretical sweetness was also calculated as the intensity of sweetness differs among types of sugar. Sucrose, which is commonly known as table sugar, is used as the benchmark, and has a theoretical sweetness of 1. Relative to sucrose, glucose has a theoretical sweetness of 0.8 on a dry weight basis.

### Taste Testing

The taste of the different ice cream formulations was assessed by qualified taste analysts. Comparing the sweetness of N1.0 with its reduced sugar counterpart, N1.2, both products were found to impart desirable sweetness. N1.0 was perceived to be too sweet by some assessors whereas the sweetness of N1.2 was generally perceived to be just about right by the assessors. A stronger milky and creamy flavour was also detected in N1.2 as compared to N1.0. This enhanced dairy note was found to desirable by the assessors. To determine if there was any difference in the intensity of sweetness perceived in the ice cream formulations between formulations comprising the granulated sugar and the amorphous sugar of the invention made from 70% white refined sugar, 5% raw sugar and 25% WPI; N1.1 was formulated. N1.1 had the same amount of total solid sugars as N1.2 (Table 23). The perceived sweetness for both N1.1 and N1.2 were found to be comparable, with N1.2 having a stronger dairy note,

Comparing the sweetness of N2.0 with its reduced sugar counterpart, N2.2, N2.2 was perceived by the assessors to be sweeter than its control, N2.0, despite a 40% reduction in sweetening agent and 32% reduction in theoretical sweetness (Table 24). Moreover, for a similar amount of sweetening agent used, N2.2 was perceived to be slightly sweeter than N2.1 by the assessors. This is in contrast to results for N1.1 and N1.2, where there was little perceptible difference in sweetness. Therefore, the amorphous sugar of the invention made from 70% white refined sugar, 5% raw sugar and 25% WPI was found to enhance the level of sweetness in a medium comprising glucose syrup.

TABLE 23
Theoretical sweetness of ice cream comprising
granulated sugar as the sweetening agent

| Formula No. | N1.0 (Control) | N1.1 | N1.2 |
|---|---|---|---|
| Total solid sugars | 13.0 | 7.80 | 7.83 = (3.1 + |
| | | | (6.3 * 75%)) |
| Percentage reduction in | — | 40 | 40 |
| solid content (%) | | | |
| Theoretical sweetness | 13.00 | 7.80 | 7.82 |
| Percentage reduction in | — | 40 | 40 |
| sweetness (%) | | | |

TABLE 24
Sugar reduction in ice cream

| Formula No. | N2.0 (Control) | N2.1 | N2.2 |
|---|---|---|---|
| Total solid sugars | 16.20 = | 9.79 = | 9.79 = |
| | (20 * 81%) | ((6.01 * 81%) + | (6.01 *81%) + |
| | | 4.92) | (6.56 *75%) |
| Percentage | — | 40 | 40 |
| reduction in | | | |
| sugar content (%) | | | |
| Theoretical | 12.96 = | 8.81 = | 8.81 = |
| sweetness | (16.20 * 0.8) | ((6.01 * 81% * | (6.01 * 81% * 0.8) + |
| | | 0.8) + 4.92) | (6.56 * 75%) |
| Percentage | — | 32 | 32 |
| reduction in | | | |
| sweetness (%) | | | |

### Overrun

The overrun of each ice cream was also measured as it affects the physical and sensory properties as well as the storage stability of an ice cream. Overrun is a measure of the amount of air incorporated into the mix that will determine the final volume of ice cream produced. The overrun was measured by comparing the weight of mix and ice cream in a fixed volume container according to the following equation:

Oₙ %=100(Wₘ−W_{ic})/W_{ic}

where Oₙ (%) is the overrun percentage, Wₘ (g) is the weight of a given volume of mix and We (g) is the weight of same volume of ice cream.

As seen in Table 25, there was no significant difference among samples using granulated sugar (N1.0−N1.2), indicating that the amorphous sugar of the invention used in the ice cream formulations did not adversely affect the overrun of an ice cream. The amorphous sugar was stable in the emulsion and was able to retain its porous structure during churning of ice cream mix.

However, the overrun of N2.0 was low. High amounts of higher viscosity glucose syrup are known to affect foaming and lower overrun.

TABLE 25
Average overrun of all ice cream formulae

| | | | |
|---|---|---|---|
| Formula No. | N1.0 (Control) | N1.1 | N1.2 |
| Average Overrun (%) | 34.93 ± 0.47^{a} | 40.13 ± 4.46^{a} | 37.07 ± 7.16^{a} |
| Formula No. | N2.0 (Control) | N2.1 | N2.2 |
| Average Overrun (%) | 25.09 ± 3.00^{b} | 31.26 ± 3.64^{ab} | 33.05 ± 0.74^{a} |

### Example 24—Amorphous Particles and Use to Prepare a Milk-Based Beverage

An amorphous sugar of the invention was prepared comprising 75% sugar cane juice and 25% stevia high intensity sweetener. The sugar was stable and free flowing.

The milk drinks of Table 26 were prepared with the cane juice and stevia amorphous sugar and with a stevia containing control—Jovia sweetener containing stevia and the low intensity sweetener erythritol.

TABLE 26
Formulations of milk-based beverages

| Ingredients | Control A (%) | Test 1 (%) |
|---|---|---|
| Full cream milk (Meiji) | 99.4 | 98.3 |
| Jovia sweetener | 0.5 | — |
| Amorphous sugar (75:25% | — | 1.6 |
| cane juice to stevia) | | |
| Vanilla Flavour | 0.1 | 0.1 |
| PCA.902366 (KH Roberts) | | |
| Total | 100 | 100 |

Test 1 had a similar sweetness to Control A but Test 1 did not suffer from the metallic aftertaste of stevia evident in Control A.

Further milk drinks were prepared with the stevia separate from the amorphous sugar. The formulations are below in Table 27.

TABLE 27
Further formulations of milk-based beverages

| Ingredients | Control B (%) | Test 2 (%) | Test 3 ( %) |
|---|---|---|---|
| Full cream milk (Meiji) | 99.4 | 98.75 | 98.95 |
| Jovia sweetener | 0.5 | 0.25 | 0.25 |
| White sugar | — | 0.9 | — |
| Amorphous sugar (80:20% cane | — | — | 0.7 |
| juice to WPI by solid weight) | | | |
| Vanilla Flavour | 0.1 | 0.1 | 0.1 |
| PCA.902366 (KH Roberts) | | | |
| Total | 100 | 100 | 100 |

The perceived sweetness of all composition was matched to that of Control B. Test 3 has less amorphous sugar than Test 2 has white crystalline sugar because the cane juice based amorphous sugar is sweeter than traditional white sugar. The amorphous sugar of Test 3 masked the metallic aftertaste of stevia better than the ingredients in both Control B and Test 2. The caramel-like flavour present in Test 3 was also considered desirable.

The milk used in these examples included 3.3 g protein/100 ml, 4.1 g fat/100 ml, 11.5 mg cholesterol/100 ml, 5 g carbohydrate/100 ml, 44.6 mg sodium/100 ml and 109 mg calcium/100 ml in water.

### Example 25—Effect of Feedstock and Preparation Recipe

The effect of the preparation method and feedstock on particle size distribution, bulk density and moisture content was investigated for different formulations and preparations. The results are tabulated below in Table 28.

### Ingredients

The following ingredients were employed in Example 25:

### Whey Protein Isolate (WPI—Bulk Nutrients Raw WPI Batch #21411001 BB: 11/1/2020)

Sugarcane Juice (Mossman Central Mill—collected October 2018) (Brix 66//75% total solids)

### Isolated Pea Protein (100% Isolate Pea Protein, Hillside Nutrition, Australia.)

Guar Gum (100% guar gum powder, 3,000-3,500 cps, Natural Colloids and Chemicals, Singapore)
Bagasse Fibre (100% sugarcane fibre Phytocel, KFSU Australia)
Intense sweetener (erythritol, stevia glycosides 0.75%, natural flavours, WholeEarth, Czech Republic)
Sunflower Protein (100% sunflower protein, Sunprotein, Biotechnologies Russia)

### Testing Conditions

Testing was performed using a GEA SD-28 spray dryer, as with the spray dryer and operation as described in Example 20. The inlet air humidity was approximately 10 g/kg.

Trials 8 and 9 were performed using a feedstock concentration of 50% total solids. The remaining Trials were performed using a feedstock concentration of 60% total solids.

The scale of all the Trials was from 1267 g to 1600 g of sugarcane juice. In all trials, distilled water was used as the diluent.

Wet particle sizing was performed using a Malvern Mastersizer S. Isopropyl alcohol was employed to stop the particles sticking together at a concentration of 0.5 g substrate to 50 mL of isopropanol.

### Observations

It was observed that increasing atomization pressure significantly reduced particle size (see Trials 1, 3 and 5). A significantly higher yield was obtained by increasing the percentage of WPI in the feedstock (see Trials 4-6 versus Trials 1-3). Without being bound by theory, the inventors hypothesise that the increase in yield is due to an increase in the glass transition temperature of the product, with particle stickiness reduced such that dried particles stick less to the drying chamber.

Increasing the concentration of WPI from 20% to 25% increased yield.

In Trial 7 the nozzle of the spray drier blocked during the run. The phytocel bagasse fibre used in Trial 7 was specified to be <100 μm. However, subsequent sieve analysis of the phytocel bagasse fibre using a Endecotts Vibrating Sieve determined that >11.5% of the fibre was greater than 125 μm. The phytocel bagasse fibre was fractionated and the fibre <125 mm was used in Trial 11, which proceeded in good yield without obstructing the atomizer. It was found that reducing the inlet and outlet temperatures improved the yield when using this feedstock (see Trial 10 and Trial 11).

Spray drying compositions comprising the intense sweetener were challenging at higher concentrations (see Trial 15). Taste testing of samples containing the intense sweetener determined that the metallic aftertaste of the intense sweetener was masked, even at a concentration of 10% (see Trials 15 and 16).

The residual moisture of Trials 5, 6 and 12 were determined by LOD at 105° C. to be 1.49%, 1.43% and 1.11%, respectively.

TABLE 28
Characteristics of prepared formulations, including particle size distributions and bulk densities

| | | | | | |
|---|---|---|---|---|---|
| Particle size | D90 | 40.71 to 41.63 | Not recorded | 60.02 to 60.54 | Not recorded |
| Distributions, μm | D50 | 40.71 to 41.63 | Not recorded | 24.4 to 29.25 | Not recorded |
| | D10 | 5.405 to 5.703 | Not recorded | 4.547 to 6.094 | Not recorded |

| | | | | |
|---|---|---|---|---|
| Yield, % | 80 | 88 | 84 | 89 |
| Atomizing air | 2 | 1 | 1 | 1 |
| Pressure, bar | | | | |
| Outlet Temperature,° C. | 84 | 84 | 85 | 85 |
| Inlet temperature,° C. | 170 | 160 | 160 | 160 |
| Feedstock | 80% sugarcane | 80% sugarcane | 80% sugarcane | 75% sugarcane |
| | juice,20% WPI | juice,20% WPI | juice,20% WPI | juice,20% WPI |
| Trial | 1 | 2 | 3 | 4 |

1. A low density amorphous sweetener, wherein the amorphous sweetener is a powder comprising aerated particles comprising
(i) one or more sugars and/or alternate sweeteners, and
(ii) one or more edible density lowering agent, and
wherein the amorphous sweetener does not comprise a surfactant.

2. A sweetener according to claim 1, wherein the amorphous sweetener has a bulk density of less than 0.8 g/cm³.

3. A sweetener according to claim 1, wherein the density lowering agent has a bulk density of less than 0.8 g/cm³.

4-6. (canceled)

7. A sweetener according to claim 1, wherein the density lowering agent is from 1% to 60% w/w of the amorphous sweetener.

8-11. (canceled)

12. A sweetener according to claim 1, wherein the density lowering agent is a protein, carbohydrate, fibre or natural intense sweetener.

13. (canceled)

14. A sweetener according to claim 1, wherein the density lowering agent is selected from the group consisting of whey protein isolate, preferably bovine whey protein isolate, egg white protein, Faba bean protein, soy protein isolate, inulin and combinations thereof.

15. A sweetener according to claim 1, wherein the protein is whey protein isolate and/or coco powder.

16-18. (canceled)

19. A sweetener according to claim 1, wherein the one or more sugars or alternative sweeteners is one or more sugars selected from the group consisting of sucrose, glucose, fructose and combinations thereof.

20-24. (canceled)

25. An amorphous sweetener according claim 19, wherein the sucrose is white refined sugar, raw sugar, brown sugar, dried cane juice, dried beet juice, dried molasses or combinations thereof.

26-29. (canceled)

30. A sweetener according to claim 1, wherein the sweetener further comprises at least about 20 mg CE polyphenols/100 g carbohydrate.

31. A sweetener according to claim 1, wherein the sweetener has a maximum of 1 g CE polyphenols/100 g carbohydrate.

32-33. (canceled)

34. A sweetener according to claim 1, wherein the amorphous sweetener has good or excellent powder flowability.

35-36. (canceled)

37. A sweetener according to claim 1, wherein the particles have a D90 of less than 60 microns.

38. A sweetener according to claim 1, wherein the particles are stable for 12 months, or 2 years when stored in sealed low-density plastic in ambient conditions (ie room temperature and 50-60% relative humidity).

39. (canceled)

40. A sweetener according to claim 1, wherein the amorphous sweetener contains about 10% or about 15% less calories than an equivalent weight of white refined sugar and/or (ii) the amorphous sweetener contains about 20%, about 30%, about 40% or about 50% less calories than an equivalent volume of white refined sugar.

41-66. (canceled)

67. A sweetener according to claim 1, wherein the amorphous sweetener has a bulk density of less than 0.5 g/cm³.

68. A sweetener according to claim 1, wherein the ratio of the one or more sugar and/or alternate sweetener to density lowering agent is 99:1 to 60:40 by solid weight.

69. A low density amorphous sweetener according to claim 1, wherein the density lowering agent is either soluble or powdered version of silicon dioxide, cellulose gum, banana flakes, barley flour, beets, brown rice flour, brown rice protein isolate, brown whey powder, cake flour, calcium carbonate, calcium lactate, calcium silicon, caraway, carrageenan, cinnamon, cocoa beans, cocoa powder, coconut, coffee, coffee, corn meal powder, corn starch, crisped rice, crushed malted barley, crushed soy beans, dehydrated banana flakes, dehydrated potatoes, dehydrated vegetables, dehydrated whole black beans, diacalite, dried brewers yeast, dried calcium carbonate, dried carrots, dried celery, dried bell peppers, dried onions, dried whole whey powder, dried yeast, dry milk powder, egg protein, egg white protein, flour, ground almonds, ground cinnamon, ground corn cobb, ground potato flakes, ground silica, hazelnuts, peanuts, almonds, hemp protein, hydroxyethylcellulose, calcium carbonate, magnesium flakes, magnesium hydroxide powder, malted barley, malted milk powder, microcrystalline cellulose, milk powder, natural vanilla, parsley, peas, pea protein, potassium chloride, potassium sorbate, potato starch, potato starch flake, potato starch powder, powdered brown sugar, powdered soybean lecithin, quick oat, rice crispy treat cereal, rice short grain, rolled corn, rolled oats, sesame, silica, silicate powder, sodium caseinate, sodium silicate, soy bean mill, soya flour, sugar beet pulp, sunflower seeds, sunflower protein, vanilla, vanilla beans, vitreous fibre, wheat bran fibre, wheat germ, whey protein powder, white hulled sesame seeds, whole oat, yellow bread crumbs, whey protein isolate, or combinations thereof.

70. A low density amorphous sweetener according to claim 1, wherein the particles have a D90 of less than 30 μm.

71. A low density amorphous sweetener according to claim 1, wherein the particles have a D50 or less than 60 μm.
